(19) United States
(12) Patent Application Publication
(10) Pub. No.: US 2019/0114938 A1
(43) Pub. Date: Apr. 18, 2019

(54) Sound Symbols Speaking and Reading Approach

(71) Applicant: Krisann Pergande, Muskego, WI (US)

(72) Inventor: Krisann Pergande, Muskego, WI (US)

(21) Appl. No.: 15/730,735

(22) Filed: Oct. 12, 2017

(51) Int. Cl. G09B 17/00; G09B 5/06; G09B 19/04; G09B 21/00

(52) U.S. Cl. CPC G09B 17/006; G09B 17/003; G09B 21/009; G09B 5/065; G09B 19/04; G09B 5/062

(57) ABSTRACT

This invention offers a unique multisensory, linguistically-based approach and for simultaneously facilitating instruction in speaking and reading skills. The approach incorporates unique methods, strategies, procedures, processes, materials, items, tools, and kit components for the teaching of speaking and reading using auditory, verbal, visual, gestural, proprioceptive, tactile, and kinesthetic treatment of sounds (spoken and read) and means of presenting said sounds. Speech sounds, combinations of speech sounds, and sound patterns, are uniquely presented in spoken, visual, and written forms. This invention introduces integrated components that contain new concepts and new ways of teaching and learning about sounds. These components which incorporate the various aspects of the invention include: the Sound Symbols Sound Circle; the Sound Symbols Visual Prompts; the Sound Symbols Consonant Chart; the Sound Symbols Vowel Chart; the Sound Symbols Tracking Form; the Sound Symbols Feedback System; the Sound Prosody concept; and the Sound Symbols Processes, Procedures, Strategies, and Activities. The Sound Symbols processes, procedures, strategies and activities apply to the learning and use of sounds in reading. Specific processes, procedures, strategies and activities also apply to use of the Sound Symbols Sound Circle. Included in the invention are associated materials and tools that address specific processes, procedures and related instructional aspects of the invention pertaining to speaking, reading, writing, spelling, and use of feedback (including external and internal feedback, self cueing, self-monitoring and self-correcting).

Visually, sounds are represented by unique hand, finger and arm positions, gestures and movements (in person and/or through various media) identified in the invention as “Sound Symbols Visual Prompts.” These Visual Prompts are paired with additional information, including: lip, tongue and orofacial positions and movements; with verbally produced and auditorily perceived sound productions; with written letters and aids that provide information on the target sounds; and with directions for forming the target sounds. The invention involves and is conveyed through the use of specific processes and procedures, through the use of directions, specific activities, and related supports or tools.

### STATEMENT REGARDING FEDERALLY SPONSORED RESEARCH OR DEVELOPMENT

Not applicable

### REFERENCE TO SEQUENCE LISTING

Not applicable

### COPYRIGHT NOTICE

A portion of the disclosure of this patent document contains or may contain material which is subject to copyright protection. The copyright owner has no objection to the photocopy reproduction of the patent document or the patent disclosure in exactly the form it appears in the Patent and Trademark Office patent file or records for purposes of official patent and trademark actions, but otherwise reserves all copyright rights whatsoever.

### BACKGROUND OF THE INVENTION

The present invention relates in general to the field of education, including regular and special education, and speech pathology. The invention relates specifically to unique methods, procedures, processes, strategies, directions, materials, items, tools, and kit objects (which are also referred to herein as “components of the invention,” the “invention,” or “components”) which offer a systematic approach and means for teaching individuals about sounds in order to improve both speaking and reading skills, with application to writing and spelling. The invention (also alternately called “program”) focuses on teaching and learning about associations between spoken sounds and written sounds (presented in letter and symbol forms); teaching and learning how to recognize sounds, elements of sounds, and sound patterns; and teaching and learning about how to distinguish, produce, manipulate, segment, sequence and combine sounds. The invention holds potential for individuals of any age or skill level for learning and improving speaking and reading skills, with application to writing and spelling skills. The invention is unique in its treatment of and the way in which auditory, verbal, visual, gestural, proprioceptive, tactile and kinesthetic means are used, combined, and patterned when presenting said sounds and combinations of sounds in spoken and written forms. This invention introduces the concepts of “Sound Prosody,” “Sound Symbols Visual Prompts,” and the “Sound Symbols Sound Circle,” along with their related tools which include the Sound Symbols Consonant and Vowel Charts, Sound Symbols Tracking Form, and other related components of the invention pertaining to speaking, reading, writing, spelling, feedback, self-monitoring, self-cueing, and self-correcting.

The Need for the Invention

Issues related to the need for improved reading instruction have been a topic of discussion for many years. In 2000, Wilber addressed findings that the reading levels of thirty-eight percent of fourth graders, or about ten million students, were below the basic level. There is ample evidence that those students who have reading difficulties at an early age seldom become skilled readers and that they generally continue to perform at lower reading levels over time when compared with students in their age groups (Blevins, 2006; Wilber, 2000). It is also important to note that a significant number of unemployed adults and incarcerated youth have reading difficulties and literacy issues (Miller, 1993). Present methods for addressing learning difficulties and improving mastery of speaking and reading skills have not succeeded in stemming the growing numbers of students who struggle in these areas (Coletti, 2013). In spite of the appalling statistics, the negative, life-changing outcomes, and the great need for improvement in these areas, there has been a lack of agreement on how to best help students, which is particularly notable in the reading instruction literature (Clark, 1988).

In 1972, about twenty percent of students were identified as having reading difficulties (Schell, 1972). In 2003, Shaywitz calculated that approximately 4.4 percent of students were enrolled in special education and that of these special education students eighty percent of students with learning disabilities (or 3.5% of the total number of students) were identified as having reading disabilities. In fact, Shaywitz (2003) reported that as many as one in five students may be affected by dyslexia.

Present methods have neglected to address or significantly increase understanding of sound systems related to teaching and learning about speaking and reading skills. These failures take on further significance when we consider the ever growing numbers of students with limited or reduced literacy skills in combination with disabilities of all types (i.e. dyslexia, learning disabilities, cognitive disabilities, hearing impairments, autism, speech and language disabilities, etc.). Moreover, decreased reading proficiency levels are strongly associated with learning difficulties of all types, as well as speech sound disorders

The Challenges that Point to a Need for the Invention

These outcomes point out the compelling need for improvement in how we approach the teaching and learning of speaking and reading skills. Individuals that would undoubtedly benefit most from the support that improved methods could provide include students with all of the disabilities listed above, as well as students who are considered to be at-risk and second language learners. It has become clear that students working on correcting speech impediments or overcoming difficulties in learning to read tend to need specialized support for understanding the nature and patterns of sounds in spoken and written forms. While programs are available to provide such specialized support, no particular program or approach has gained preeminence (Shaywitz, 2003, p. 267), or become widely known for stemming the increase in numbers of students with speech and reading disabilities. Moreover, the ongoing debate regarding the best ways to teach students how to read, which has endured for decades (Blevins, Wiley, 2006), has not provided needed answers to the challenges we face in this area.

One of the particular challenges current speech and reading programs face is that of finding ways to help students generalize or transfer learned skills to ongoing speaking and reading activities (also called carry-over). There is a particularly pressing need for programs that bridge the gap from teaching and learning of isolated skills to transfer of those skills to ongoing speaking and reading tasks. This need is especially evident with students who tend to over-generalize errors (which can include incorrect application of newly learned skills), at levels high enough to produce increases in errors during the learning process.

Furthermore, the construction of programs which can meet the diverse needs of students, who require supports and specialized instruction, has also proven to be an unmet challenge. Other challenges that have not yet been adequately addressed include the need to remediate student difficulties with specific skills, such as listening (or auditory) and sequencing difficulties, which some students exhibit when learning to read or when working on correcting speech impairments. Shaywitz (2003, p. 44, p. 53) compares such auditory discrimination difficulties to visual difficulties, equating inadequate or fuzzy auditory skills to visual perception that is “blurry,” and results in “less sharply defined” sounds or phonemes. Relatively few supports are available to facilitate development of auditory discrimination and sequencing skills, but even those that are available are not designed to be integrated into ongoing reading instruction. Shaywitz notes that auditory discrimination difficulties interfere with learning how to decode or identify words, while Clark (1988, p. 19) asserts that decoding is the major obstacle that dyslexic or learning disabled students face when learning to read. Moreover, Ball (1989, p. 150) observes that these needs are complicated by the fact that perception and discrimination of sounds are neither equivalent nor adequate unless comprehension skills are also present.

An additional and considerable challenge for students is that of transforming letter names into spoken or written sounds. The concept of the “alphabetic principle” is frequently addressed in the reading literature. Wilber (2000, p. 55) notes that the “alphabetic principle is the idea that alphabet letters represent the sounds we hear in words.” Complicating efforts to transform letters into words is the notion that English is generally considered to be irregular and even unphonetic (Flesch, 1986; Stewart & Vaillette, 2001). In fact, Wilber reports that “there are one hundred sixty-six phonic rules” (2000, p. 123). Given the perceptions of complexity and irregularity, an overwhelming preponderance of programs currently focus on identification of sight words (Flesch, 1986) with priority given to the teaching of alphabetic letter names. Associations between letters (by name) and their corresponding spoken or written sounds tend to be taught secondarily and sometimes as an afterthought when the primary focus is on visually recognizing words. This occurs in part, due to the perception that the most common English words are irregular from the perspective of phonics (Clark, 1988, p. 13). This perception seems to be related to and associated with the conclusion that phonics is both dull (Wood, 2004) and lacks importance in teaching and learning to read. In contrast, this invention offers ways of streamlining the processes for learning to read and the number of rules that need to be taught.

In many phonics programs a great deal of attention is given to the naming of alphabetic letters while little if any attention is given to the shape and features of the letters. However, in the relatively few instances where attention is given to the shapes and features of letter forms (e.g. Algozzine, Marr, McClanahan, & Barnes, 2008; Moore & Lyon, 2005) attention to ensuring that students are able to “sound out” words or understand the sound symbol relationships present between speech sounds and written letters appears to be minimal or nonexistent. In other programs any attention given to sounds is sandwiched between letter names, letter symbols, and pictures (e.g. A-apple-ae, etc.). For example, consistent with this type of approach, Wilber (2000, p. 65) stresses that it is important that children say “the letter name first, then the sound of the letter, and the picture name.”

Many English language learners (both native and foreign born) struggle with what has been identified as the disparity between spoken and written forms of English. This perception of disparity is based on more than the fact that the twenty-six letters of the English alphabet do not have a one-to-one correspondence with the actual sounds of the English language. These twenty-six alphabetic letters represent approximately forty-three to forty-six sounds or phonemes, depending on which sound analysis, process or approach is used (e.g. Flesch, 1986; Van Riper, 1978). It should be noted that the lack of agreement on the number of sounds in the English language extends to even linguists (Blevins, 2006, p. 62). Furthermore, the sounds produced in English are represented in various forms of individual letters and combinations of letters, being represented in many more forms than the twenty-six alphabetic letters alone denote.

Given such disparity between many of the alphabetic letters and the spoken sounds in English, this inventor determined that when teaching students about sounds it could be beneficial if the focus was first and primarily on sounds, while simultaneously pairing sounds with their corresponding written forms (individually and in specified combinations) in order to provide a more effective approach. Since so many reading difficulties continue to be encountered by students, the notion that it could be more beneficial to make the teaching of sounds of languages a priority (particularly with English), over teaching the names of the letters, emerged as a key viewpoint in the development of the invention.

The Need for New Approaches for Teaching and Learning about Sounds

A plethora of books and products from various related disciplines present a wide range of approaches for considering and addressing the relationships between spoken and written sounds, words, and print. Such disciplines include, but are not limited to the fields of linguistics, speech pathology, communication science, second language learning, and reading and literacy areas, many of which also address writing and spelling. Although many books and products exist for assisting in the teaching and learning of speaking and reading skills, the failure of so many students (from early childhood through adulthood) to perform adequately in these areas points to the need for innovative tools and better options for promoting more efficient and more effective learning in these areas (Coletti, 2013). Many professionals (e.g. teachers, speech pathologists, tutors, etc.), parents, and family members would benefit from the availability of more efficient and effective options.

Given the current and longstanding challenges in improving literacy rates, it can be clearly seen that students would benefit from an improved understanding of how sounds are processed, perceived, understood and then produced in speaking and reading tasks. Current reading programs do not provide adequate, yet alone specific and effective supports in these skills. Presently, reading programs tend to focus on sight words and the learning of letter names, expecting students to automatically associate letter names and sounds as they expand their sight word vocabulary. Although speech pathologists do provide support in development of skills in the areas of processing, perceiving, understanding, and producing of sounds with students who are identified as having a significant disability, many students with speech and reading difficulties do not meet the criteria for such assistance.

Farrell and Matthews (2010, p. 64) stress that “listening ability constitutes the base for reading comprehension.” Current teaching methods, however, do not generally include specific skills for increasing student understanding of how to perceive or differentiate sounds (Flesch, 1986) beyond limited and simple associations between letters and sounds or associating sight words with spoken or pictured words. It is interesting to note that written letter forms are often differentiated during writing instruction, and in some early literacy instruction. In contrast, attention to specific similarities and differences among sounds tends to be very limited, if addressed at all. For example, instructional activities typically use pictured rhyming materials or lists of rhyming words (e.g. Hiskes, 1996) to address differentiation of word pairs that vary by single sounds (e.g. hat, cat, etc.), in both speaking and reading tasks. In such rhyming tasks, the sounds, sound differences, and letter differences are often emphasized, while cues relating to sound productions (particularly consonant sounds) are rarely provided. Unfortunately, even when students adequately perceive sounds and sound differences in rhyming tasks, they may still fail to accurately produce or read these same sounds in other tasks.

Van Riper (1978) noted that when students make errors in productions of sounds, they may or may not discriminate or perceive the accuracy of those sounds as produced by others or by themselves. Recognition of the need for students to develop discrimination skills (for speaking and reading) has been long standing, but specific teacher training in this area has been insufficient. In this invention, both similarities and differences among sounds are exemplified for identification and differentiation using auditory and verbal means, and through gestural, kinesthetic, tactile, and proprioceptive means, as well as through the use of visual means. The invention thereby promotes student understanding of how to differentiate sounds, in addition to promoting student recognition of various aspects of sounds that support development of speaking and reading skills.

Developing the requisite skills to recognize, differentiate and produce sounds takes on additional meaning and value when we consider that listeners often “hear” or perceive less than what is actually said. In fact, Pei (1965) indicates that listeners frequently fill in sounds, as a result of hearing only about half of the sounds that speakers have actually said. Moreover, although Van Riper and Erickson (1996) note that there may be difficulties in the receiving, producing, or interpreting of speech sounds, consideration should be given to the possibility that any given student has difficulties in all or more than one of these areas, particularly when speech or reading difficulties are present. This invention allows for simultaneous attention to various aspects of sounds and development of students' processing skills, such as those discussed here and elsewhere herein.

Weaknesses in Present Approaches for Teaching and Learning about Sounds

Emphasis on the Teaching of Letter Names

As noted previously, students are generally taught letter naming and recognition first and are then expected to make associations with sounds, concurrent with the development of sight word vocabulary. It is important to again emphasize that teaching the names of the alphabetic letters does not necessarily facilitate the process of learning the sounds of a language for speech or for reading, even when difficulties with discrimination or differentiation of sounds are not present. This approach, or focus on letter names, may in fact hamper the learning process due to confusion that arises between the sounds that letters make and the sounds that make up the letter names (e.g. Letter “G” or jee, with spoken sounds “g” or “j” or “f” in the case of gh, etc.). When letter based approaches are used, students can be seen to confuse and even substitute names of letters for sounds, which can be particularly problematic during reading tasks. Moreover, on those occasions when the sounds that letters represent are presented, many programs unnecessarily add extraneous sounds during the teaching process (e.g. “bee” or “buh” for “b”), causing further confusion in the learning process (e.g. Wood, 2004).

Flesch (1986, p. 3) defines reading as “getting meaning from certain combinations of letters. Teach the child what each letter stands for and he can read.” To Flesch and many others this refers to teaching which focuses first and foremost on learning the names of the letters. This approach to reading which emphasizes learning of letter names has led to development of teaching programs that use sayings, like “A, apple, ae,” to help students learn to associate letters and sounds (e.g. Wood, 2004). A significant number of students, however, have difficulty applying these types of sayings and have difficulty using them as they work on developing fluent reading skills. Imagine saying “A, apple, ae,” each time you encounter an “a” during attempts to learn to read. Approaches such as these, which actually expand on the learning of letter names, can also interfere by adding confusion to the learning process and by adding to delays in making rapid associations between sounds and letters.

Visual images on or around the letters themselves have been used to help students visually differentiate letters (e.g. A is for apple, B is for boy, etc.). These approaches again emphasize letter names without providing other means of gaining proficiency in knowledge or use of the sounds that the letters represent. Moreover, such approaches often imply a one to one correspondence between letters and sounds that does not accurately represent the way that many sounds operate in English. These issues, as well as the previously discussed issues, likely contribute to the skepticism that supporters of whole language, learning of sight words, and other similar approaches, express about the presently available phonics or sound-based reading approaches.

Emphasis on Segmented, Linear Representations of Sounds

After students have learned alphabet letters as segmented items, sounds are typically connected in a linear fashion during speech and reading instruction. Students are then expected to simultaneously recognize, retain and produce sequences of sounds presented in linear fashion, while concurrently ascertaining the meanings associated with the target sounds. Traditional approaches have not been able to overcome the significant cognitive load and processing difficulties this combination of tasks can present. Attempts to address these issues using “look-and-say” or sight word approaches have also tailed to produce the needed results (Flesch, 1986). While many students are generally able to “look-and-say” growing lists of words, the sight word approach totally ignores the need to develop those important skills (e.g. recognize, retain, and produce sequences of sounds, while ascertaining their meaning) which allow students to readily decode new and unknown words. In contrast, the invention offers alternatives that are able to decrease the cognitive load involved in learning how to combine these tasks and provides supports that facilitate students' efforts to simultaneously make progress on all of these tasks.

Using the unique supports and circular patterns of the invention, the emphasis is on learning about sounds and on how to recognize, perceive, produce, and manipulate sounds, with associations intentionally developed while working on sounds paired with letters (both singly and in combinations representing sounds). This focus on developing associations from sounds to letters while simultaneously working on perceiving and manipulating sounds (as well as recognizing and producing sounds) offers additional means through which the invention uniquely approaches sounds and sound development, in comparison to traditional approaches. Moreover, multiple sound and letter associations are taught from the beginning, along with methods for connecting sounds in ways that help students use them to read and write words. This allows avoidance of the pitfalls found when first teaching letter names and then subsequently teaching students to make associations from letters to sounds, as separate steps in the learning process.

Emphasis on the Teaching of Vowel Sounds

In many reading programs that do address sounds, a great deal of attention is put on vowel sounds, even though consonant sounds are significantly greater in number. Often the focus or emphasis in reading instruction revolves around rules and examples related to vowels, particularly applicable to short vowel productions (Wilber, 2000), while teaching and learning about consonant productions takes a back seat. This attention to vowels appears to be related to the perception that the English language is highly irregular and difficult to learn or understand (primarily because of variations in the use of vowels and the lack of one to one correspondence between letters and sounds) and that the presence of many phonics rules, particularly those revolving around vowels, is unavoidable. Blevins (2006, p. 175), however, questions the usefulness and benefits of such phonics rules.

In contrast with approaches that focus on vowels, this invention emphasizes focusing primarily on the teaching and learning of consonant sounds while simultaneously presenting long vowels, and lastly addressing short vowel sounds. Moreover, this invention streamlines learning about sounds, so that those students with difficulties can minimize their need to recall “exceptions to the rule” and can overcome what teachers have long thought of as the complexity and difficulties of learning the rules of English for reading proficiency. The invention accomplishes this by identifying and describing a simplified and more generalized approach to rule development and use. The idea that this approach is needed and can be accomplished is not new (e.g. Schell, 1972), but the particular approach taken in this invention and the tools provided in the invention offer new and very different ways of teaching speaking and reading skills.

Challenges in the Use of Visual Cues and Combining Cues for Learning about Sounds

Current approaches have had limited success in remediating student difficulties in learning about sounds (such as difficulties segmenting, combining, and manipulating of sounds). Nor have current methods been able to approach development of skills in a manner that simultaneously combines teaching and learning of skills in segmenting, combining, manipulating, and associating sounds, which is in clear contrast with what the present invention is able to attain.

Some programs or methods have focused on representations of sounds using fairly arbitrary means of making associations between sounds and hand positions or actions, during efforts to draw attention to the sounds. One such example involves making exaggerated “ssss” sounds, associating them with a snake sound, and then making movements of the fingers down the forearm while simultaneously producing exaggerated “ssss” sounds. These types of approaches can strengthen associations between sounds and physical actions, however, associations between spoken and written forms of sounds are not generally addressed or even considered when using these types of techniques. The present invention moves beyond these limitations by combining multimodal components and strengthening associations between both spoken and written sounds. Increasing students' skills in these areas provides opportunities to decrease learning difficulties and to improve student mastery of speaking and reading skills in ways that advance their understanding of the sound systems used in both areas.

Hand movements and hand positions to encourage correct sound productions have at times been incorporated into speech programs, with more recent expansion into some reading activities. Programs of this nature, as well as programs that pair letters and words with pictures have tried to provide visual supports for students. For example, Finger spelling, Sign Language, Cued Speech, and other visual programs have been used to try to facilitate students' learning of sounds, letters and language. Although these methods provide additional information to students, they run into the same issues noted previously, in that the additional information they provide does not necessarily offer students the best information for making accurate associations between spoken and written speech.

For instance, when using signing, it is important to remember that signing is a very different form of communication with a different grammar and vocabulary than that of Standard English. As a result, the differences between these two systems of communication (spoken English and signed language) can be difficult for students to reconcile. Finger spelling and other methods using hand positions can run into the same problems that the teaching of and focusing on alphabetic letters poses, particularly when the finger and hand positions represent letter names that do not fully correspond with the sounds being taught or learned.

Charts and cards are used in many speech and reading programs and are sometimes used in combination with hand positions or other types of cues. At other times, the charts or cards alone provide the specified information. In contrast with many other programs, Cued Speech (Northern Virginia Cued Speech Association, 2010) uses hand positions to represent speech sounds and also offers other visual supports (e.g. chart of hand positions). However, because the particular hand formations in Cued Speech lack an intuitive relationship with their representative sounds, this approach does not consistently facilitate understanding of the relationships between spoken sounds and their written forms. Nor was Cued Speech initially designed for the purpose of helping students make associations between spoken and written sounds. Instead, Cued Speech was designed to facilitate speech development in students with hearing disorders (e.g. deafness or hearing impairments). The hand formations used in Cued Speech can nevertheless help students become more aware of sounds and students certainly do learn to make associations between the sounds and the cues. Unfortunately, Cued Speech in its present form does not develop students' awareness of the distinctive features of sounds, nor are the cues designed to make full and complete use of all of the visual and oral motor information available to students during the cueing process. Cued Speech does, however, present a different and unique way of representing sounds visually and is herein referenced as prior art, for the purposes of this application.

It is noted here, though, that none of the above approaches, including Cued Speech, were initially developed to promote connections between spoken and written language. Nor were they designed to provide feedback to students. This present invention is unique and different from Cued Speech and other similar manual or gestural approaches to sounds in numerous significant ways. Even more importantly, this invention constructs a new and unique way of combining manual or gestural information with visual, auditory, kinesthetic, tactile, and proprioceptive information and the treatment of sounds in spoken and written forms (including information on sound patterns). In contrast with these other approaches, the unique features of the invention also facilitate the provision of distinctive feedback to students.

Weaknesses in the Use of Feedback for Learning about Sounds and the Need for New Approaches

The various types of information presented to students during use of the invention provide specific and unique forms of feedback. Although the concept and use of feedback has gained attention in relation to education (Butler, 1987; Clark, 1988; Pergande & Thorkildsen, 1995), feedback approaches in both speech and reading instruction generally rely on repetitions of instructors' corrections while instructors and students repeatedly model sounds, letters, and words (e.g. Shaywitz, 2003). Feedback has typically included provision of varied indications on the accuracy of student responses, generally including indications of correct or incorrect results. In other words, most feedback consists of providing indications that student responses are correct or providing indications that student responses are inaccurate and providing students with correct responses or additional models that offer students the desired responses. It is noted, however, that even feedback that provides only evidence of accuracy or error can be useful since students with speech errors often do not recognize their errors. There is a high likelihood that students with reading difficulties similarly experience and demonstrate difficulties with the recognition of errors.

Ball (1989, p. 172) describes feedback as “the monitoring of your speech . . . to make sure it is not going wrong and to correct it when it does.” Moreover, Ball asserts that an absence of feedback can lead to deterioration of speech. Ball (1989, p. 175) further discusses the need for auditory, tactile (touch and pressure), kinesthetic (movement and positions), and proprioceptive (gamma-loop) types of feedback. His discussion centers on the need for feedback throughout the speaking process, where feedback is not limited to or centered only on learning how to speak. The use of this invention also extends to and promotes the use of feedback in structured and ongoing speech, as well as during the process of learning to read and beyond.

While the need for teaching approaches that address different learning modes and learning styles has been addressed in educational literature, this body of literature has focused primarily on styles and modalities of instruction and has given little attention to the need for providing feedback which incorporates these same principles. Drawing on the concepts of learning styles and literature supporting various modes of instruction, the present invention integrates very specific feedback, using multiple modalities, into the components of the invention and into instruction in ways that can increase the value of feedback and can lead to improvements in performance, as well as to the use of self-monitoring, self-cueing, and self-corrections.

The act of giving very specific feedback with respect to what students have actually said in combination with demonstrations of how their actual productions differ from the target productions, using multiple modalities has not typically been incorporated into present educational approaches for either speech or reading instruction. Using this invention, unique demonstrations can be used to provide such specific feedback. The combined feedback and self-monitoring aspects of the invention (including self-cueing and self-corrections) further differentiate it from other programs and help meet identified needs in these areas.

The Need to Expand Our Understanding of Sounds

The need to expand student understanding of sounds, in relation to speech and reading instruction, is clear. The present invention builds, in unique ways, on linguistic foundations for examining and analyzing sound productions and on our understanding of language development in order to achieve progress in the areas discussed above. It should be noted that while numerous approaches for examining and analyzing sound production and language development presently exist, analysis of speech has historically been an area of interest since ancient times. Various linguists (Chomsky, 2016; Fromkin & Rodman, 1974; Pei, 1965) have reported that activities and discussions related to analysis of speech and language patterns can be clearly traced back to the times of Socrates and Plato, with evidence of observations occurring even prior to their times. In fact, Chomsky (2016) recently indicated that even though language has been studied since ancient times, linguists continue to have many questions about the nature of language and speech.

In spite of the fact that language has been studied since ancient times, the field of speech pathology as a profession is considered to be fairly new (Lubinski & Frattali, 1994). Speech and hearing disorders and treatments were not examined systematically until the nineteenth century and early information on speech pathology in the United States indicates that the profession didn't formally emerge until the 1920's (Van Riper & Erickson, 1996). It should be pointed out that speech pathology as a field of study incorporates information from various areas besides linguistics, including (Lubinski & Frattali, 1994) but not limited to anatomy and physiology, physics, psychology, behavioral science, education, and various other areas.

Well before the establishment of the recently developed field of speech pathology, linguists had already identified and classified sounds of various languages. Furthermore, linguists have described (and continue to study) specific languages according to the range of sounds used as well as the variety of sounds that can be combined into meaningful sound patterns in order to form words and components of words. In years past, linguists began to label and classify individual speech sounds as “phones” or “phonemes.” Webster (Webster's New Collegiate Dictionary, 1977, p. 862) defines a “phone” as “a speech sound considered as a physical event without regard to its place in the sound system of a language.” A “phoneme” is defined by Webster (Webster's New Collegiate Dictionary, 1977, p. 862) as a “speech sound” and “a member of the set of the smallest units of speech that serve to distinguish one utterance from another in a language or dialect.” Elgin (1973, p. 12) indicates that a phoneme is “a sound which the native speaker of a language knows to be a meaningful part of that language, and which enables him to make distinctions between words.”

Phonemics relates to phonemes or speech sounds, while phonetics may include spoken sounds, rules, and other aspects of sounds, spoken language, and written language. Fromkin and Rodman (1974, p. 64) explain that phonetics is “the science of speech sounds” that describes the sounds of languages. Phonetics has also been called (Stewart & Vaillette, 2001, p. 33) the “study of spoken language” or human speech (Ball, 1989). According to Ball (1989, p. 23), phonetics includes articulation or “the process of producing individual speech sounds.” It is interesting to note that Stewart and Vaillette include other features, such as melodies and rhythms, in their description of phonetics.

The term “phonology” often refers to the science and theory of speech sounds and includes both phonemic and phonetic aspects (Webster's New Collegiate Dictionary, 1977, p. 862). Elgin (1973, p. 4) describes phonology as “the analysis and description of the meaningful [emphasis in the original] sounds that human beings make.” On the other hand, Pei (1965, p. 111) defines phonology as the “study of sound transformation along the historical course of a language.”

These various terms related to sounds and sound use are referred to in some instructional materials related to speaking and reading. Not all speech or reading programs include attention to the concept of allophones. This, however, is sometimes viewed as another important aspect of sounds. Van Riper (1978, p. 84) described allophones as “variant members of a phonemic family” and described examples of how allophones could be confused as belonging to specific sounds, instead of being recognized as production errors. Steward and Vaillette (2001, p. 71-72) emphasize that languages consist of two-level phonological systems, where allophones (subsets of phonemes or the various sounds that make up a given phoneme) and phonetic segments represent the physical reality of sounds while phonemes represent the abstract nature of sounds. In fact linguists, like Steward and Vaillette, indicate that only the allophones of phonemes are actually perceived during ongoing speech.

Attention to linguistic aspects of sounds, such as discussed above, and inclusion of various linguistic definitions (e.g. Farrell & Matthews, 2010) in literacy materials has increased in recent years in conjunction with efforts to draw attention to phonological and phonemic concepts (Coletti, 2013). This appears to have been a result of attempts to update and promote what is more commonly known as phonics instruction. Phonics has been defined as “knowledge of the way spoken English is put on paper . . . [and] simplified phonetics for teaching reading (Flesch, 1986, p. 122, p. 22).” On the other hand, phonics has been defined as teaching and learning to read by pronouncing words based on the phonetic value of letters, letter groups, and syllables (Webster's New Collegiate Dictionary, 1977, p. 862). Wilber (2000, p. 4) indicates that phonics is “learning how to attach sounds to alphabetic letters,” while Blevins (2006, p. 7-8) similarly describes phonics as “the relationship between sounds and their spellings.” Phonics is also defined (Farrell & Matthews, 2010, p. 10) as “sounding out letters through knowledge of sound-symbol relations” or “teaching letter sounds” (Wood, 2004, p. 39-40). Two primary or main types of phonics instruction are identified in the literature as synthetic and analytic phonics (Blevins, 2006; Clark, 1988), where synthetics phonics is said to be explicit and taught through direct instruction and analytic phonics is implicit, being taught or learned through discovery approaches.

It is interesting to note that authors like Wilber (2000, p. 129) can conclude that phonics “frees a child from memorizing thousands of sight words” while at the same time they assert that (Wilber, 2000, p. 94) “overuse of phonics is an inefficient way to read” [and] . . . “the more written language a child memorizes the faster he will learn to read.” These apparently contradictory remarks capture some of the dilemmas encountered in making sense of sounds and finding the best ways to teach children about sounds in both speaking and reading tasks. One of the apparent reasons for this quandary and the tension that exists between the use of phonics and sight words (alternately given other names such as look and say, whole language, etc.) centers on the perception that sight words cannot be sounded out and that the process of sounding out words is excessively slow (Wilber, 2000). Moreover, these perceptions by Wilbur and many others lead to such conclusions as those overtly stated by Wilbur (2000, p. 186) that “It's much easier . . . to recall a picture from memory than a sound.” Agreement with such conclusions may be less overt, but is nevertheless clearly demonstrated in the emphasis and even over-reliance on pictures found in many instructional materials.

To be fair, it should be pointed out that even linguists have grappled with firmly establishing an understanding of sounds. Numerous ways of analyzing and classifying sounds (Elgin, 1973) have emerged over time. Linguistic knowledge has clearly developed and been expanded upon during efforts to classify and make sense of sounds and sound systems. Valuable linguistic ideas have included the “IPA” or international phonetic alphabet developed through the International Phonetic Association in 1888 (Fromkin & Rodman, 1974) and the concept of distinctive features proposed by the Prague School linguists (Elgin, 1973) in the 1930's. The IPA is based primarily on the use of Roman letters to symbolize the sounds of languages (Fromkin & Rodman, 1974). Additional examples of various types of phonetic alphabets, with similarities to the IPA, can found in the literature in the field of speech pathology (e.g. Van Riper, 1978) as well.

It should be noted that while the linguistic concept of distinctive features has often been used to group and define sounds according to specified aspects related to their production, the concept of distinctive features has been judged to be inadequate, when used alone, for understanding the structure of sounds (Jackendoff, 1964). In addition to the use of Roman alphabet letters, this present invention builds and expands upon the ideas of distinctive features for grouping and defining sounds, along with the use of symbols (such as the IPA) for representing sounds (International Phonetic Association, 1999) and various phonetic alphabets, and includes these concepts as prior art, for the purposes of this application.

Over time, various classifications and descriptions of sounds were developed, for some of the reasons addressed above. It should be noted, however, that there are many approaches for describing sounds and attempting to explain sound patterns. Approaches using distinctive features, place and manner of production represent only some of these attempts. Descriptions, classifications, and ways of organizing sounds are all designed to distinguish one speech sound from another and speech sounds from non-speech sounds, according to features or aspects of sounds that are meaningful in any given language. Although people are capable of physically producing the full range of possible sounds that are present in any language, not all sounds are meaningful across all languages. Sounds which are distinct or separate in one particular language may also be used in combination with other sounds to form distinct or single, meaningful sounds in a different language (e.g. allophones). As a result, it is important to be able to clearly identify and explain those aspects of sounds which make them perceptible, to native and non-native speakers alike, as well as meaningful in a particular language. These overarching conceptions of sounds and sound development, perception and production are not generally given consideration relative to instruction in speaking and reading. Given the ever growing numbers of students who are learning to speak and read English as a second language (as well as those learning other languages as a second or additional language), these concepts take on growing importance and meaning.

Although linguistic concepts for classifying and addressing sounds (e.g. IPA and distinctive features) are regularly used in the field of speech pathology, these concepts have not received the same level of attention in reading and literacy circles. This is in spite of the fact that the ideas of phonological and phonemic awareness have become commonly accepted and used concepts for speech pathologists, while at the same time these specific concepts have tended to be tangentially applied in reading activities. Phonemic awareness has been described as the awareness that words are comprised of strings of separate, distinct sounds or phonemes (e.g. Blevins, 2006). Blevins includes the “ability to pick out and manipulate sounds in spoken words” as part of phonemic awareness (2006, p. 35) and further indicates that phonemic awareness is a component of the larger concept of phonological awareness. Similarly, Shaywitz asserts that (2003, p. 40-43) phonological processing or “processing the distinctive sounds of language” can also be viewed as an umbrella term that includes phonemic skills within the larger concept of phonological processing. It should be pointed out, that the term “phonological processes” is used for a different concept which refers to the strategies or natural processes that young children use to simplify the speech of the adults whom they model (Van Riper & Erickson, 1996) while learning to talk.

As leaders in the field of reading began to use and incorporate more linguistic terms into their work, discussions and consideration of the role of speech pathologists pertaining to reading issues began to emerge in the 1980's (American Speech-Language-Hearing Association, 1991). This occurred along with an increase in attention to the concept of phonological awareness (Gillon, 2005), which generally refers to awareness of aspects of the sound structure of words. This often includes awareness of rhyming patterns in words and awareness of syllables and phonemes, including the ability to segment words into syllables and sounds. It is interesting that Ball (1989) asserts even phoneticians face challenges in identifying and explaining syllables, yet alone students learning to read. Nevertheless, a growing number of reading approaches have included activities related to identification of syllables, in order to incorporate the concept of phonological awareness into their curricular materials.

Given the growing focus on phonological awareness and discussions on the role of speech pathologists, Goldsworthy (1998) asserted that speech pathologists are well qualified to collaborate and work on phonological awareness with classroom teachers and students, as well as with speech students. This assertion has been supported in part by the research of Gillon (2005), who found that students with moderate to severe speech impairments were able to demonstrate improvement in phoneme awareness and letter knowledge, as well as strong early reading and spelling outcomes, in response to intervention by speech pathologists. Although Gillon's work provides support for the notion that phonological skill development, or more specifically phoneme awareness, may be an important and necessary skill for learning how to read, these and similar findings have not gone unchallenged (Peterson, Pennington, Shriberg, & Boada, 2009). Furthermore, it should be noted that the above examples, definitions and applications of phonological and phonemic aspects and awareness address only a select portion of information related to sound development that pertains to the learning and mastery of speaking and reading skills.

This invention incorporates the linguistic concepts discussed here as prior art for purposes of this application, but also builds on them and adds to them by contributing new concepts, methods, processes, procedures, strategies, materials, items, and tools, for teaching speaking and reading skills. This includes, for example, the introduction of the concept of “Sound Prosody,” the “Sound Symbols Sound Circle,” and the “Sound Symbols Visual Prompts,” along with additional tools in the invention, including the “Sound Symbols Consonant Chart,” the “Sound Symbols Vowel Chart,” and the “Sound Symbols Tracking Form,” as well as other related components of the invention.

Expanding Our Understanding of Sounds through Sound Prosody

The previously coined term “prosody” has been commonly defined as the “accent of a syllable” (Webster's New Collegiate Dictionary, 1977), and as patterns of intonation or “pitch, stress, tone, and the like” (Elgin, 1973, p. 13) that apply to syllables or across several sounds. Prosody is a term (as well as its related descriptors) that has been generally used in relation to syllables, rather than single sounds (Jackendoff, 1994; Pei, 1965). Ball (1989) also includes length and pitch movement in his descriptions of prosody or suprasegmentals and further indicates that this feature applies across words and even phrases, as well as to syllables. Van Riper and Erickson (1996, p. 54) define prosody as “linguistic stress patterns as reflected in pause, inflection, juncture, melody or cadence of speech.” Similarly, Moore and Lyon (2005, p. 55) note that “We do not speak with equal spacing between words.” Like others, however, they neglect to address how timing of sounds contributes to inequality in spacing, length, and patterns of intonation. Expanding on these descriptions of prosody, Moore and Lyon (p. 56-57) describe oral language as including “voice” which adds meaning through emphasis, pitch, and volume. Likewise, Farrell and Matthews (2010, p. 8) identify intonation and volume as “paralinguistic features.”

As noted above, the term “suprasegmental” (Stewart & Vaillette, 2001, p. 62) has been described as including features such as length, intonation, tone and stress, primarily relating to production of syllables, while only tangential reference to sounds has been made or addressed in the literature relative to suprasementals or prosody. In fact, Stewart and Vaillette consider suprasegmental features to reside on top of syllables or across sounds, although they do note that suprasegmental features can apply to sounds.

It should be noted that the term “Sound Prosody” was devised by this inventor to describe specific features and aspects of sounds. In contrast with and expanding upon the above views, the concept of Sound Prosody moves from a focus on syllables, words, or phrases and applies in specific ways to individual sounds, as well as to combinations of sounds and the relationships among sounds. This unique concept (relating to linguistics, speech pathology, and reading instruction), which contributes to further understanding and development of speaking and reading skills, is described in detail in this invention.

The Need to Combine Knowledge from Linguistics, Speech Pathology and Reading Instruction

As noted previously, some of the linguistic concepts discussed above are also addressed in the literature or field of speech pathology. There has not, however, been a systematic instructional model for both speaking and reading which incorporates multimodal representations of sounds (based on linguistic conceptions of sounds) with IPA-based sounds and Roman symbols (as representations of sounds) while concurrently informing teachers and students about sound patterns and distinctive features of sounds. It is important to note that this invention was developed to provide simultaneous instruction in both speaking and reading skills. The invention provides the means and the tools for synchronized teaching and learning about speaking and reading skills, using a systematic, linguistically based, multimodal approach that explicitly instructs students in the understanding and use of sounds, features of sounds, and sound patterns.

Given that it is normal for very young children to learn to talk, some might initially think that speech sound formation, production and descriptions are relatively simple concepts to understand. This can be shown to be far from the truth, in light of the many challenges linguists and speech pathologists typically identify (e.g. Jackendoff, 1994; Van Riper, 1978) and the fact that even the widely respected and used IPA or International Phonetic Alphabet has undergone numerous revisions over the years (International Phonetic Association, 1999). Even the concept that what we hear during speech is comprised of clearly distinct speech sounds has been challenged by linguists (Jackendoff, 1994). Moore and Lyon (2005, discuss the divergent views that linguists and researchers presently hold on how children develop language skills, or speech. During his lifetime, Noah Chomsky, the well-known author and linguist, has reported making changes in his descriptions of how speech and language develop and of how sound and meaning are related (Chomsky, 2016). Moreover, the fact that sounds used in words in one particular language may not carry meaning in other languages provides yet another example (among many examples that could be used) of how difficult the principles of sounds can be to grasp.

Furthermore, while the act of speaking or using sounds to represent words, implies that a listener will be able to automatically and fully distinguish, process, and make associations among spoken (or written) sounds, this cannot be assumed in all cases. For instance, it is clear that listeners with hearing impairments may have difficulties perceiving spoken sounds. Other listeners, however, without identified hearing impairments may also have difficulties (Jackendoff, 1994) with the perception of sounds. For example, some listeners may not process sounds according to how they actually sound or according to how they are generally classified (e.g. auditory processing issues). In fact, Shaywitz (2003, p. 55) found that children's phonologic difficulties were the “most significant and consistent” indicators of dyslexia. Making distinctions among sounds is further complicated by the fact that productions of sounds vary among different speakers and even within the same speaker (Pei, 1965).

Additional difficulties occur when listeners and speakers have unconventional rule systems for sounds, which can impact how they assign meaning to correctly perceived sounds (e.g. phonological processing differences). Current approaches for teaching such students (including approaches for students identified with special education needs related to these areas) do not adequately address these areas. These inadequacies are demonstrated in numerous ways, including by the numbers of students in special education and at-risk programs, by test scores, by drop-out rates, by the disparities reported in performance levels of various groups of students, and by many other related statistics. It is important to note that special education and at-risk students often receive instruction that is remarkably similar to regular education students, albeit at slower paces and lower levels of complexity. In contrast, this invention uses novel means and approaches to facilitate learning and identification of shared understandings of sounds, as they are actually heard, processed, perceived and understood. What is more, this present invention can simultaneously address the needs of multiple types of students performing at varied skill levels, while concurrently increasing student focus on the distinct ways in which sounds are physically produced.

In addition, this invention includes effective and efficient ways of helping students learn how to sequence, segment, combine and manipulate sounds. These are important and key skills for both speaking and reading. Although programs exist that address sound sequencing skills none of them do so in a manner that effectively and efficiently combines the variety of important skills that are presented or using the unique means that are provided in this invention. Furthermore, this invention is distinctive in the design and format used for teaching sequencing, which allows for continuous productions of sounds (and varied combinations of sounds) in a manner that resembles natural, ongoing aspects of connected speech. In other words, the processes and visual supports in the invention uniquely accommodate the ongoing nature of speech, while simultaneously supporting efforts to teach about segmentation of speech into individual sounds and combinations of sounds. These are important skills, necessary for both speaking and reading.

It is important to note that presently, speech and reading programs have not been able to provide tools and methods that can adequately, yet alone effectively and efficiently, address the needs of the entire range of students who are working on learning speaking and reading skills (either as separate subjects or by combining speaking and reading instruction). Students with disabilities of any type are at a particular disadvantage in the current state of affairs, in spite of the range of programs that have been developed to try to address their difficulties and learning needs. Currently, programs, methods, and educational tools have failed to coordinate materials and teaching processes in ways that streamline learning or easily facilitate development of associations between spoken and written sounds in literacy and verbal communication activities.

Moreover, presently used reading programs of assorted types (including both phonics programs and sight word or whole language programs of various types) have been further criticized because of the ways in which they have limited vocabulary selection (Clark, 1988; Wood, 2004). For example, programs that rely on phonics have been criticized for limiting vocabulary that is characterized as irregular, while sight word programs have been criticized about their repeated use of limited vocabulary in order to facilitate memorization of specific words. Thus far attempts to use more eclectic approaches to address these shortcomings have led to the mixing of components from both phonics and sight word methods in ways that continue to perpetuate many of the weaknesses of both systems of instruction, which is clearly demonstrated by the persistent difficulties of our students.

These numerous and varied failures in educational approaches have led to breakdowns in the teaching and learning environment, with particularly negative impacts on students who struggle in these areas. For example, Coletti (2013) and many others (too numerous to cover here) report appalling statistics on how poorly our students are performing, abysmally underperforming in comparison to students in other parts of the world. Moreover, the likelihood that students will overcome literacy difficulties, particularly when speech or language deficits are present, is alarmingly low at this time.

Summary Comments

If there is to be any hope for achieving success in these areas, highly qualified teachers who have access to effective and efficient approaches that can meet the needs of all types of students are required. Present methods, procedures, and tools continue to fall short in meeting the growing needs faced by students, educators and families alike. Present methods do not provide clear, easy to learn approaches for understanding sounds or the relationships between spoken and written sounds, words and language. It is essential to address these pressing needs in ways that can generate successful teaching and learning outcomes. The invention explained herein addresses these important needs in ways that can offer a solution, by presenting effective and efficient means for teaching and learning about how to improve speaking and reading skills. Moreover, the invention is distinctive in how it approaches intervention in terms of the unique methods, procedures, processes, materials, items, and tools for improving speaking skills and in the unique manner in which speaking and reading skills can simultaneously be addressed, with application to writing and spelling. Thus, the invention contributes in significant ways to the fields of reading and speech pathology.

### BRIEF SUMMARY OF THE INVENTION

The Sound Symbols Speaking and Reading Approach provides a novel approach that simultaneously facilitates instruction in combined speaking and reading skills through a uniquely identifiable format of distinct but integrated components that represent the sounds of a language as they are spoken and written. The invention herein provides a novel multisensory, linguistically-based system that can effectively and efficiently facilitate instruction in speaking and reading skills, with application to writing and spelling. The invention has also been designed so that its materials, methods, processes, procedures, strategies and tools can be used with a wide range of students. As a result of its design, the invention is readily applicable to instruction with students of all ages and ability levels, from young children through adults. It is also useful for delivering instruction to students with disabilities or learning difficulties of all types, ranging from profound to minimal levels of difficulties. These students include, but are not limited to, those with speech and language disabilities, students with reading disabilities, students with hearing impairments, and students with other learning or developmental disabilities. While it is designed for use with English language learners, whether students are learning English as a first or second language, it can be adapted for use with other languages.

This invention introduces integrated components that contain new concepts and new ways of teaching and learning about sounds. Taken as a whole, the invention consists of and provides methods, strategies, processes, procedures, directions, tools, materials, supports, and kits or kit components for teaching, distinguishing, making, practicing, and correcting sound productions during speaking and reading tasks within one overall flexible but systematic approach that is comprised of a uniquely identifiable format of integrated components. These multiple components, of which the invention is comprised, facilitate teaching and learning about sounds, including features of sounds and how sounds operate, sound patterns, and other related aspects of sounds. As such, the invention's components and processes utilize an array of unique elements to specifically portray individual (or separate) and combined sounds as they are spoken and written. The components of the invention incorporate visual, auditory, verbal, gestural, tactile, proprioceptive, and kinesthetic treatment of speech sounds and means of presenting said speech sounds, combinations of speech sounds, and sound patterns in spoken and written forms. Moreover, the invention provides a unique multimodal or multisensory linguistically based approach to teaching and learning about sounds and addressing speaking and reading skills.

The components and collections of products are integral elements of this invention. The components of the invention can be combined in unique ways in order to facilitate teaching and learning about sounds and their use in speaking and reading tasks. The invention's components can operate as individual or distinct parts or can be used in assorted combinations. The various components, and instructions for using both individual and combined components in various forms, are intended to facilitate efforts to best meet the needs of instructors and students. These components of the invention may be packaged singly or assembled in the form of kits or as a collection of products. Each of these components of the invention contributes to learning and improvement of speaking and reading skills overall. Furthermore, each of these components of the invention target specific sub-skills for learning and improving speaking and reading skills in unique ways, which contribute to the overall uniqueness of the approach provided through the invention.

Nevertheless, each of these components function together, to form one overall systematic approach and entity that makes up the invention. These components include the following and are incorporated into various aspects of the invention: the Sound Symbols Sound Circle; the Sound Symbols Visual Prompts; the Sound Symbols Consonant Chart; the Sound Symbols Vowel Chart; the Sound Symbols Tracking Form; the Sound Symbols Feedback System; the Sound Symbols Reading Processes, Procedures, Strategies and Activities; the concept of Sound Prosody; and related materials and tools that address specific processes, procedures and related instructional aspects of the invention pertaining to speaking, reading, writing, spelling, and use of feedback (including external and internal feedback, self cueing, self-monitoring and self-correcting).

The invention provides methods, procedures, processes, materials, items, tools and kit components, with directions, strategies, and supports for teaching, learning, distinguishing, making, practicing, and correcting sound productions during speaking and reading tasks, within one overall systematic approach. The methods of the invention include all of the procedures, processes, and strategies used in the invention overall. The Sound Symbols Processes incorporate use of the Sound Circle and the Sound Symbols Visual Prompts and related procedures as well as unique procedures that are applied during reading instruction. This includes procedures for using the various components in the invention, such as the Sound Symbols Consonant Chart, Vowel Chart, Sound Symbols Tracking Form, Sound Prosody, and Sound Symbols Feedback and Self-Cueing Components.

Said invention facilitates learning of accurate conceptions and productions of sounds. The unique design of the invention promotes teaching and learning of correct pronunciations of sounds, including particular individual or segmented sounds and correct pronunciations of sounds in connected, structured, or ongoing speech and reading. The invention is equally useful when working with native and non-native speakers of the language on speaking and reading tasks. As a result, the invention is useful for addressing and providing supports for various speaking and reading difficulties and differences, such as dialectical variations, accent reduction, second language learning, and other variations in productions of words and sounds, as well as being useful when learning difficulties are present.

The invention facilitates development of speaking and reading skills by focusing on sounds instead of letters. This invention moves beyond presenting sounds as simply single, static entities and instead presents teaching strategies and supports for understanding features of sounds and sound patterns or systems, using multiple systems of supports and linguistically based information that facilitates understanding of dynamic aspects of sounds. Sounds presented in the invention are based on variations of characters used in the field of speech pathology, linguistics, and reading or language instruction, which generally derive from the International Phonetic Alphabet or IPA (International Phonetic Association, 1999), charts, tables and descriptions of sound classification approaches (e.g. Fromkin, V. & Rodman, R., 1974; Elgin, S., 1973; Van Riper, 1978).

The invention is organized by sound, using a modified alphabetic system that emphasizes sounds over letters. The invention uses a modified Roman alphabetic system which is more consistent with the invention. Corresponding written symbols and visual prompts are presented based on their associations with the sounds and as representations of the sounds (instead of the other way around where the focus is on letters). Consequently, the materials and sound charts in the invention are not strictly alphabetical, but are organized so teachers and students can still make use of alphabetic cues and formats, where it is beneficial.

Visually, sounds are represented by hand, arm, and finger positions, gestures, and movements (in person and/or through media) identified in the invention as “Sound Symbols Visual Prompts.” Sounds are also represented through visual supports, using pictured, drawn and written items (displaying and explaining components of the invention), as well as through spoken and/or auditory means. Information on sounds is conveyed through the use of specific processes, procedures, and strategies, through the use of directions and modeling, and through the use of a variety of supports and related tools. When presenting the processes used in the invention (in person or through other media), positions (of hands, arms and fingers), gestures and movements are paired with lip, tongue and orofacial positions and movements; with vocalized and auditory sound productions; and with written letters and aids that provide information on the target sounds and directions for forming the target sounds. Kinesthetic, tactile, and proprioceptive activities are incorporated into the invention and its procedures by having students observe, model and demonstrate utilization of information related to the positions, gestures and movements presented in the program (including finger, hand, lip, tongue and orofacial movements).

The emphasis in the invention during initial stages of instruction is on varied consonants in combination with the five vowel sounds that say their alphabetic names, with the exception of the letter “u” which is identified as “U2” (often spelled as oo, as in moon), pronounced like “oo” in the number “two.” Students learn, use and manipulate these combined consonant and vowel sounds, while being shown their corresponding written forms or letters. Students are taught processes and procedures for learning and mastering sound recognition, discrimination, and productions using the tools in the invention (e.g. “Sound Symbols Sound Circle,” “Sound Symbols Visual Prompts,” etc.) Only after they have gained a level of mastery over the consonant sounds and this limited number of vowel sounds, are students introduced to the remaining vowel sounds in the invention and in the language. After learning about sounds and sound productions, students are introduced to processes, procedures, strategies, and additional tools for applying what they have learned in speaking, reading, writing, and spelling activities.

The above ordering of instruction differs from the more usual approach of introducing short vowels (Blevins, 2006) and then spending a great deal of instructional time teaching said short vowels before introducing long vowels and only briefly addressing consonant sounds, in favor of spending substantial amounts of time on sight words. This invention also differs in the manner in which sounds are initially presented in various combinations, rather than in isolation. So, sounds are neither presented in isolation initially, nor in words. They are instead, presented in consonant and vowel patterns. Instruction in many programs initially focuses primarily on isolated sounds or goes right to sounds in words. By combining sounds at the start of instruction, students learn about sounds in a more natural context, but without the distractions and errors that can occur when using words as a starting point. Given the various unique supports in the invention (e.g. Sound Symbols Visual Prompts, Sound Prosody, Sound Symbols Step by Step Processes and Helper Phrases, Sound Symbols Consonant Chart, Sound Symbols Vowel Chart, and Sound Symbols Tracking Form etc.), which are useful for subsequent phases of teaching and learning skills about speaking and reading, students are able to efficiently and effectively apply what they have learned in progressively harder speaking and reading tasks.

The invention provides students with a variety of unique strategies and ways of understanding a range of sound representations, such as single sounds represented by multiple letters (e.g. sh, th, ch, etc.), single sounds represented with multiple spellings (e.g. f, ph; ks, x, s, c; etc.), multiple sounds for single letters (e.g. g said as /g/ and /j/, c said as /s/ and /k/, s said as /s/, /z/, and /zh/, etc.), and unique ways of understanding letters that do not have their own sounds or in fact share sounds with other letters (e.g. c, q, y, zh, etc.). The invention is also useful for helping students understand and produce blends, or combinations of consonants, in speaking and reading tasks.

The invention reduces “exceptions” to reading rules by approaching and treating sounds in very different ways from present methods. Through use of the invention, students are provided with novel strategies for learning about and unique ways of handling exceptions to the more usual relationships between spoken sounds and written representations, which are detailed below. Use of these strategies reduces exceptions overall. Other ways of reducing exceptions includes use of specific wording or phrases to explain sound patterns, which are also detailed in subsequent sections.

The elements of which the invention is comprised can be displayed, used, presented or demonstrated personally by instructors (to include physical presence in real time as well as virtual presence) or through the use of various other forms or displays that represent, describe, and/or explain the components of the invention. These include various items in diverse forms, such as items in written or printed forms (paper, books, booklets, pamphlets, pictured, whether rigid or flexible in form, or using text, pictures, drawings, photos, visualized, or digitized information on permanent or disposable materials), in audio or audio visual versions which use recorded, mechanized or electronic processes (e.g. dvd, cd, thumb-drive, data cards, website or web-based formats, digitized, digital displays or retrieval systems, electronically stored or transmitted forms or displays, downloaded or saved files, computerized forms including storage on hard drives and/or external or flash drives or similar devices, projections using smart boards or video displays or other similar means, as apps for internet, tablets or cellular phones, email, or other related means or devices, etc.), and other similar formats or combinations thereof that are presently available or become available.

An additional benefit, (which also relates to the functions and purposes for the invention) is that the invention can be incorporated into and used simultaneously during instruction on any subject. One of the reasons this is possible is because the components and processes of the invention can be separated and used individually, as well as in various combinations. The invention is designed to make it convenient for instructors to use either individual components or combinations of components when, where and in the manner they deem best for their students. Such flexibility also distinguishes this invention from other more static teaching programs. For example, the visual hand prompts or Sound Symbols Visual Prompts in the invention can be used in combination with speech or can be used to provide unique, discrete signals to students on particular sounds (or for all sounds) while instruction on any subject is being provided. Moreover, this invention is useful for allowing and even promoting the use of feedback and corrections without interrupting student productions during the act of speaking or reading, while learning about any given subject. As a result, the invention is particularly useful for developing and establishing students' abilities in the areas of self-monitoring, self-cueing and making self-corrections. Furthermore, use of the invention in these and other unique ways promotes and increases accurate recall of and associations between spoken and written sounds. The Visual Prompts and various reading procedures, processes, strategies, and tools in the invention are able to streamline reading instruction and student learning in multiple ways.

Visual and tactile materials may be made of any variety of materials, including paper or paper-based materials (such as cardboard or tagboard), plastic materials or coatings containing plastics, metal or magnetic materials, whiteboard materials, or fabrics and/or other types of construction materials. Invention materials may contain printed letters and designs using black, white, and other colors. Methods for instructor demonstration or showing the invention include the use of actions or motions, fixed and moving positions, as well as written, verbal, pictured, drawn and physical demonstrations of components in the invention. Electronic, digital, and computerized formats may also be utilized, to include all of the materials, tools, items or components, and directions for methods, processes, procedures and strategies that make up the invention.

The invention provides multiple unique means of representing sounds, including written forms (e.g. Sound Symbols Sound Circle, Sound Symbols Consonant Chart, Sound Symbols Vowel Chart), multisensory forms (e.g. Sound Symbols Visual Prompts), and written descriptions using specific wording or phrases to depict and explain sound patterns and the tools for facilitating related skills. As noted above, all of these aspects and components of the invention contribute to the unique nature of said invention. As a unique tool for teaching, learning and improving speaking and reading skills, with application to writing and spelling skills, this invention provides a valuable addition to the fields of speech pathology and reading instruction specifically and education in general. The invention extends the knowledge-base of information related to the fields of speech pathology, reading instruction, and linguistics, particularly as drawn from the International Phonetic Alphabet, Cued Speech, and speech pathology methods originally introduced by pioneers in the field, such as Charles Van Riper (Van Riper, 1978; Van Riper & Erickson, 1996).

The invention facilitates instruction in speaking and reading in very specific ways. While this invention and its component parts and processes emanate from and expand on various linguistic, educational and therapeutic sources, it is unique in its design, the manner in which it compiles its component parts, and the ways in which new concepts, methods, procedures, processes, strategies, materials, items and tools are expressed through these components. This invention introduces the concept of “Sound Prosody” and “Sound Symbols Visual Prompts and their related tools, including the Sound Symbols Sound Circle, Consonant Chart, Vowel Chart, and Tracking Form, as well as specific procedures, processes, strategies and related aspects of the invention pertaining to speaking, reading, writing, feedback, self-monitoring, self-correcting, and self-cueing. These and other attributes or qualities, components, and processes that make up this invention are evident in the ensuing sections and elements referenced herein by numbers with their corresponding descriptions, explanations, examples, figures, drawings, photos, and supporting information. The components of the invention are described further in following sections. The specific components of the invention as presented here and the format of the invention presented herein, however, should not be regarded as restricting the range or application of this invention.

### BRIEF DESCRIPTION OF THE SEVERAL VIEWS OF THE FIGURES

Referring to the accompanying figures that constitute a part hereof, including pictures, charts, text and reference information, it is seen that:

Sound Symbols Speaking and Reading Approach: Visual Overview of Methods, Procedures, Processes, Tools and Materials for Teaching and Learning Speaking and Reading Skills

FIG. 1 depicts a visual overview of the overall invention in diagram form, addressing in brief form the components of the invention and the connections between said components, as well as depicting the inclusion of the unique methods, processes, procedures, items, tools, and materials included in this invention. This figure provides a quick glance of the overall function and form of the invention, which facilitates teaching and learning of accurate conceptions and productions of sounds in speaking and reading tasks, with application to writing and spelling activities. This figure is noted as depicting material subject to Copyright;

### Sound Symbols Visual Prompts

FIG. 2 a b illustrates sound representations in the form of the Visual Prompts for consonant and vowel sounds developed as a component of the present invention, and further indicating corresponding characters of the International Phonetic Alphabet and Roman alphabetic Letters, with modifications thereof. These sounds are generally represented in written form through Roman alphabetic letters, combinations of alphabetic letters, or characters derived from the International Phonetic Association Alphabet or IPA (International Phonetic Association, 1999). Both Roman alphabetic and IPA constructs are, however, considered to be prior art for the purposes of this application. Although the Visual Prompts are paired with Roman alphabetic and IPA designations, these Visual Prompts are unique and novel components of this invention in terms of their usage (as well as in terms of their novel design). It should be particularly noted, that some representations and descriptions of sounds in this invention do not strictly conform to the conventional conceptions of sounds generally put forth either alphabetically or using the IPA. These differences are also evidence of the unique treatment of sounds in this invention, which facilitates learning of accurate conceptions and productions of sounds in speaking and reading tasks, with application to writing and spelling activities. This figure provides information on the form and format of the presented Visual Prompts. It should be noted that details on the use of the Visual Prompts are further addressed in relation to additional components in the invention. These figures are noted as depicting material subject to Copyright;

### Sound Symbols Consonant Chart

FIG. 3 depicts the Sound Symbols Consonant Chart included in the invention. In this component of the invention, sounds are represented and listed in modified alphabetic form using Roman alphabet letters, combinations of alphabetic letters, and characters derived from the International Phonetic Association Alphabet or IPA (International Phonetic Association, 1999). Both alphabetic and IPA constructs are, however, considered to be prior art for the purposes of this application. Descriptions of respective Sound Symbols Visual Prompts are provided adjacent to their listed sounds. Although the Visual Prompts are paired with alphabetic and IPA designations, these descriptions of the Visual Prompts are unique and novel components of this invention. It should be noted, that some representations and descriptions of sounds in this invention and figure do not strictly conform to the conventional conceptions of sounds generally put forth either alphabetically or using the IPA. These differences point to the unique treatment of sounds in this invention. Moreover, this Consonant Chart comprises only one, albeit important, portion or aspect of the invention. This component of the invention facilitates teaching and learning of accurate conceptions and productions of sounds in speaking and reading tasks, with application to writing and spelling activities. This figure provides information on the respective sounds and their related Visual Prompts, as well as related distinctive features and special labels assigned to particular sounds as listed. This figure is noted as depicting material subject to Copyright;

### Sound Symbols Visual Prompts: Vowel Prompts

FIGS. 4 a b c illustrate sound representations in the form of the Visual Prompts for vowels, developed as a component of the present invention. FIG. 4a gives pictured views of all of the vowel sounds represented in the invention. FIG. 4b adds information on the mnemonics used with the vowels, but does not include the pictured vowel positions. FIG. 4c charts the vowel sounds as used in conjunction with the Sound Symbols Sound Circle, using pictures and added information on their respective hand and arm positions and movements. The figures illustrate the Sound Symbols Vowels in chart form, where said charts contain outlines or diagrams and descriptions of each of the Vowel Prompts in the invention, with additional information such as hand positions and/or mnemonics that pair with each of the corresponding vowel sounds included in charts. Some of the Visual Prompts for vowels are organized by place and manner of production, with the inclusion of mouth positions and movements, such as mouth opening and lip protrusion, rounding, and retraction. Each vowel sound is distinguished by specific hand and arm positions and movements (not finger positions, as hands are in a fisted position for vowels) that correlate with how the sounds are formed physically, visually, and auditorily. In these charts the vowel sounds are represented in written form, using Roman alphabet letters, combinations of alphabetic letters, and characters (such as IPA characters from the International Phonetic Association, 1999), and are paired with descriptions of their corresponding Visual Prompts. Both alphabetic and IPA constructs are, however, considered to be prior art for the purposes of this application. It should be noted, that some representations and descriptions of sounds in this invention and these figures do not strictly conform to the conventional conceptions of sounds generally put forth either alphabetically or using the IPA. These differences point to the unique treatment of sounds in this invention. Moreover, these Vowel Chart comprise only one, albeit important, portion or aspect of the invention. This component of the invention contributes to the facilitation of teaching and learning of accurate conceptions and productions of sounds in speaking and reading tasks, with application to writing and spelling activities. components of this invention in terms of their usage (as well as in terms of their novel design). It should be noted that details on the use of the Visual Prompts are further addressed in relation to additional components in the invention. These figures are noted as depicting material subject to Copyright;

### Sound Symbols Sound Circle

FIG. 5 depicts the Sound Symbols Sound Circle, a component of the invention and a unique visual tool designed for teaching and learning about sounds for speaking and reading purposes, with application to writing and spelling. The Sound Symbols Sound Circle (or “Sound Circle”) consists of a large circle with a smaller circle centered within the larger one. The smaller centered circle maintains space for the placement of consonant sounds (or letters representing such). The sounds (or letters for the sounds) “a”, “e”, “i”, “o”, and “u2” are placed inside the large circle, equidistantly around the outside of the smaller circle. The Sound Symbols Sound Circle pairs spoken and written sounds, for teaching and learning of recognition, production, sequencing, segmenting, combining, and manipulation of sounds. Roman alphabetic letters used within the Sound Circle are considered to be prior art for the purposes of this application. Additional instructions on how to effectively and efficiently use this tool for teaching and learning purposes and how to combine use of the Sound Circle with other features of the invention are included in descriptions of the components of the invention and their related figures. This figure is noted as depicting material subject to Copyright;

### Sound Symbols Sound Circle: Methods, Processes, Procedures, and Strategies

FIG. 6 illustrates the methods, processes, procedures, and strategies related to use of the Sound Symbols Sound Circle (Refer also to FIG. 5), via a diagram with step by step instructions and a description of this component of the invention. In this figure, methods, processes, procedures, strategies, and applications associated with the Sound Symbols Sound Circle (Also identified as “Sound Circle”) are specified, through directions for using the Sound Circle. The Sound Circle is a unique visual tool for teaching and learning about sounds for speaking and reading purposes. The methods, processes, procedures, and strategies used with the Sound Circle to promote teaching and learning about sounds are likewise unique and represent novel treatment of sounds as depicted in this invention. This component contributes to this invention by facilitating recognition, retention, production, sequencing, segmenting, combining, and manipulation of sounds. This component of the invention also facilitates provision of information and feedback on sounds in ways that promote learning of sound features and sound patterns, as well as the development of self-monitoring, self-cueing, and self-corrections.

The act and process herein of using a consonant in a circular position and with back and forth movement, from consonant to vowel sounds (or from vowel to consonant, or moving back and forth multiple times between vowels and consonants), is a unique format for teaching about sounds. This format contrasts significantly with the linear format that has traditionally been used for teaching about sounds. This component of the invention promotes understanding and production of sounds as connected and flowing in predictable patterns, as can be discerned in spoken, ongoing speech or reading. Moreover, the design, methods, processes, procedures and strategies applied to sounds herein intentionally allow for the targeting of multiple sounds and multiple skills simultaneously. This figure is noted as depicting material subject to Copyright;

### Sound Symbols Tracking Form

FIG. 7 provides an illustration of the Sound Symbols Tracking Form, a component of the present invention and a unique chart designed for planning, observing, recording and evaluating purposes as relates to use and application of the invention to teaching and learning about sounds in speaking and reading activities, with application to writing and spelling. The Sound Symbols Tracking Form (or “Tracking Form”) is useful for tracking activities during all phases and all activities related to the invention. The Sound Symbols Tracking Form is organized according to modified alphabetic information and is presented in a way that outlines the sound system presented in the invention, while providing information relating to the invention. The sounds in this form are based on sounds normally spoken in the English language, as represented in various forms using modified versions of Roman alphabet letters and symbols contained in the International Phonetic Alphabet (International Phonetic Association, 1999) or IPA, which are noted as prior art for the purposes of this invention. This chart is uniquely designed to be used for planning purposes and to track student productions and progress by sounds and sound productions instead of by letter knowledge or recognition. In addition to providing a listing of all the sounds in the invention, the Tracking Form is designed to allow for documenting of the various ways in which sounds are used (both correctly and incorrectly). This figure is noted as depicting material subject to Copyright;

### Sound Symbols Reading Processes, Procedures, Strategies and Activities

FIG. 8 illustrates and outlines information on the component of the invention that focuses on Reading Processes, Procedures, Strategies and Activities. Said processes, procedures, strategies and activities relating to this component are outlined in this figure, while including specific steps and methods that make this component unique in terms of the function it plays in the invention and in teaching and learning about sounds and sound patterns. Specific terms related to this component of the invention are addressed in this figure as well. This figure is noted as depicting material subject to Copyright;

### Sound Symbols Sound Prosody

FIG. 9 illustrates and outlines information on the component of the invention that focuses on the concept of “Sound Prosody.” This figure includes and addresses various unique aspects of sounds that are part of this concept and component of the invention. This figure also contrasts this component with the concept of “Prosody,” which is considered to be prior art for the purposes of this application. This figure is noted as depicting material subject to Copyright;

### Sound Symbols Feedback System: System and Supports for Feedback, Self-Monitoring, Self-Cueing and Self-Corrections

FIG. 10 illustrates and outlines information on the component of the invention that focuses on “Feedback.” This figure includes and addresses various unique aspects of feedback and the feedback system and supports that are part of this component of the invention. This includes unique ways of teaching, promoting, and using self-monitoring, self-cueing, and self-corrections. This figure is noted as depicting material subject to Copyright;

### Materials for Conveying Methods, Procedures, Processes, Tools, Items, Kit Components, and Directions Relating to the Invention and Corresponding Activities and Actions Relating to Such Forms of Conveyance

FIG. 11 illustrates and outlines examples of materials related to and exemplifying materials in the invention. Materials related to the invention, regardless of the form they take, are to be referred to commercially as “Sound Symbols Speaking and Reading Approach” or “Sound Symbols.” Said materials and any variants thereof, regardless of their composition, means of manufacturing or form, electronic, rigid, flexible or otherwise, which relate to the present claimed invention are deemed to be elements of the invention. This figure is noted as depicting material subject to Copyright.

### DETAILED DESCRIPTION OF THE INVENTION

The present invention offers a unique approach for simultaneous instruction in speaking and reading. It offers methods, processes, procedures, strategies, materials, items, tools, and kit objects (herein all of which are also referred to as “components of the invention” or “components” or the “invention”) for teaching and learning how to correctly perceive and produce speech sounds and to read written representations of spoken speech sounds, with application to writing and spelling. The invention provides a system and processes for teaching individuals to speak or to express themselves orally with improved intelligibility while learning to read, or to associate written sounds with spoken sounds. The invention offers a systematic approach and means for teaching and learning about sounds and about associations between spoken and written sounds, while learning to recognize sounds, elements of sounds, and sound patterns. The systematic approach in the invention also promotes teaching and learning about how to distinguish, produce, manipulate, segment, sequence and combine sounds, in order to improve both speech intelligibility and reading skills.

The components of the invention uniquely provide students with multiple ways of accessing information about sounds and about how sounds are produced. The invention also provides a novel, systematic approach and means for teaching individuals about the multifaceted nature of sounds, as well as how to associate spoken sounds with written sounds. Using the invention, students learn to recognize sounds, elements of sounds, and sound patterns, in addition to learning to distinguish, produce, manipulate, segment, sequence and combine sounds, as they engage in work on improving speech intelligibility and reading skills. These aspects of the invention are useful for facilitating teaching and learning about the nature and use of sounds in various spoken and written forms.

Users

The invention and each of its components have been designed for use in teaching and learning activities in any setting and by any instructors (e.g. teachers, speech pathologists, parents, tutors, etc.) or users (e.g. students, individuals engaged in self-instruction, etc.). Settings where the invention can be useful may include, but are not limited to, classrooms, clinics, rehabilitation or hospital settings, homes, and remote teaching or learning sites, as well as other settings. Users of the invention may include, but are not limited to, teachers or instructors of various types, speech pathologists, parents, various family members, tutors, child-care workers, students of various types (including regular and special education students and second language learners), individuals engaged in self-instruction, and others. The invention is intentionally designed so that it can be easily utilized in a wide range of activities and by multiple types of instructors or users. It is beneficial that users may teach or learn through the invention in real time and physical presence or through virtual means

Although initially conceived of as being useful for students with speech and language disabilities (also similarly referred to as speech disorders, speech deficits, or speech difficulties), the invention holds potential for individuals of any age or skill level for learning or improving speaking and reading skills. The invention is useful for delivering instruction to students with learning difficulties or disabilities of various types, ranging from mild to severe levels of difficulties, where acquisition of speech and reading skills are negatively affected. These students include, but are not limited to, those with speech and language disabilities, students with reading disabilities, students with hearing impairments, and students with other learning or developmental disabilities. The invention is useful for students learning English as their first language, as well as for those students learning English as a second language.

The invention also holds potential for teaching and learning in other languages. Although the sounds of American English are presently described and utilized in the invention, the design of the system and processes of this invention are capable of accommodating adjustments, where needed, for representations sounds in any spoken or written language.

The invention is likewise useful for delivering instruction to students with very limited knowledge of speech sounds and minimal sound productions, as well as being useful with students who have received extensive instruction in speech sounds and reading skills but still require interventions. The invention is readily applicable for use with students having a wide range of ages and skill levels, in part, due to the ability to use either the full and complete invention or separate component parts of the invention. The ability to make choices or opportunities to select the most applicable components for each student or groups of students contributes to the efficiency and effectiveness of the invention. Using the invention, specific student needs may be targeted and individualized programs can be provided whether students are working one-on-one with instructors or as members of groups. With this invention, instruction can even be uniquely delivered in an individualized manner for students who are members of either small or large groups.

The invention has been specifically designed so that its components can be used with a wide range of students. A major aim of the invention is to provide a program that can meet the needs of students who customarily fail, or experience significant difficulties making progress, in learning how to speak or read. Additional purposes or objectives of the invention include offering efficient but powerful processes and tools for initial teaching of speech and reading skills and for offering interventions. The invention was therefore designed to be applicable and useful for students functioning at varied ability levels. Moreover, use of the invention can promote easy, progressive transitions from modeling to interactive production of sounds and sound patterns, and then to independent identification and production of spoken and written sounds. Given its design, the invention is therefore readily applicable to instruction of students of all ages, ability levels and language backgrounds. The use and application of the invention with such a wide range of users, both instructors and students, differs from traditional approaches which tend to focus on more narrowly defined application of curricular materials for select target audiences (e.g. students by narrow age levels, teachers of select grade levels, etc.).

Application of the Invention

The components in the invention may be simultaneously applied or used as individual components. The components may be used in a wide range of activities, such as (but not limited to) work on sounds in live or recorded speech, work on sounds in syllables, words, phrases, sentences, or in various literacy activities, and in work on sounds in other speaking and reading activities, along with writing and spelling activities. Examples of activities where the invention and the components of the invention could be incorporated include tasks involving talking or listening activities; reading, writing, or spelling activities; and activities related to learning about specific subjects, as well as application of the invention to work with other types of materials or topics. Examples of application of the invention to other activities and the use of various materials could involve reading and writing (as well as spelling) with any type of substance, whether using paper-based or other types of materials such as chalkboards, whiteboards, and Smartboards. Additional activities and materials could also include use of manipulatives to reinforce productions of sounds or to represent sounds (such as the use of letters to represent sounds made of magnetized, plastic, wood or paper based products). Applicable activities could also include tasks combining sounds and applying use of sounds in words during any variety of language-based tasks (e.g. modeling, naming, describing, interacting, story-telling, questioning, playing with toys, games or game-like items, etc.). Combining use of the components of the invention with these types of activities and assorted materials can facilitate student associations between spoken and written sounds and provide benefits during any variety of instructional activities.

This invention can be used as a stand-alone program, utilizing all or some of its components for initial instruction in speaking and reading skills. The invention can also be used in combination with other speech or reading programs or materials, thereby providing a means of clarifying or supplementing instruction in order to increase effectiveness and efficiency of instruction or to serve as an intervention. Additionally, the invention is useful for providing individualized instruction, as well as instructional supports for specific students or student groups, during the use of traditional programs and traditional approaches to speaking and reading instruction. The invention is beneficial for use as a means of clarifying or augmenting teaching in other academic instruction, particularly when students need additional supports for recognition, comprehension, retention and use of spoken or written sounds and words. The invention is useful for all of these purposes, given the assortment of components incorporated into the invention and the manner in which the invention provides multimodal supports for addressing various needs of teachers and students. The range of methods, processes, procedures, and strategies, as well as flexibility, incorporated into this invention allow for unique maximization of teaching and learning opportunities.

The invention may also be used more narrowly to target select sets of sounds or sounds having specific relationships with one another. For example, voiced or voiceless sounds could be selected or targeted for initial work. Other distinctive features or aspects of sounds could also be targeted for use with the invention. Particular sets of sounds or specific individual sounds, to the exclusion of other sounds, can be targeted or focused on at any given time during use of the invention's components. Such select use of the invention's components with specifically targeted sounds can be readily and easily integrated into other activities, including educational, social and other sorts of activities.

All of these applications of the invention provide benefits to students and instructors when teaching and learning about spoken and written sounds. Additional benefits are also derived from the flexible design of the invention, which contributes to its value in terms of ease of application and use. This invention can accommodate a wide range of student needs and learning styles, given the qualities of the invention which allow it to be used as a stand-alone program as well as an integrated program that can simultaneously meet group and individual learning needs (e.g. individual students or small groups of students within larger groups).

Various Unique Aspects of the Invention

This invention is innovative and distinctive, given its unique combination of components (including methods, procedures, processes, materials, items, tools, and kit objects), which are not found in these same configurations in other educational items. The invention is distinctive in its use of unique visual prompts (Sound Symbols Visual Prompts) for presenting sounds, providing particular hand, arm and finger shapes, positions, gestures, and movements for each sound that correspond with written letters and with the manner in which the sounds are formed physically (e.g. lip, mouth, tongue and orofacial positions and movements).

Instruction in the manipulation of sounds is unique, in this invention, given the flowing or fluid process in which sounds are sequenced and connected in a circular fashion, rather than a linear fashion. Moreover, the invention helps students understand the discrete aspects of which specific sounds are comprised, so that they can simultaneously learn about the boundaries between sounds while they learn about the features that make sounds distinct, by using the Sound Symbols Sound Circle and related items. Additionally, the invention is unique in its treatment, presentation, and organization of sounds. The invention is furthermore unique because of the inclusion of the concept of “Sound Prosody” which is defined and described in the related component.

All of these aspects of the invention combine in novel ways to provide a unique, efficient and effective approach to teaching and learning about sounds. This invention offers distinct but concrete ways of helping teachers and students present, use, understand and learn about how to produce and manipulate spoken and written sounds in isolation, in syllables, in words, in progressively harder combinations and contexts, and in ongoing speech or writing. The invention is particularly useful for helping students understand some of the more perplexing sounds and normally confusing alphabetic or written representations of sounds, including those comprised of multiple letters or sets of letters. Confusion between spoken and written sounds can be significantly decreased and even eliminated through use of the invention and its component parts.

In the invention, one modality uniquely supports another, so that use of auditory, visual, proprioceptive, tactile, kinesthetic (e.g. mouth, tongue and orofacial movements and positions; finger, arm, and hand positioning, gestures, and movements), spoken sounds, and written forms of sound productions come together to reinforce associations between all of these various aspects of sound productions. Moreover, instruction using the invention promotes student interest and motivation in learning, recall and use of sounds in their various forms, as well as the ability to self-monitor, self-cue, and self-correct.

A very unique aspect of the invention is the manner in which corrections can be provided and the ways in which the use of self-corrections can be promoted without interrupting student productions during speaking and reading activities, using the Sound Symbols Feedback System and Sound Symbols Visual Prompts. This approach is particularly useful for establishing students' use of self-monitoring, self-cueing, and self-corrections. Furthermore, use of the invention can also simultaneously promote and increase accurate recall of and associations between spoken sounds and written sounds.

In the invention, specific actions and prompted information provided through use of the “Sound Symbols Visual Prompts” and the “Sound Symbols Sound Circle” uniquely facilitate understanding of how to segment or separate, connect, sequence, and manipulate sounds. Use of this invention helps students gain an understanding of these various aspects of sounds. Use of the concepts and processes learned when utilizing the “Sound Symbols Sound Circle” also increase student understanding of the positioning of sounds, including initial or beginning, middle and ending sound positions. Moreover, when using the “Sound Symbols Sound Circle” students simultaneously engage in and practice visual tracking of written letters and letter patterns (paired with their corresponding sounds) while learning how to produce these target sounds in various positions in syllables.

The invention's inclusion of visual prompts, or the “Sound Symbols Visual Prompts,” provides effective and efficient visual demonstrations of sound productions that can represent each and all of the elements discussed above in sounds, syllables, words, phrases, sentences and utterances or connected speech. It is important to note that users of the invention can begin to easily learn about sounds by learning one visual prompt at a time, gradually expanding until proficiency in use or recognition of multiple prompts is achieved. The tools and charts in the invention can also be referred to in order to facilitate learning and use of the prompts.

As noted above, a unique aspect of the invention involves development and application of the concept of “Sound Prosody”. “Sound Prosody” is an original concept and original term developed in conjunction with the invention to explain and demonstrate specific concepts of sound productions not yet recognized, incorporated, or explained in other speech and reading programs. “Sound Prosody” differs from and goes beyond the traditional notions of “prosody,” which has historically been applied to syllables, but not sounds. The application of prosody to syllables, words, and phrases has held in spite of the fact that Ball (1989) reported that disruptions of usual patterns of coarticulation can be as disruptive to intelligibility as changes in sounds and features of sounds.

Prosody is generally said to include rhythm, patterns, stress, intonation, pitch, loudness and syllable length. These features of prosody are commonly considered individually and less often in combination or simultaneously. It should also be noted that the idea of prosody is not normally addressed when considering the understanding or production of sounds during acquisition of speaking and reading skills. Instead, prosody is usually given consideration during discussions of syllables, phrases or grammatical features (such as its use in rising intonation to signal questions).

In this invention, the concept of prosody is applied primarily to sounds (instead of syllables or words) and therefore the term “Sound Prosody” was formulated to exemplify this component of the invention. This conception of “Sound Prosody” includes various aspects related to sounds such as the following: sound length or timing (e.g. average length, shortening or extension of production of sounds); space or pauses between sounds and words (inadequate space or timing between sounds can be comparable in nature to the concept of run-on writing); individual sound rates and ratios (such as the rate between sounds and ratios among sounds); overlap between sounds and transitional aspects among sounds (which differs from, but can correlate with co-articulation); variations in intonation and emphasis during sound productions (including but not limited to aspects such as vigor or softness, gentleness, firmness, tension, or harshness); the boundaries of (including completeness of, clipping of, or cutting off of parts of sounds) and between sounds; and the ways in which these aspects of sound productions affect the distinctiveness of the features of the sounds (ranging from very distinct to so indistinct that one or more features transform into different features). These aspects of sounds may be viewed as similar in nature to what have been called suprasegmental aspects of productions (e.g. see Ball, 1989 and above discussion of prosody and suprasegmentals), although application is hereby made to sounds instead of syllables with the identification and inclusion of additional features that apply to sounds. The concept of “Sound Prosody” addresses aspects of sounds that facilitate understanding and production of sounds in ways that can help students identify unique aspects of said sounds and subtle differences among sounds.

The concepts, components and processes in the invention utilize an array of unique approaches for specifically portraying sounds, individually and in various combinations (spoken and written). It should be noted that visual and auditory modalities are commonly incorporated into many programs or approaches, while gestural and tactile senses are less commonly included. Very infrequently is consideration given to proprioceptive, kinesthetic and tactile senses, or senses such as touch, pressure, tension, and timing, which are incorporated into this invention. This invention includes and addresses these various senses because each sound has unique features which can be made known or identified through the use of these senses and concepts related to them. In this invention, all of these senses, individually and in combination, are incorporated into instruction pertaining to the comprehension and use of spoken and written sounds.

Conveying the Invention

The components of the invention may be conveyed in a variety of ways, using an assortment of materials. The invention may be presented or displayed in person through actual presence or through virtual means, as well as through the use of various other forms or displays that represent and explain the components of the invention. For example, the invention may be displayed in electronic, digital or computerized forms or through use of any variety of materials, substances or compositions (whether rigid or flexible materials, applying text or without text, using pictures, drawings or actions, with or without audible sound) in order to demonstrate position, formation, production, and use of sounds through the following: actions and motions; use of gestures, fixed or moving positions and shifting gestures or movements; spoken and written demonstrations; pictured, drawn or physical demonstrations; or modeling production and use of sounds in various forms. Any of the components may be conveyed as individual components of the invention or conveyed in combined forms. Any or all of the components of the invention may be presented in kit forms, as well as the various forms noted throughout this description of the invention.

Formats for presenting or demonstrating the invention may include, but are not limited to, the following: written or printed forms (e.g. paper, books, booklets, pamphlets, pictured, whether rigid or flexible in form, or using text, pictures, drawings, photos, or digitized information on permanent or disposable materials), audio versions, recorded versions, versions using mechanized, digital, or electronic processes (e.g. dvd, cd, website or web-based formats, digitized, digital displays or retrieval systems, electronically stored or transmitted forms or displays, downloaded or saved files, computerized forms including storage on hard drives and/or external or flash drives or similar devices, projected on smart boards or video displays or using similar means, as apps for tablets or cellular phones and other related devices, etc.), and other similar formats that are presently available or may become available. Visual and tactile materials in the invention may be made of any variety of paper or paper-based materials, such as cardboard or tagboard; plastic materials or materials containing plastic coatings; metal or magnetic materials; whiteboard materials; fabrics; and/or other types of construction materials. These materials may contain printed or written letters and designs to represent sounds or letters and components of the invention using various media comprised of black, white, and other colors.

Regardless of their composition and means of manufacturing, these items (such as materials, tools, and kit components representing the methods, processes and procedures of the invention) which relate to the present claimed invention are deemed to be elements of the invention. This includes materials and components made of or manufactured from the following substances or combinations of substances: paper, cardboard, tagboard and other paper-based products; fabrics, wood and cork products; ink and paint based products; plastic materials or materials containing plastics; resin and synthetically-based products; metal, magnets or magnetized materials, and computerized, digital or digitized, and electronically-based or electronically stored (e.g. web-based storage, mobile apps or software, computerized files, electronic files or disks, emails, DVDs, internal or external hard drives, flash or thumb drives, and similar electronic storage devices) materials; and any other materials which retain their relationship to the invention. The materials and kits germane to this invention may contain adhesive properties, such as stickers and tape-based products. Fasteners of any variety may be attached to these materials or be used to connect materials included in the invention, not to be limited to such fasteners as clips, hooks, pins, loops, tapes, and connective substances of various types for attaching items in the invention.

Said items, materials, tools, kit components, and any variants thereof, regardless of their composition, means of manufacturing or form (whether electronic or manufactured through any of various means), which relate to the present claimed invention or methods, procedures, and processes in the invention are deemed to be elements of the invention. Additionally, beyond the items, materials, tools, kit components, methods, procedures, and processes, all of the teaching and learning concepts presented in the invention are integral elements of the invention, which provide specific and unique benefits to users of the invention. All of the components in this invention relate to skills, methods, processes and procedures for teaching and learning how to speak and read using spoken, written, pictured, demonstrated, and gestured or prompted sounds which can be seen, heard, felt and perceived using visual, auditory, tactile, proprioceptive and kinesthetic senses. The components of this invention aid teachers, students, and users in recognizing, producing, and making associations between target sounds and their corresponding written forms. This invention and its related components also aid users, teachers, and students in making corrections on errors and in providing or receiving feedback (both externally and internally) for decreasing sound production errors during speaking and reading tasks. Each sound is presented with unique identifiers to facilitate teaching and learning of speaking and reading skills. Moreover, this invention uses a unique multisensory linguistically-based approach for teaching and learning about sounds in speaking and reading activities.

The following sections address these unique aspects of the invention in more specific detail. Figures are provided as visual supports for each section.

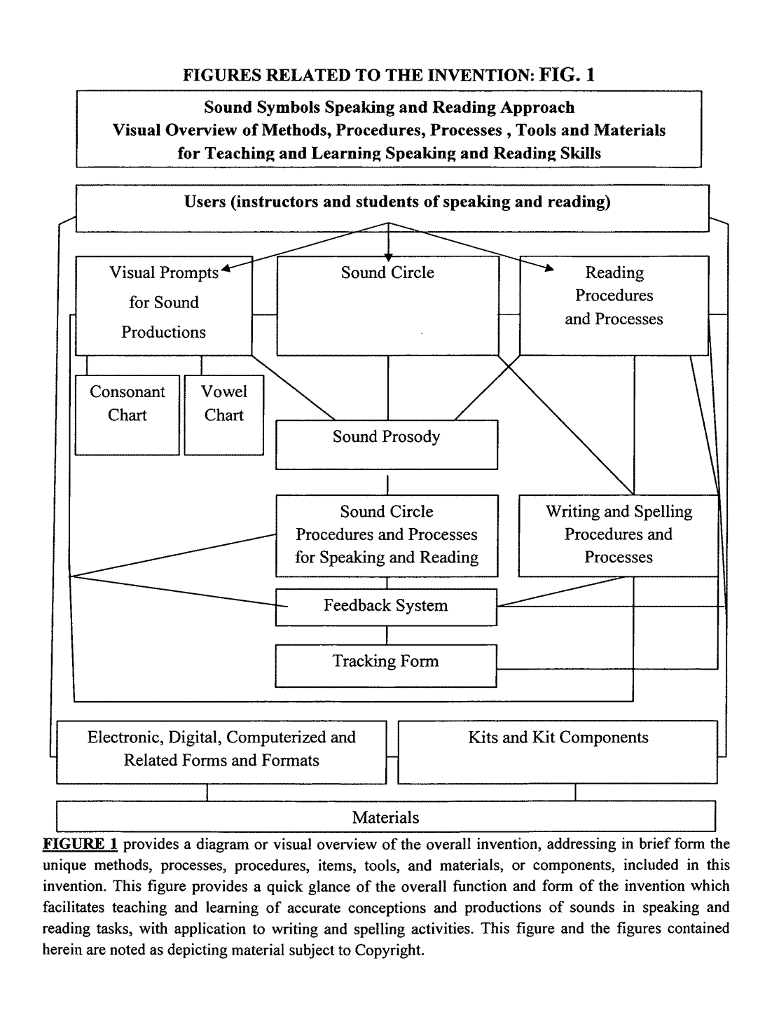

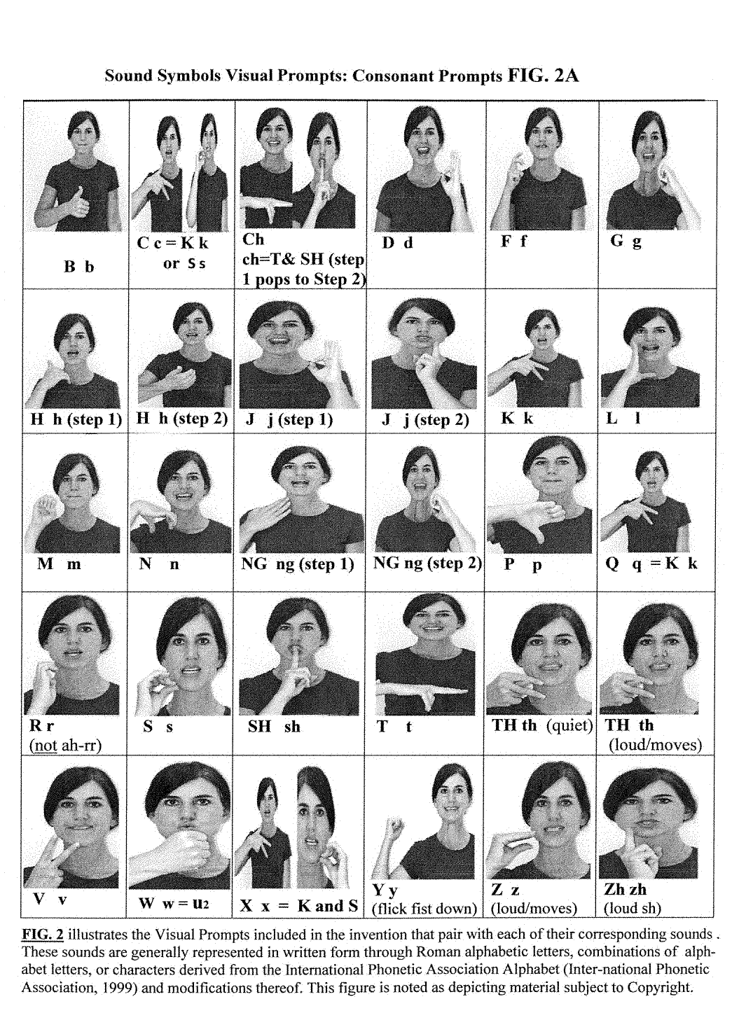

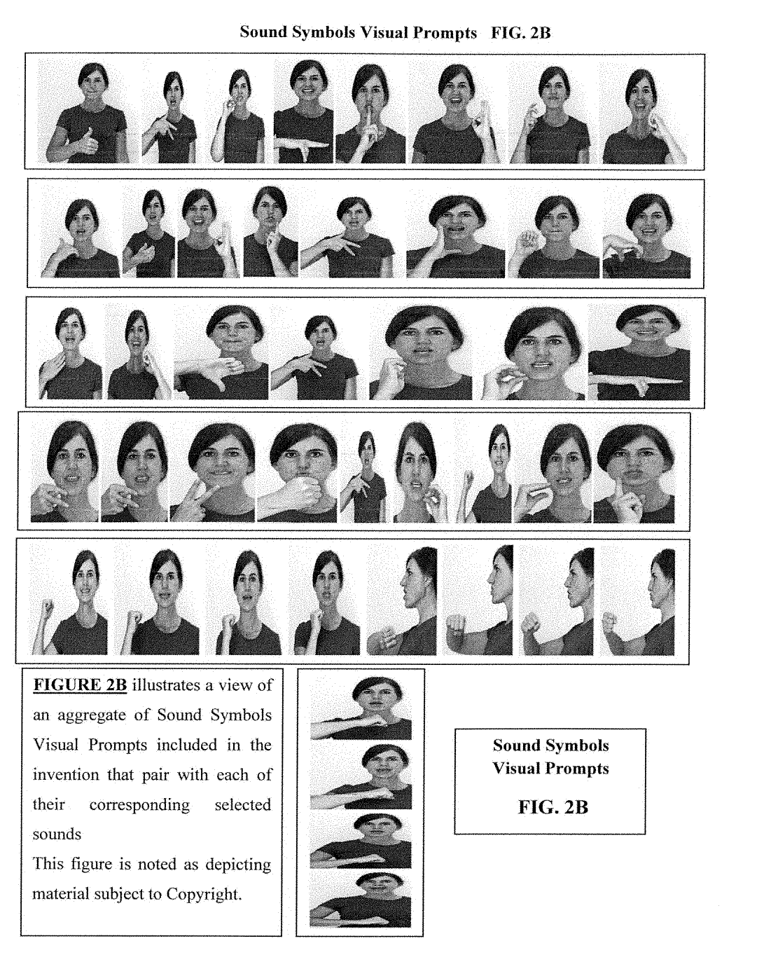

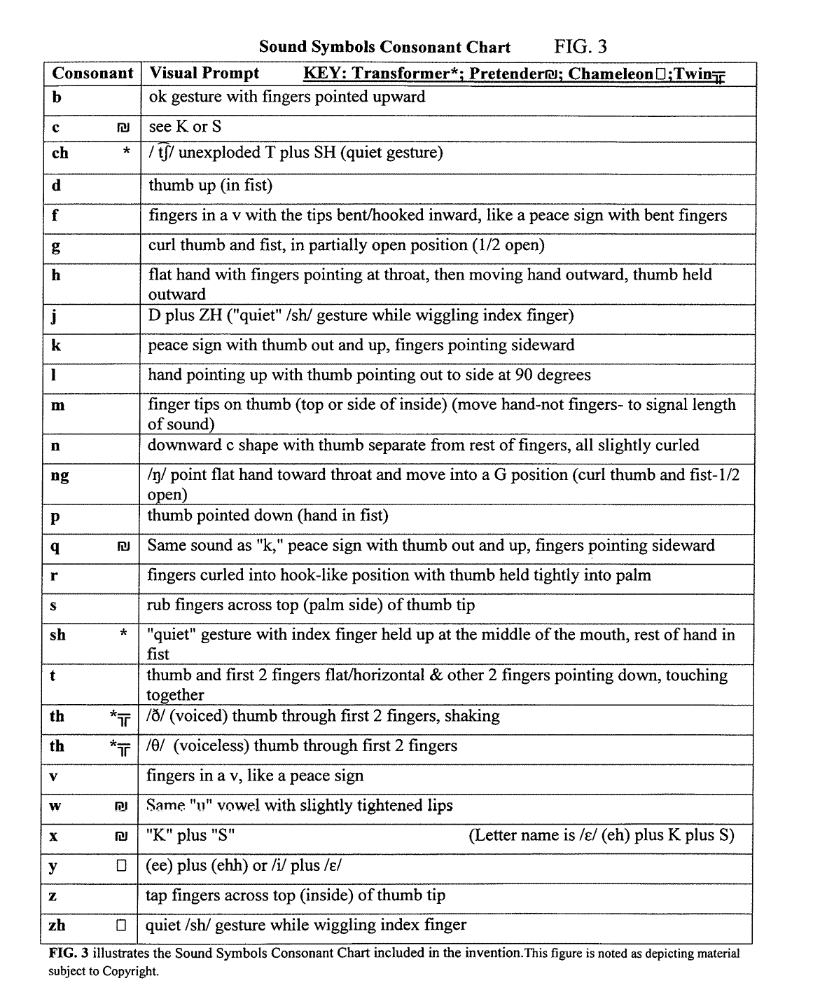

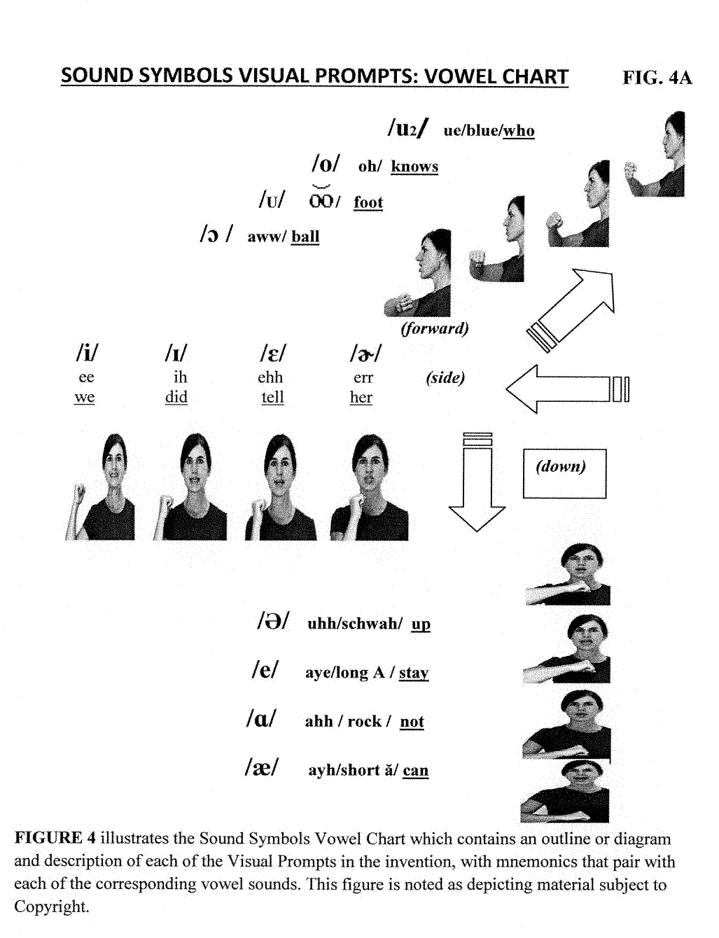

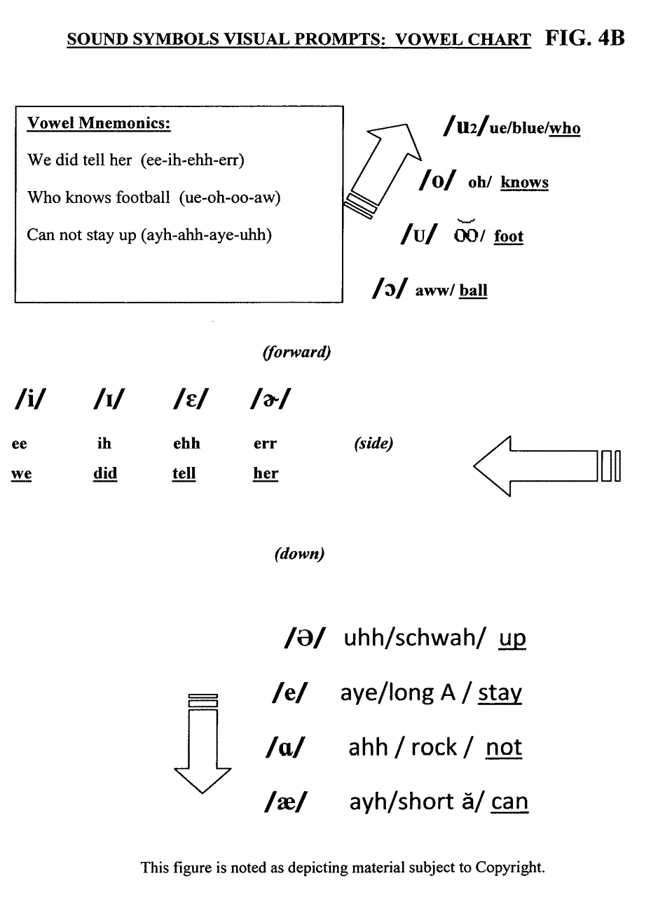

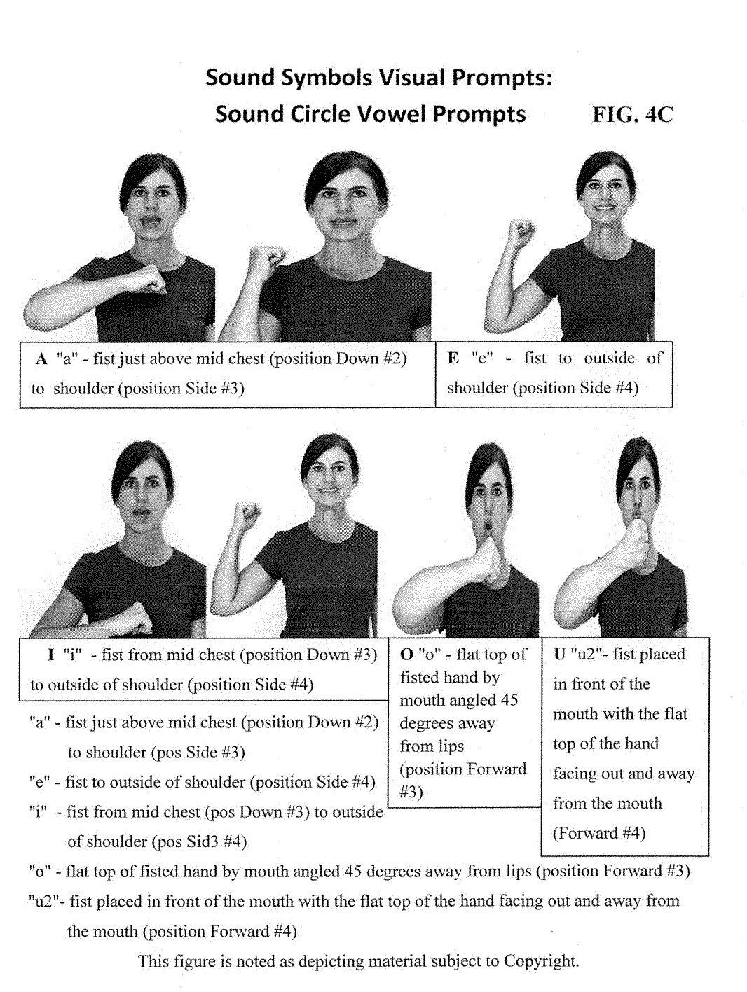

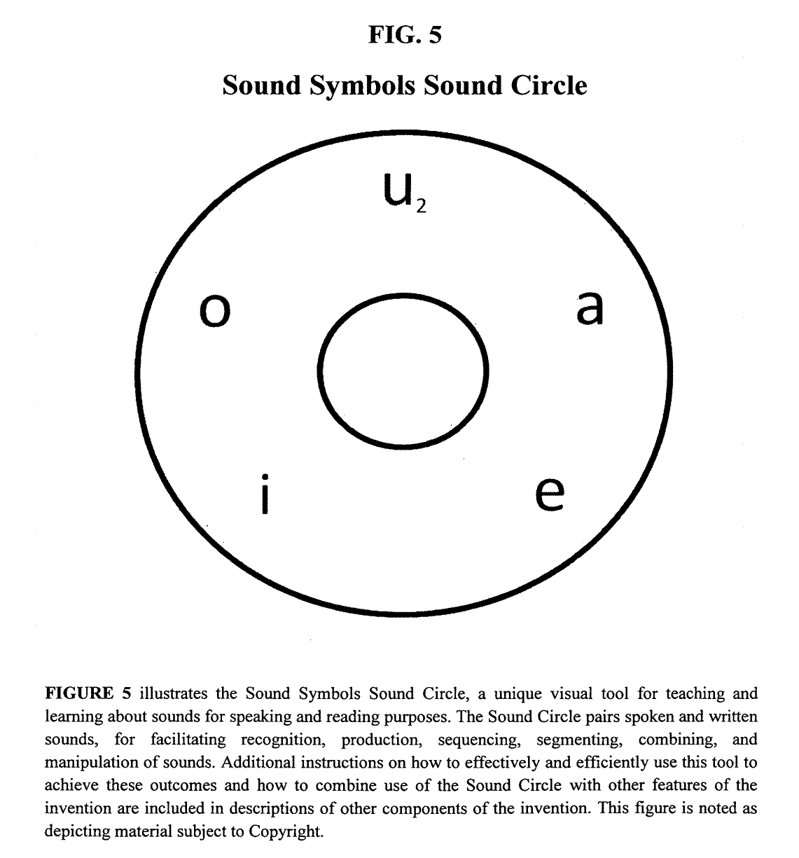

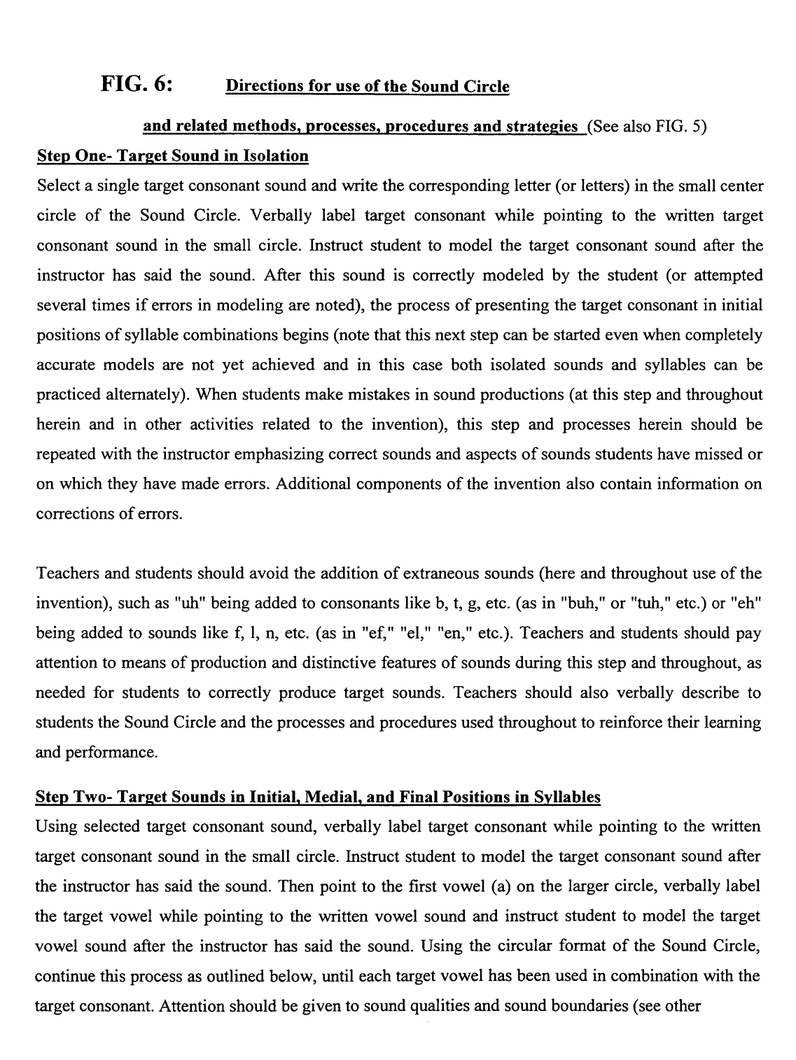

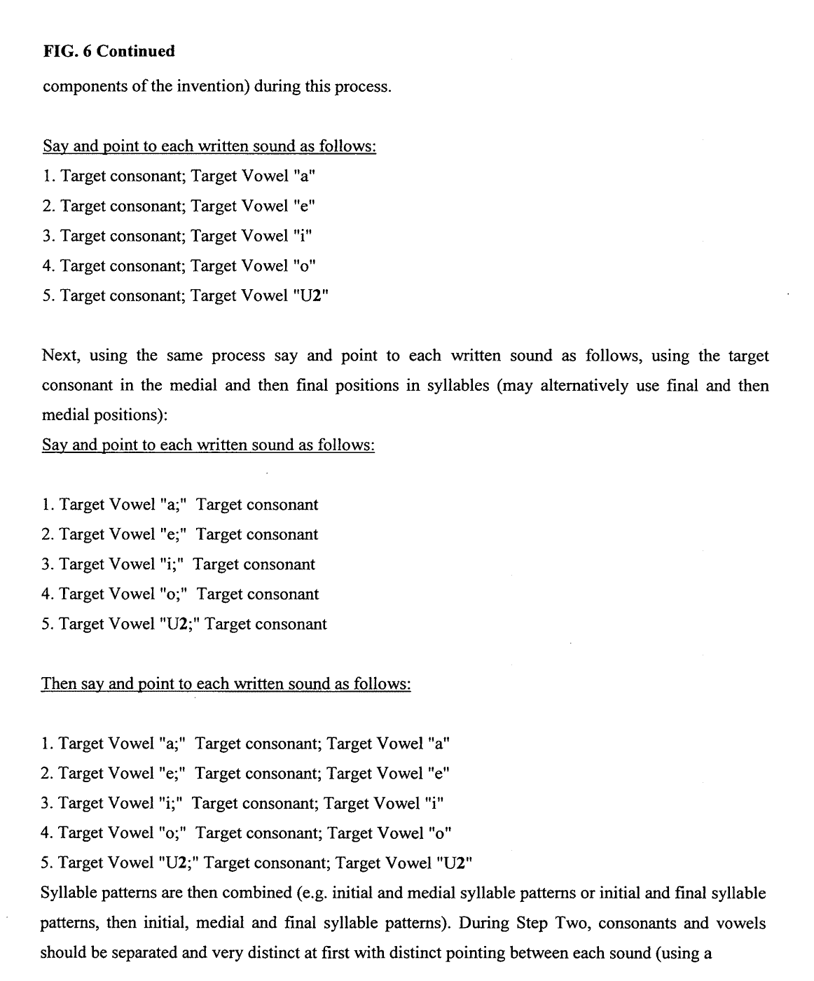

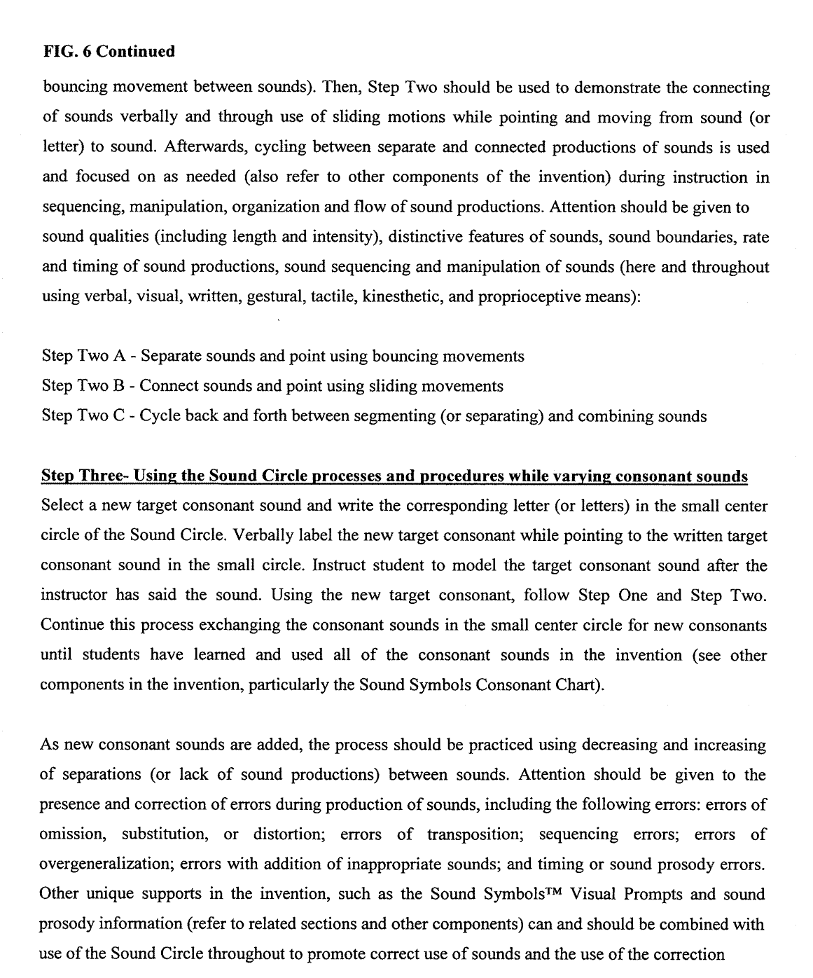

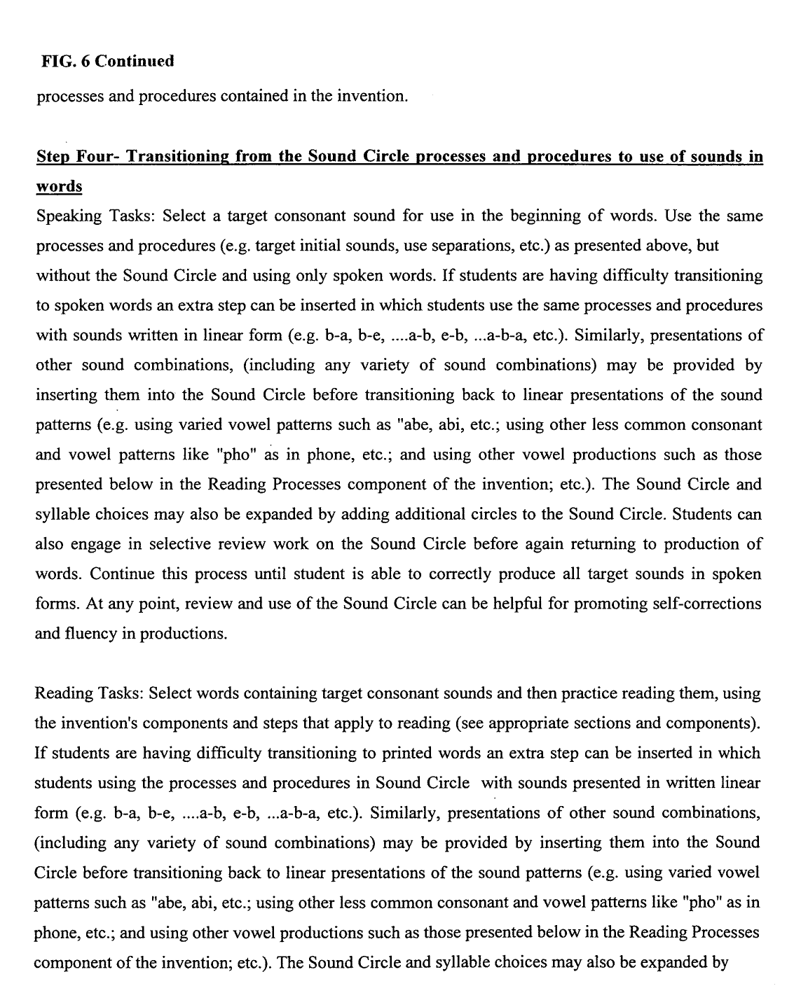

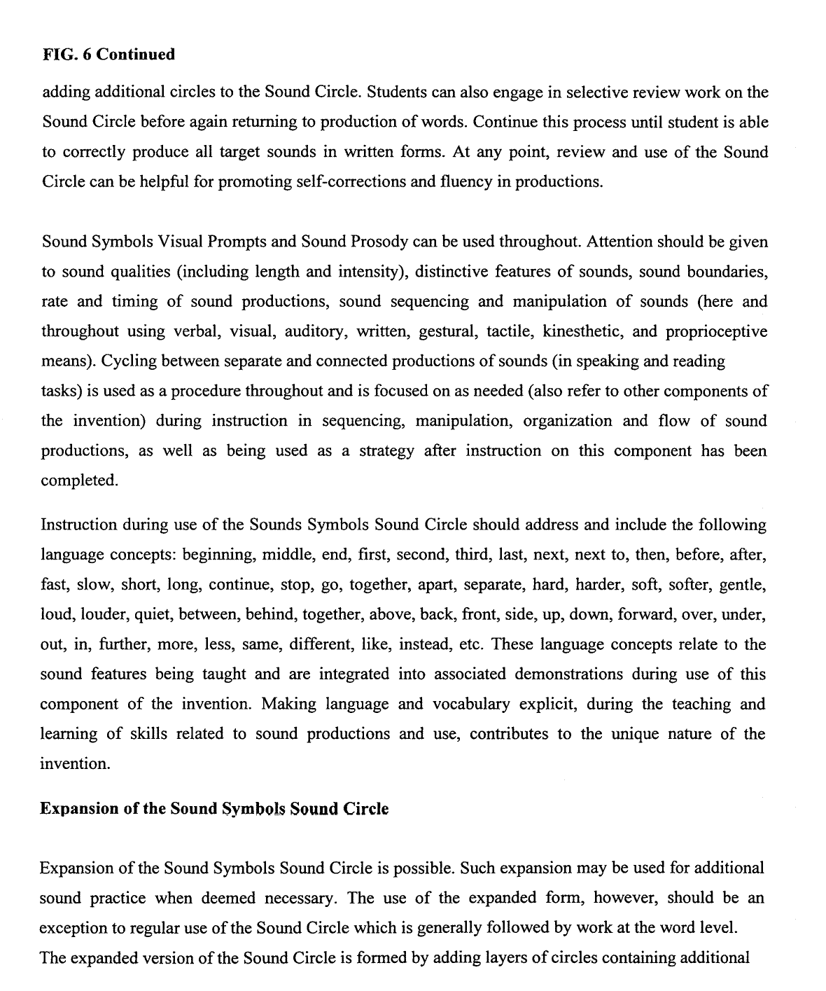

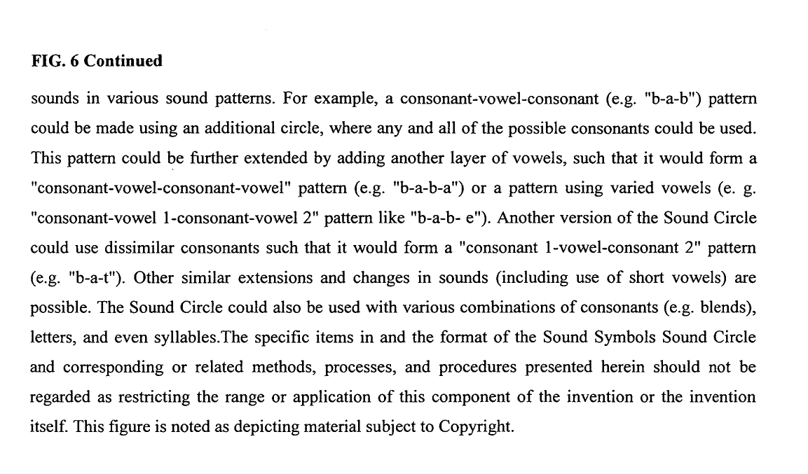

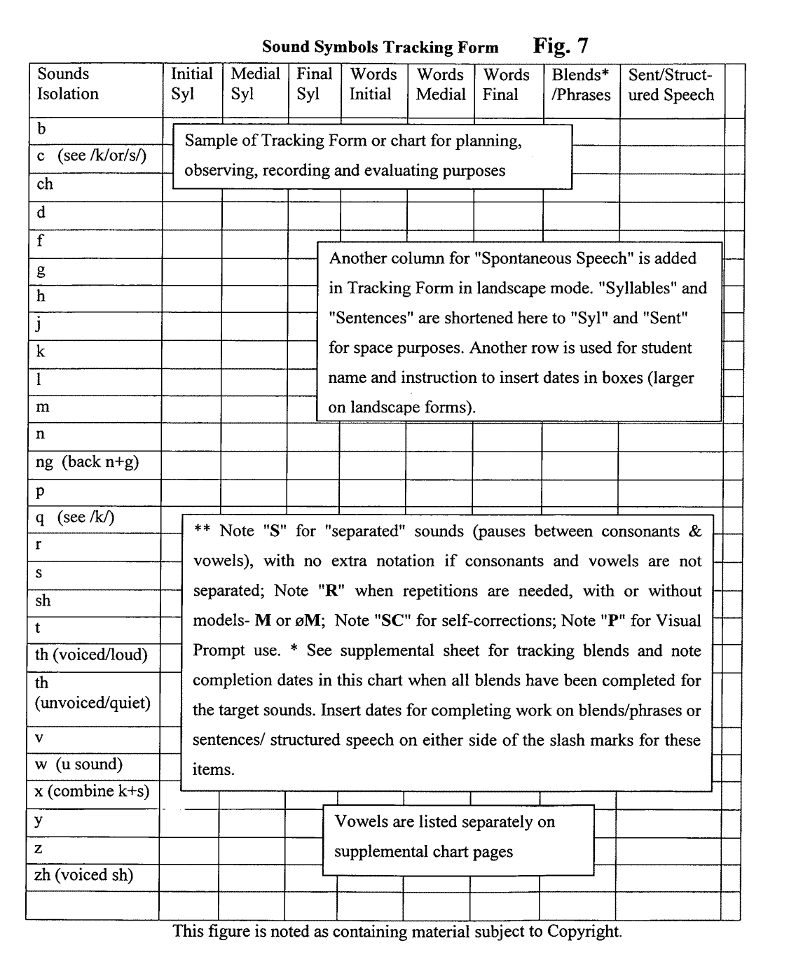

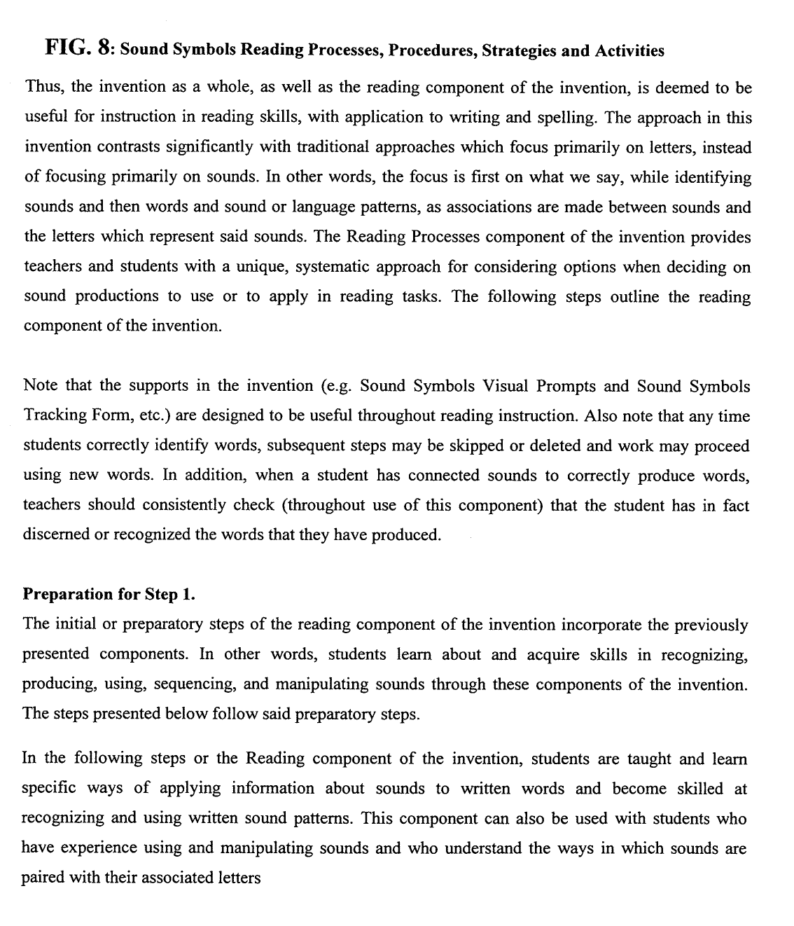

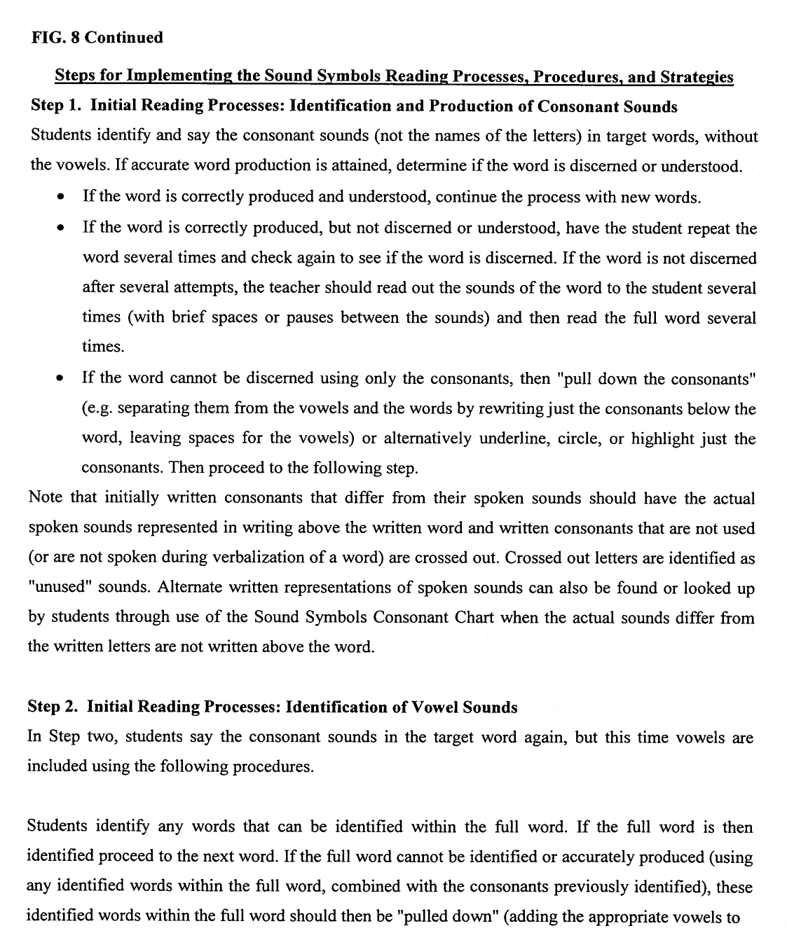

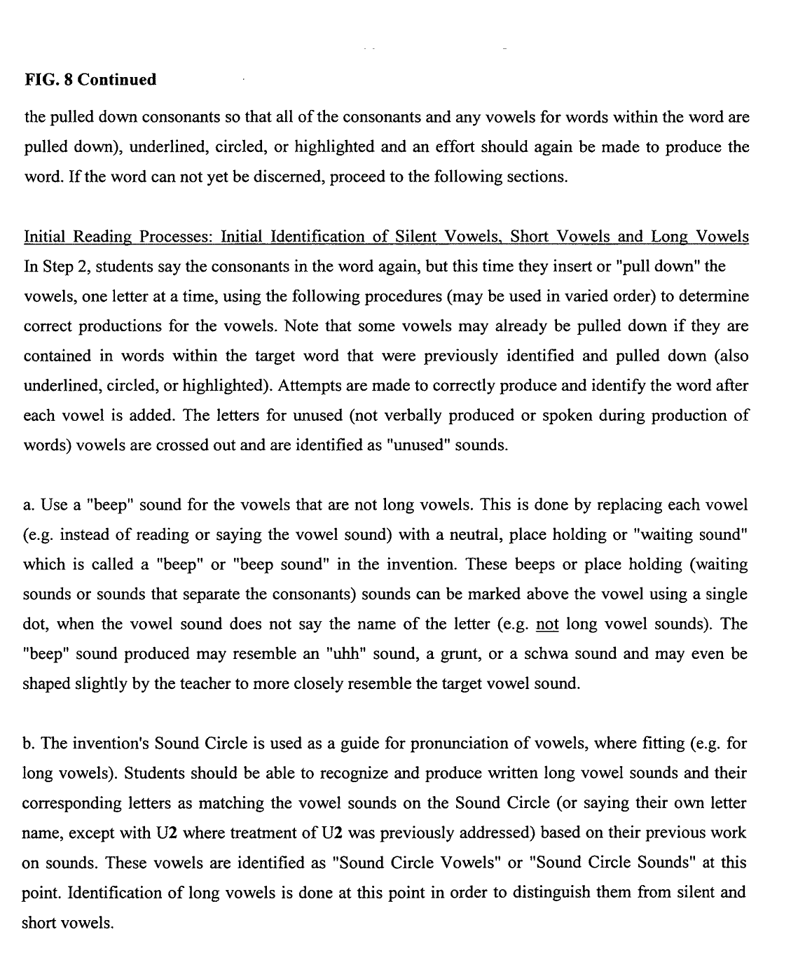

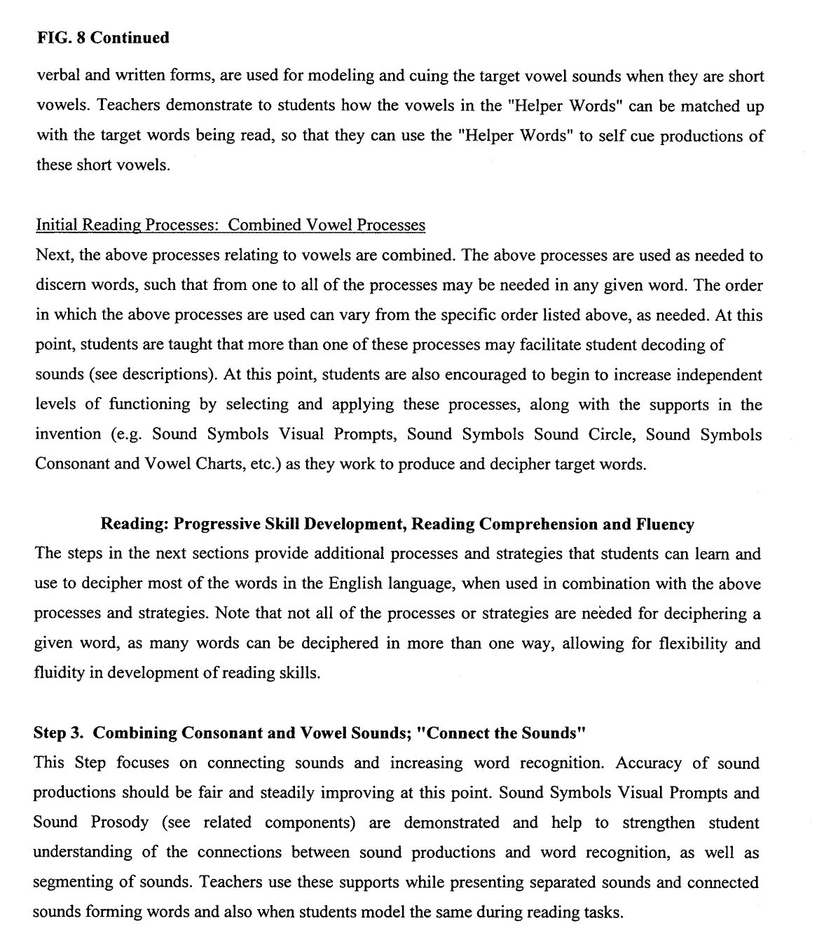

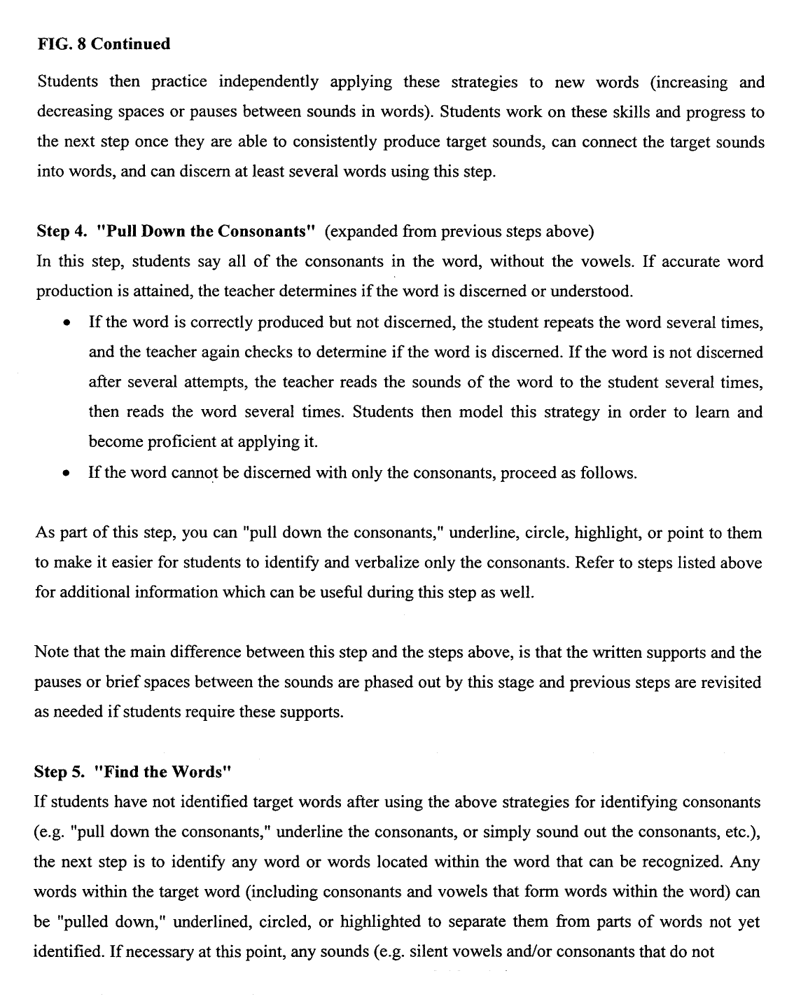

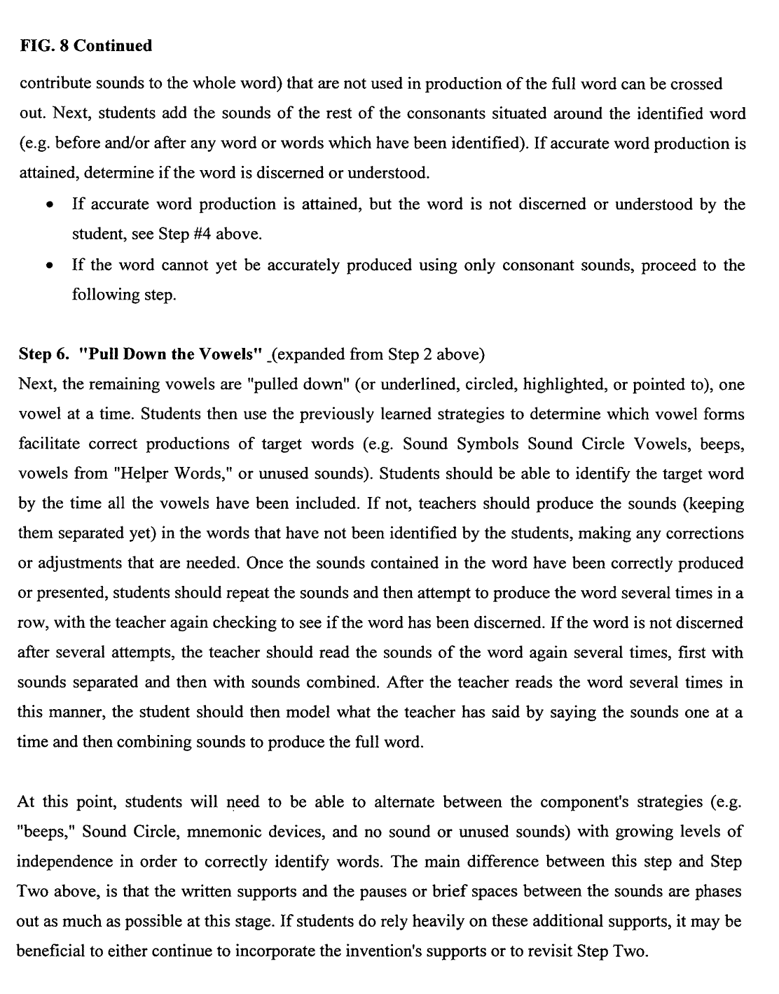

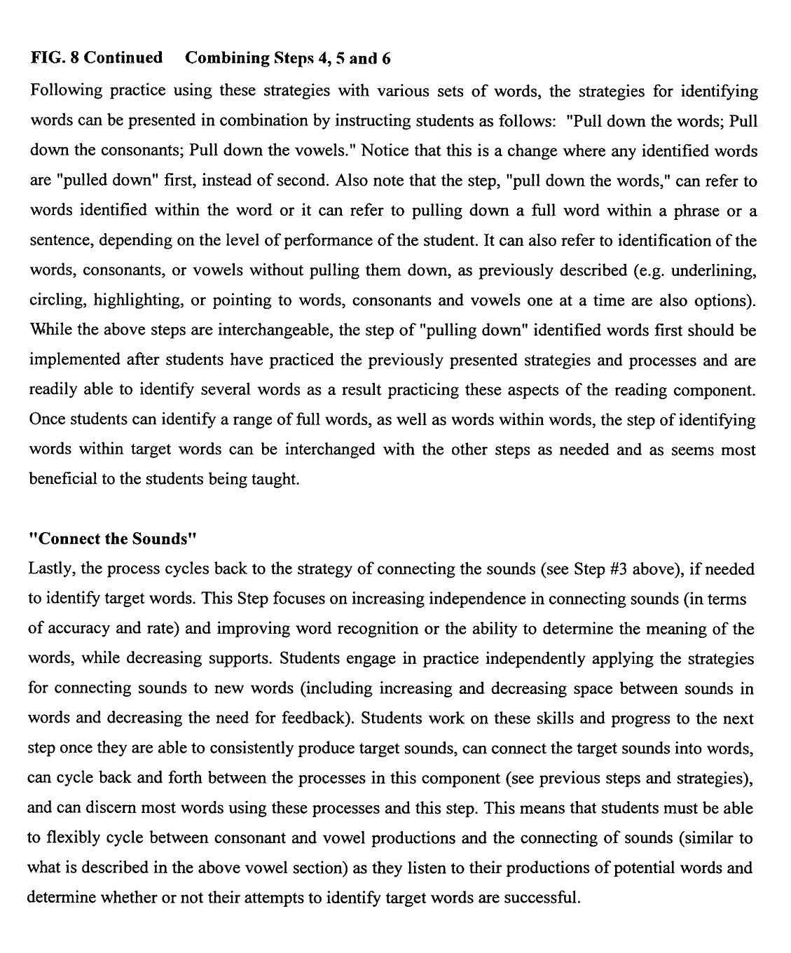

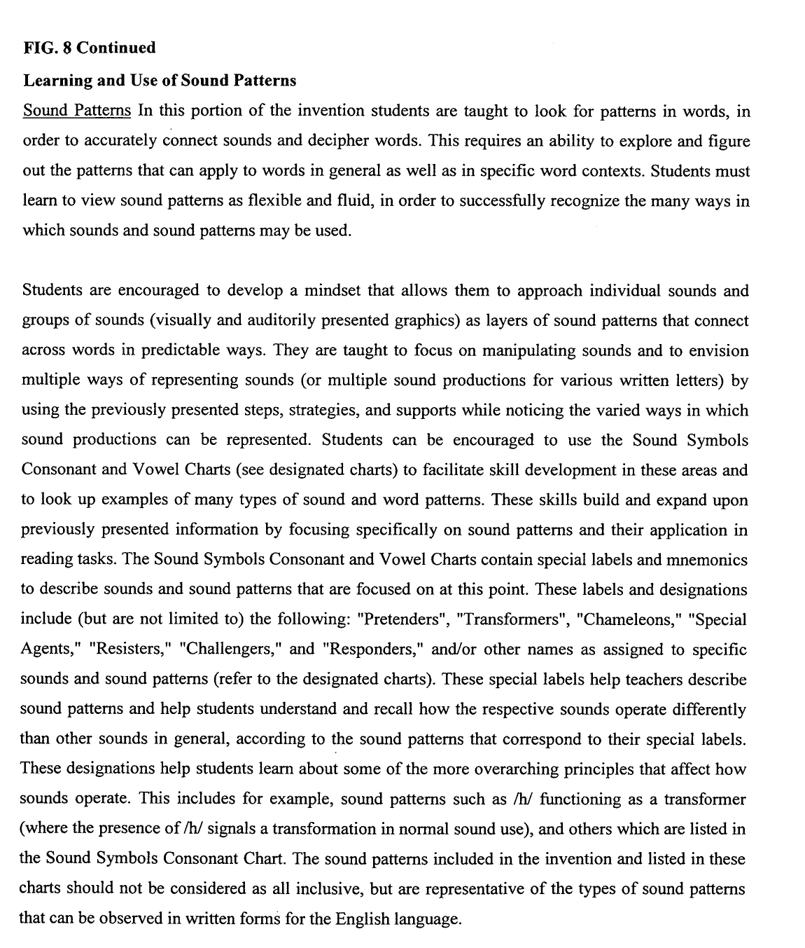

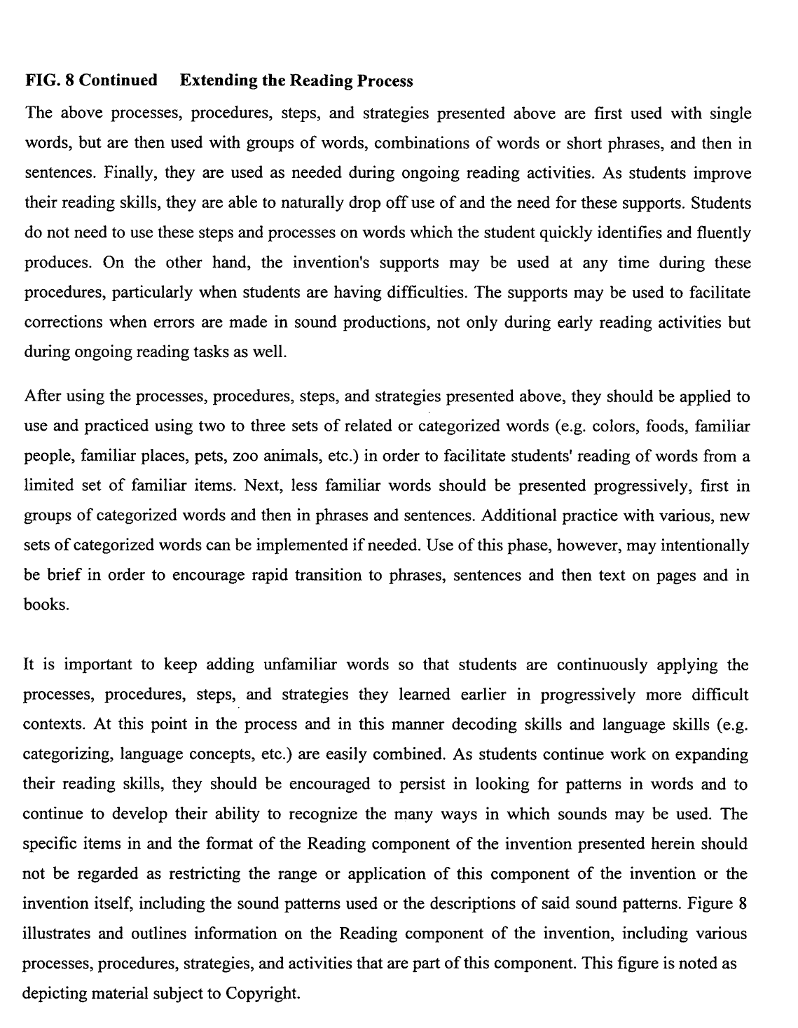

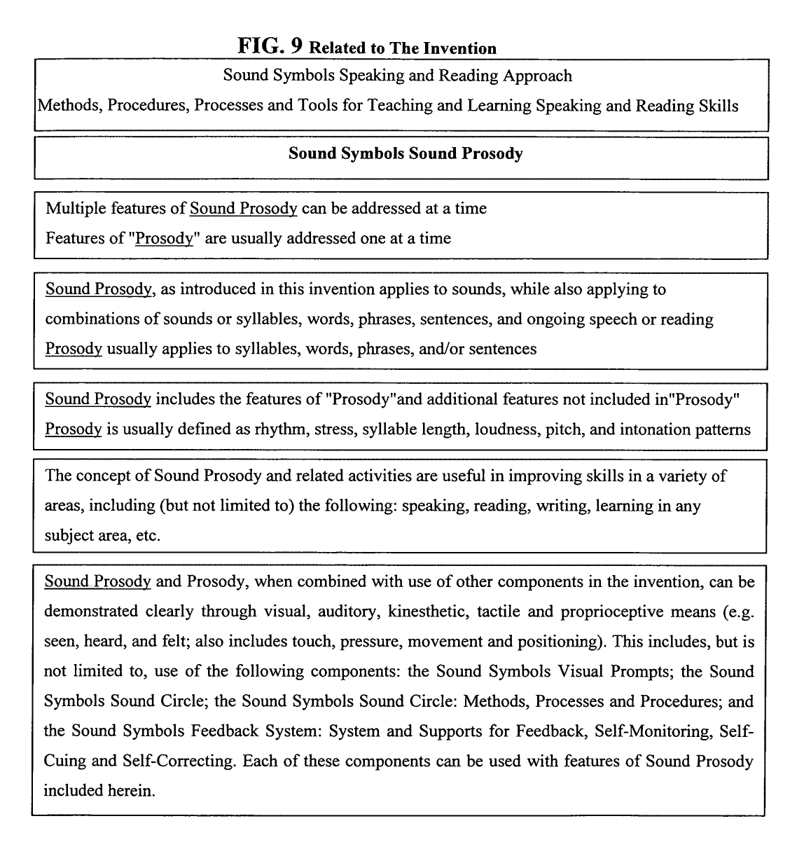

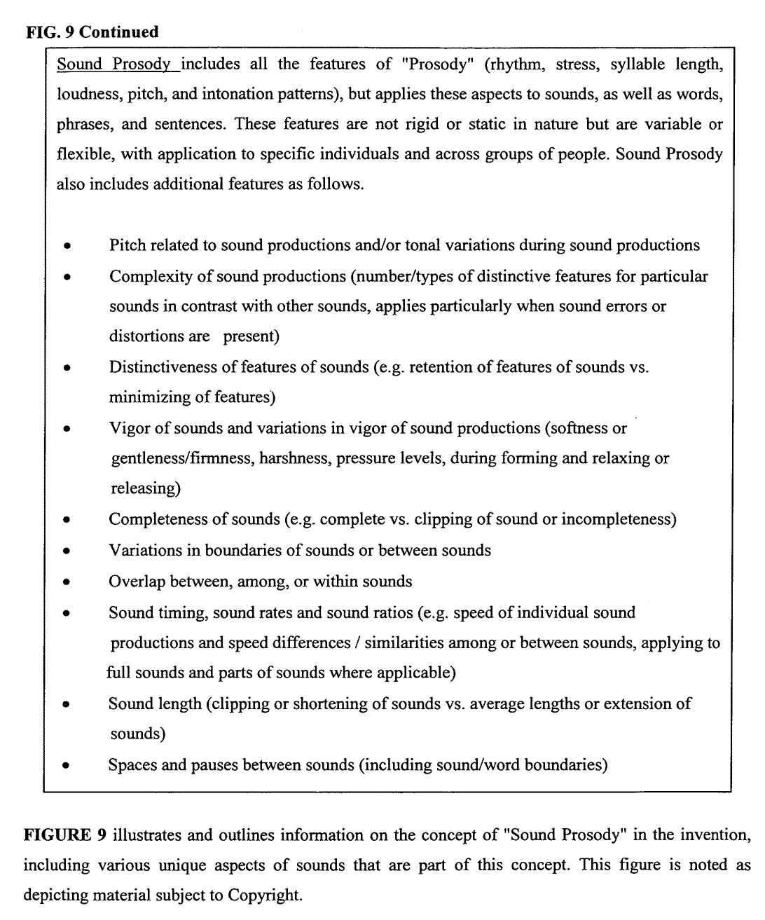

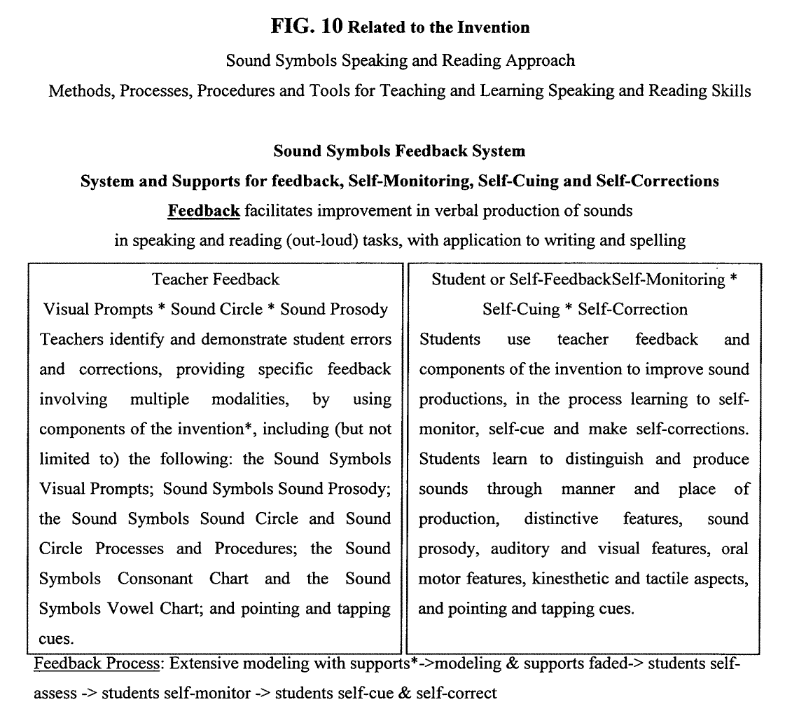

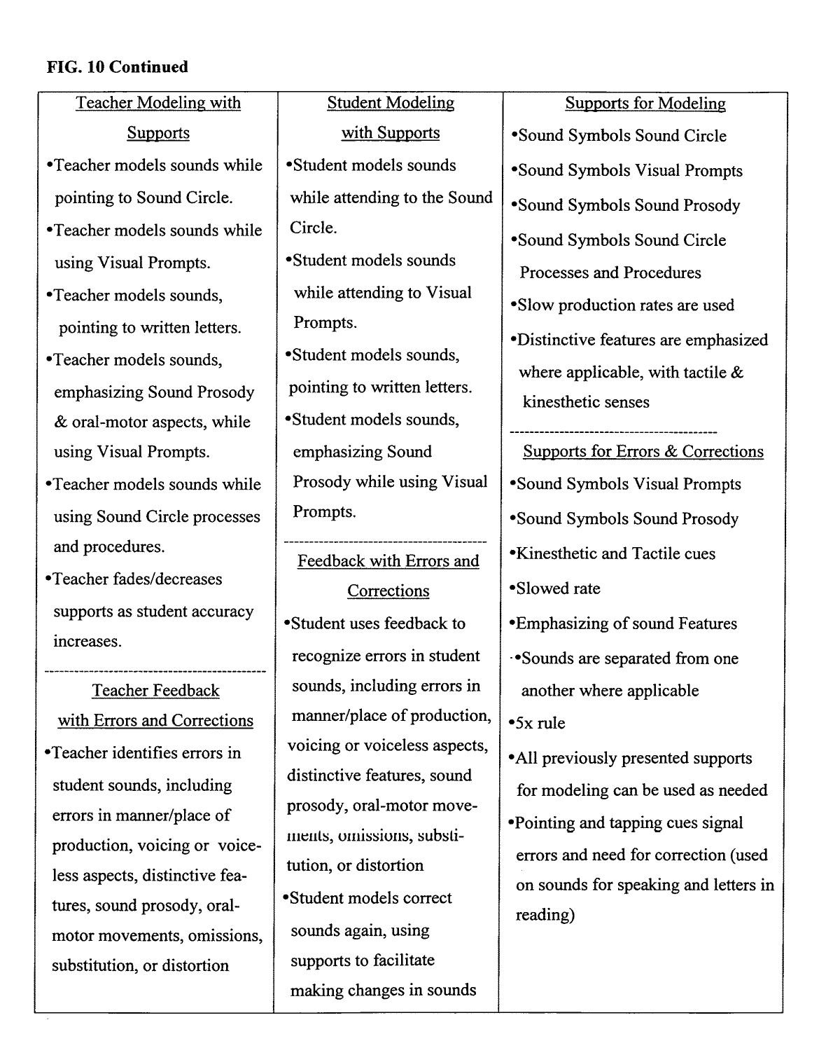

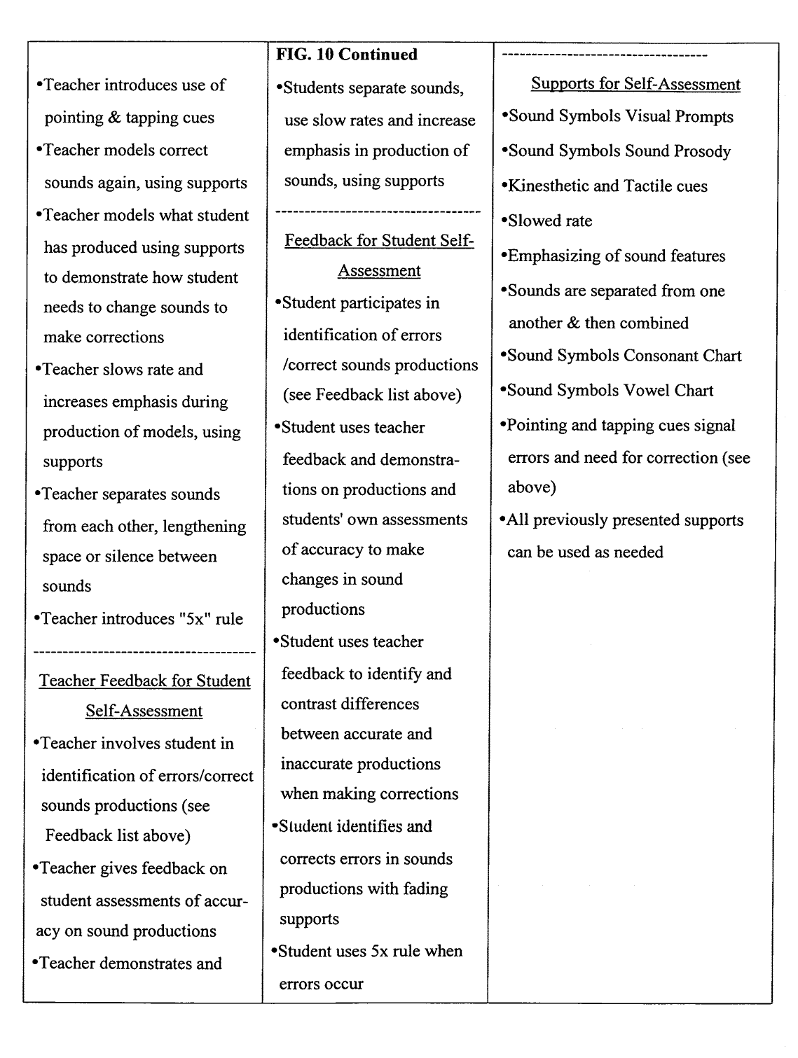

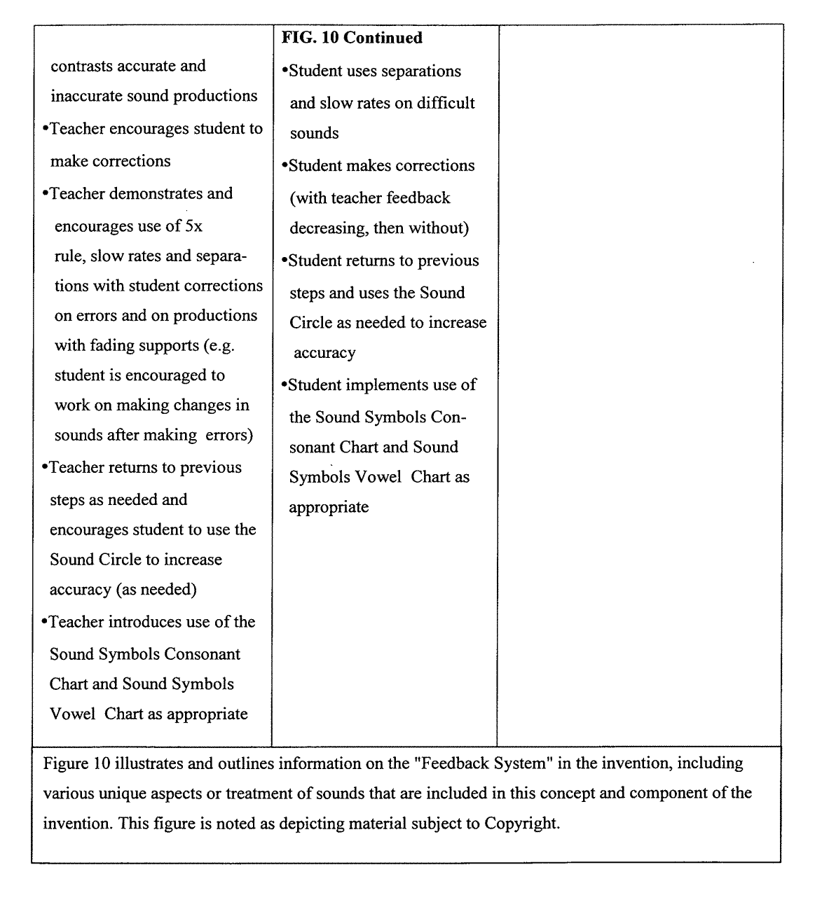

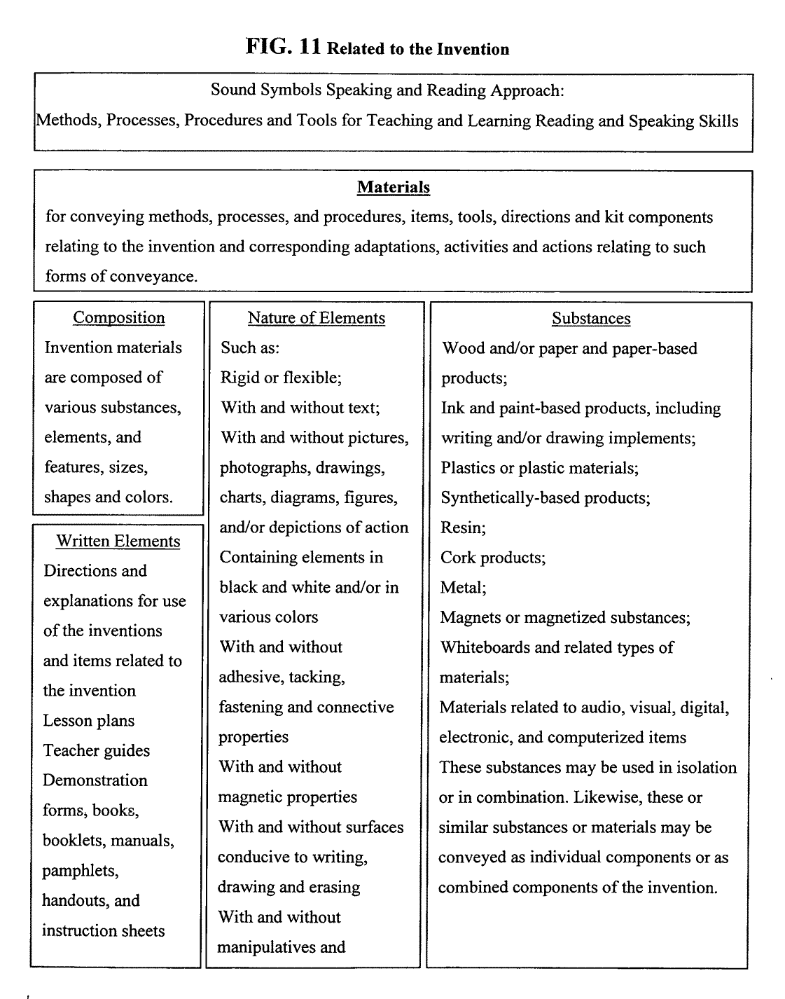

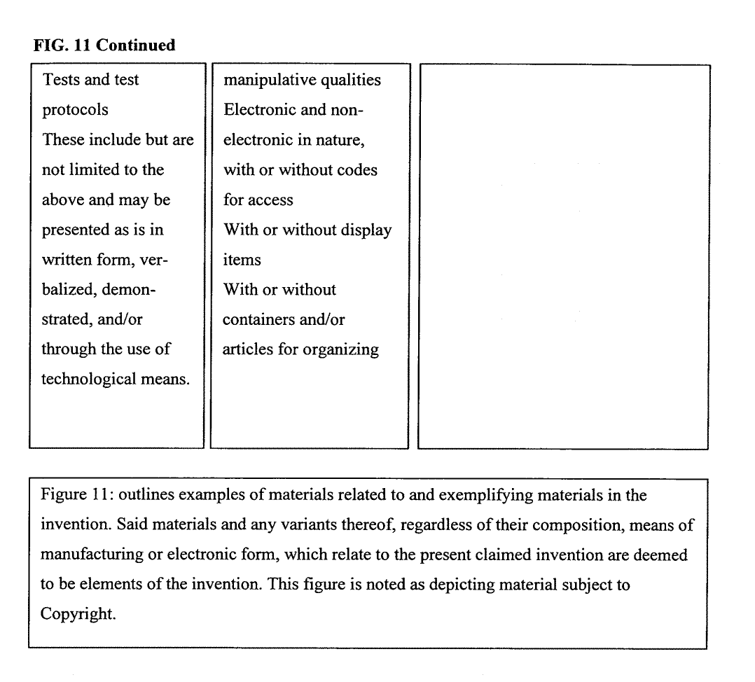

Pertaining to Claim 1 and FIG. 1: Sound Symbols Speaking and Reading Approach

The invention herein provides a unique system for the teaching and learning of speaking and reading skills, with application to writing and spelling activities. This section addresses an overview of the invention, or a view of the invention as a whole entity. Taken as a whole, the invention (or the Sound Symbols Approach) provides methods, strategies, directions, processes, procedures, supports and tools for teaching, distinguishing, making or producing, practicing, and correcting sound productions, and providing feedback related to sound productions during speaking and reading tasks (as well as writing and spelling tasks). These are provided within one overall systematic approach that is flexible and can be divided into component parts.

One of the most important aspects of this invention is that it moves beyond the usual approach of presenting sounds as isolated or single, static entities through the use of instruction which proceeds on a sound by sound basis (e.g. typical approaches focus on single sounds, teach one sound at a time, and focus on letters as the chief concept). The invention accomplishes this and moves beyond such a limiting view of sounds and reading by providing a unique approach for the teaching and learning of concepts and the provision of supports which are able to facilitate and increase students' understanding of key features of sounds, sound patterns, and of sound systems. The invention uses multiple systems of supports, with the inclusion of multisensory approaches and materials, for imparting this unique method and understanding of sounds.

Moreover, the methodology, processes, procedures and strategies used in this invention differ from other less efficient and effective, but generally accepted approaches which emphasize the teaching of letter names and the sounds that letters make, where the emphasis is on the letters. It should be noted that letters, in the invention, are presented as written examples of sounds where the names of the letters themselves are not taught. In this invention, the emphasis is on the sounds as the most important feature, while corresponding written symbols and visual prompts are presented based on their associations with the sounds and as representations of the sounds (instead of the other way around). As a result of this focus, the invention is able to promote student awareness of their own progress as they increase their understanding of the nature of sounds (in spoken and written forms). The invention is therefore reinforcing to student efforts to work on and make changes in their perceptions, productions and use of sounds in speaking and reading tasks (which can carry over to writing and spelling tasks).

Consistent with this way of thinking, components of the invention are organized by sounds using a modified alphabetic system that emphasizes sounds over letters. Similarly, the materials and sound charts in the invention are not strictly alphabetical, but are nevertheless organized in a modified alphabetic manner that allows teachers and students to make use of familiar alphabetic cues and formats where it is beneficial to use them. The modified alphabetic system is more consistent with the invention, although it is loosely based on the International Phonetic Alphabet or IPA (International Phonetic Association, 1999) and the Roman alphabetic system or letters which are considered as prior art for the purposes of this application.

As noted above, the initial emphasis in the invention is on sounds and sound productions, even though sounds are paired with the letters that correspond to the sounds. Students are taught various skills related to sounds, including skills that relate to perception, differentiation, and accurate production of sounds. While teaching students about specific sounds, students are simultaneously shown some of the varied ways in which spoken sounds can be represented in written forms. Students learn to make associations between sounds and letters through instruction that puts a continual emphasis on the role of sounds during lessons that progress from representations of sounds in basic written forms (from an emphasis on single sound combinations and corresponding letters to combinations of sounds in written words) to multiple means of representing sounds in written forms.

Through use of the invention, students are provided with strategies for learning about sounds. They are also provided with unique ways of handling exceptions to the more regular relationships between spoken sounds and written representations, through the use of the various components of the invention which are described herein. One of the ways students learn about sound patterns and how to handle exceptions is by using specific wording or phrases that help to explain the exceptions (refer to Reading sections, Sound Symbols Consonant Chart and Sound Symbols Vowel Chart). The invention provides students with unique ways of understanding a variety of sound representations, such as single sounds represented by multiple or combined letters (e.g. sh, th, ch, etc.), single sounds represented with multiple spellings (e.g. f, ph; ks, x, s, c; etc.), multiple sounds attached to single letters (e.g. g said as /g/ and /j/, c said as /s/ and /k/, s said as /s/, /z/, and /zh/, etc.), and letters that do not have their own sounds or share sounds with other letters (e.g. c, q, w, y, and zh). Descriptions of these are found in the Reading sections, the Sound Symbols Consonant Chart, the Sound Symbols Vowel Chart, and the Sound Symbols Visual Prompts, as well as in discussions of the processes and procedures that are addressed throughout this depiction of the invention.

The invention is also useful for helping students produce blends or combinations of consonants in speaking and reading tasks. Using a more traditional approach, Blevins (2006, p. 123) identifies two ways in which sounds are blended, distinguishing oral or auditory from phonic or visual blending. Blevins (2006, p. 66) also distinguishes pairs of consonants or blends (where the combined consonants represent multiple sounds) from consonant clusters or digraphs, which represent single sounds. For the purposes of this invention, digraphs are presented as single sounds which use two letters, while auditory and visual blending are combined or used together in a multisensory approach (viewing blending as a naturally combined form and function, instead of viewing auditory and visual as separate types of blending) involving both consonants and vowels. In other words, blending is more of a function and action in the invention, where sounds are combined into words. As such, combinations of consonants are not treated as unique, separate entities, except when they form digraphs or single sounds which use two letters to set them apart. These distinctions are important, in this invention, because the blending of sounds is viewed herein as an action specific to the pairing of sounds and letters while merging the sounds into discernible words. In other words, sounds are taught as single sounds, whether using one or two letters and the process of combining sounds (whether consonants or vowels are used) is viewed as the blending of sounds. Typical combinations of consonant pairs (e.g. bl, dr, rg, etc.) are not taught or addressed as separate entities, except where semantic or syntactic issues pertain (e.g. ing, ed, s/es, etc.).

The methods and components of the invention include all of the processes, procedures and strategies used in the invention overall. The unique design of the invention promotes teaching and learning of correct pronunciations of sounds, including particular individual or segmented sounds and correct pronunciations of sounds in connected or ongoing speech and reading. The invention is also adaptable so that it can be used for teaching and learning of only speaking skills or only reading skills, allowing for flexibility in use. On the other hand, the invention is uniquely suited for promoting rapid improvement in speech skills while simultaneously introducing and integrating literacy skills. The invention allows speech and literacy activities to be integrated in various ways. The invention may be used as a whole applied simultaneously to both speaking and reading (with application to writing and spelling) or it may be used to selectively address discrete aspects of speaking or reading. Each of the unique components which make up the invention as a whole are described in more detail in subsequent sections of this depiction of the invention. As a unique tool for teaching, learning and improving of speaking and reading skills (with application to writing and spelling), this invention provides a valuable addition to the fields of speech pathology and reading instruction specifically and education in general.

Pertaining to Claim 1 and FIG. 2 a b: Sound Symbols Visual Prompts

The system of claim One, wherein the invention includes and incorporates unique Visual Prompts to represent sounds. In this invention, one of the ways in which sounds are represented is visually through the use of finger, hand, and arm positions, gestures and movements (in person and/or through various media) identified in the invention as “Sound Symbols Visual Prompts” (also identified throughout as “Visual Prompts” and “prompts”). This component of the invention is comprised of Visual Prompts that offer a unique system for visually demonstrating, in a concrete manner, abstract aspects of speech, reading, and language concepts. In other words, the Prompts provide uniquely structured, concrete visualizations of sounds through visually presented prompts using the physical positions, gestures and movements presented in the Prompts. This component of the invention is useful for teaching and learning about sounds and sound patterns, with application to speaking, reading, writing, and spelling. This component of the invention is further characterized as follows.
The Visual Prompts provide concrete information through physical positions, kinesthetic movements, tactile and proprioceptive information, as well as through visual information paired with auditory information.
These Visual Prompts can simultaneously facilitate learning about spoken and written sounds, while facilitating associations between spoken and written sounds with visual, auditory, proprioceptive, tactile, and kinesthetic information.
The Visual Prompts can be used to simultaneously represent and demonstrate spoken and written sounds, with each sound having a distinctive Prompt (with distinctive hand, finger, and arm positioning, gestures, and movements, which promotes learning of the distinct features of sounds) that can differentiate each sound from other sounds.

Each of the Visual Prompts and their corresponding positions, gestures, motions and unique identifiers can symbolize spoken and written sounds used in spoken language and written communication. The Visual Prompts may be demonstrated singly to represent individual sounds or in a sequential manner to represent connected sounds during ongoing sound production tasks, such as speaking or reading. While the Prompts can visually convey distinct features of isolated sounds, just as importantly, they are able to demonstrate features and variations that occur when individual sounds are embedded in connected speech.

Associations are strengthened by the unique connections established between the Visual Prompts, spoken and heard sounds, written forms of sounds as letters, and proprioceptive, kinesthetic, tactile, auditory and visual senses. The Visual Prompts thereby promote learning of the distinct features of sounds. At the same time, the Prompts and their corresponding positions, gestures and motions for each sound simultaneously incorporate characteristics of their written forms, wherever possible, such that they resemble or bring to mind their written counterparts, in terms of appearance and various specific ways (refer to related figures). As a result, these unique aspects of the Visual Prompts facilitate associations between spoken sounds and written sounds (as letters).

In this component of the invention, Visual Prompts (or finger, hand, and arm positions, gestures and movements) are paired with both spoken and written representations of the prompted sounds. In other words, each sound has a corresponding Visual Prompt, in addition to the usual corresponding written representations of each sound. The written representations of the prompted sounds are designated primarily through the use of alphabetic letters, combinations of alphabetic letters, or characters derived from the International Phonetic Association Alphabet or IPA (International Phonetic Association, 1999). Where presented sounds or phonemes differ from their specific letter sounds (e.g. ch, th, y, etc.), they may be labeled with their corresponding IPA designations. For example, in FIG. 1, the Visual Prompt for the consonant phoneme /ch/ is designated by the specific Prompt for the corresponding sound (consistent with the IPA symbol “[ch]”), which is different than the Prompt for the individual sounds or letters “c” and “h.”

Although the Visual Prompts can be paired with Roman alphabetic letters and IPA designations (or International Phonetic Association designations of the International Phonetic Association, 1999), which are considered to be prior art for the purposes of this application, these Visual Prompts are one of the unique and novel components of this invention (particularly in terms of their design and application). It is important to note, however, that some representations and descriptions of sounds in this invention do not strictly conform to the conventional conceptions of sounds generally put forth either alphabetically or using the IPA. These differences are also additional evidence of the unique treatment of sounds in this invention. Moreover, these Visual Prompts comprise only one, albeit important, portion or aspect of the invention.

In this invention, the Visual Prompts are readily taught and learned in combinations (e.g. blends, syllables, words, etc.), as well as in isolation or as representing single sounds. Similarly, the Visual Prompts can be used as a single element of the invention or in combination with other components of the invention. The invention and this component are also unique due to the ability to use the Visual Prompts in combination with other programs or teaching methodology. Use of the “Sound Symbols Visual Prompts” can be combined with various components and activities in the invention, including (but not limited to) combining them with visual supports, such as pictured, drawn and written items (including displaying and explaining components of the invention,) and speaking, listening, and modeling (includes verbal, gestural, tactile, kinesthetic and proprioceptive) activities.

The Visual Prompts can be used with individuals and groups of students during instruction dedicated to the teaching and learning of sounds. However, the Prompts may just as easily be used during ongoing instruction of other topics, subjects or skills. This means that the Visual Prompts may be learned by association with sounds and vice versa, without the need for separate instruction and without interruption of instruction. Essentially, this allows addition of information on sounds (spoken or written) to be included or incorporated into lessons on any subject matter.

Each sound is distinguished by specific finger, hand, and arm positions, gestures, and movements that correlate with how the sounds are formed physically and visually, and how they are heard (or auditory qualities), with attention to qualities of sound prosody (sound prosody is addressed in another section) being visually transmitted. When presenting the Visual Prompts (in person or through other media), finger, hand and arm positions, gestures and movements are paired with lip, tongue and other orofacial positions and movements; with vocalized and auditory sound productions; with written letters; and aids that provide information on the target sounds and provide directions for forming the target sounds.

Each of the Visual Prompts in the invention was designed to capture, then represent, and demonstrate corresponding spoken and written sounds, with each sound having a distinctive Prompt with distinctive positioning (finger, hand, and arm positions, gestures and movements) that can differentiate each sound from other sounds. The Prompts emulate specific aspects of sounds in spoken and written forms, which distinguish them from one another. Each Visual Prompt emphasizes or highlights characteristics of its corresponding spoken sound and/or written sound while also emulating aspects of the form of the mouth and positions of articulators during production of said sounds.

These Prompts augment or highlight the normally present auditory, visual, tactile, and kinesthetic information on sounds that teachers and students often do not pay attention to or which they frequently take for granted. Furthermore, tactile, kinesthetic and proprioceptive activities are incorporated into the invention and its procedures by having students observe, model and demonstrate utilization of information related to the positions, gestures and movements presented in the Visual Prompts (including finger, hand, arm, and orofacial movements). Instructors demonstrate and use these Visual Prompts to provide students with information and feedback on sounds as a means of improving student understanding of various aspects of sounds. Students may also use information conveyed through the Prompts, particularly the tactile, kinesthetic and proprioceptive information, to facilitate self-monitoring, self-cueing, and the development of self-corrections. It is important to note that one of the ways Visual Prompts are particularly unique is because of their usefulness in facilitating corrections of student errors during instruction without resorting to verbal interruptions.

Given the nature and the features of these Prompts, they are useful for teaching students to recognize the unique aspects of sounds that allow each sound in the language to be differentiated from all other sounds. For example, Visual Prompts for consonants are distinctive in appearance from the Prompts for vowels, which additionally helps students distinguish or differentiate between vowel and consonant sounds. Unique ways of signaling the differences between vowels and consonants and novel approaches for helping students understand these differences are provided using the Visual Prompts of the invention.

These Visual Prompts are also unique in the manner in which they convey multiple features or information simultaneously about each sound. For example, the Visual Prompt for any given consonant simultaneously presents as many of the following features as are applicable (and possible to portray) to the particular consonant sound (note that “Prompt formations” indicated below refers to the design of the Prompts or the finger, hand, and arm positions, gestures and movements of the Prompts):
Prompt formations inform as to how sounds are made in terms of lip, tongue, and mouth formation, positioning and movements;
Prompt movements inform on the audible or voiced and voiceless nature of sounds;
Prompt positioning and movements inform on the nature of articulators producing said sounds in terms of firmness, flacidity, and levels of tension;
Prompt positioning and movements inform on the prosodic nature of sounds (refer to sections on Sound Prosody as a component of this invention);
Prompt formations contain similarities with written representations of corresponding sounds, in terms of shapes and/or characteristics.

Visual Prompts for vowel sounds are designed to demonstrate mouth positions and movements, such as mouth opening, mouth shape, and lip protrusion, rounding, or retraction. Vowel Prompts, however, differ from consonant Prompts due to differences in the nature of these sounds. For example, in English, all vowel sounds are voiced, so voicing is not a feature that differentiates one vowel from another. Vowel sounds are all continuous in nature, so the Visual Prompts for vowels reflects this aspect of vowel sounds through the use of movement incorporated into the Prompts for vowel sounds.

Select vowel sounds also hold a prominent place in the Sound Symbols Sound Circle. Moreover, vowels are clearly distinguished from consonant sounds based on their positions in the Sound Circle. An additional way in which vowel Prompts are distinguished from consonants is through the use of closed fists in vowel positions and movements. Mnemonics are provided to facilitate learning of vowel sounds and their associated Visual Prompts, as well as for providing additional means of distinguishing them from consonant sounds.

The Visual Prompts for vowels are unique in the manner in which they convey multiple features or information simultaneously pertaining to each vowel sound. For example, each Visual Prompt for any given vowel sound simultaneously presents with as many of the following features as are applicable to the particular vowel sound (note that “Prompt formations” below refers to the design of the Prompts or the finger, hand, and arm positions, gestures and movements of the Prompts):
Prompt formations inform as to how sounds are made in terms of lip, tongue, and mouth formation, positioning and movements;
Prompt positioning and movements inform on the nature of articulators producing said sounds, including mouth opening and lip protrusion, rounding, or retraction;
Prompt positioning and movements that inform on the continuant nature of vowel sounds, including changes during sound productions; and
Prompt positioning and movements inform on the prosodic nature of sounds (refer to sections on Sound Prosody as a component of this invention).

Differences between students' actual productions and desired productions of sounds are easily addressed through use of the invention, particularly through use of the Visual Prompts. The invention also provides a systematic way to approach dialects and other variations in productions of words and sounds (e.g. tomayto vs. tomahto, potayto vs. potahto, etc.), as well as errors and sound distortions. For example, teachers can use prompts to provide visual supports indicating how students should produce target sounds. Teachers can use prompts to demonstrate what sounds students actually produce in response to presented models. Prompts can be used to provide visual representations of sound transpositions and deletions, as well as additions of inappropriate or extraneous sounds. These concrete ways of learning about variations in sound productions can also facilitate development of skills for self-monitoring, self-cueing, and for making self-corrections.

These supports are useful in both speaking and reading activities, as well as activities pertaining to teaching English as a second language. This is possible because use of the invention can help increase students' understanding of differences among sounds, whether their productions consist of variations (including dialectical or language based differences) or errors. The specific formations of the Prompts and the positions, gestures and motions presented here should not be regarded as restricting the range or application of this invention, particularly in light of application of the invention to multiple languages, as well as to English sounds.

All of these aspects of the Visual Prompts contribute to the unique nature of said invention, including the unique ways in which sounds are approached and treated. The invention in general, as well as the specific Visual Prompts, provides students with novel ways of understanding a variety of sound representations as previously described (e.g. such as single sounds represented by multiple letters, etc.) The Visual Prompts are an important component of the overall invention presented herein. As a unique tool for teaching, learning and improving speaking, reading, and writing skills, they provide a valuable addition to the fields of speech pathology and reading instruction specifically and education in general. It should be noted that details on the use of the Visual Prompts are further addressed in relation to additional components in the invention. The specific items in and the format of the Sound Symbols Visual Prompts should not be regarded as restricting the range or application of this component of the invention or the invention itself.

Pertaining to Claim 1 and FIG. 3: Sound Symbols Consonant Chart

The system of Claim One, wherein the invention includes a unique Consonant Chart useful for teaching and learning about sounds and sound patterns, with application to speaking, reading, writing, spelling, and documenting or monitoring of progress. The Sound Symbols Consonant Chart (or herein also designated as “Consonant Chart” and “chart”) is organized according to modified alphabetic information and is presented in a way that outlines the sound system presented in the invention while providing additional information relating to the invention. The sounds in this chart are based on sounds normally spoken in the English language, as represented in various forms using a modified version of Roman alphabet letters and symbols contained in the International Phonetic Alphabet (International Phonetic Association, 1999) or IPA. Both alphabetic and IPA constructs are, however, considered to be prior art for the purposes of this application.

Descriptions of the Visual Prompts in the chart correspond with those contained in the Sound Symbols Visual Prompts component of the invention. In the Consonant Chart, these descriptions of the Visual Prompts are organized to correspond with their representative sounds as contained in the Consonant Chart. The left hand column of the Sound Symbols Consonant Chart pairs respective consonant sounds with descriptions of corresponding Visual Prompts presented in the right hand column. The written descriptions of the unique Visual Prompts correspond to both their representative sounds and the physical aspects of the Visual Prompts.

Sounds or phonemes that differ from their usual letter sounds (this does not refer to the names of the letters), in the Chart, are also labeled with their corresponding IPA designations. For example, in the Chart the consonant sound or phoneme / [symbol] / or /ch/ is listed alphabetically using the letters “c” and “h” (listed just below “c”) with the corresponding IPA symbol / [symbol] / provided next to the description of the matching Visual Prompt. The letters “ch” are used as the most regular written representation of this sound, as there is no single letter that depicts this particular sound. This format is used for representing other similarly situated sounds, such as ng, sh, th, and zh. It should be noted, however, that some representations and descriptions of sounds in this invention do not strictly conform to the conventional conceptions of sounds generally put forth either alphabetically or using the IPA. These variations in the application of alphabetic principles and patterns of sounds in the invention are one of the factors that make this invention unique. The Consonant Chart thereby provides a unique perspective on sounds that varies from conventional notions about these sounds. There are historical precedents for modifications in conceptions of sounds, like those presented in this invention, including alterations which have been made to the IPA (International Phonetic Association, 1999).

This component of the invention, or the Sound Symbols Consonant Chart, contains an outline of the sounds listed and used in the invention (written using Roman alphabet letters, combinations of alphabetic letters, and IPA symbols) and a description of each of their corresponding Visual Prompts. The alphabetic designations (and variations thereof) for sounds, are listed vertically in modified alphabetic order and are paired with their respective Visual Prompts on the Sound Symbols Consonant Chart. The written descriptions of the Sound Symbols Visual Prompts are adjacent to each of the written representations of their corresponding sounds. Visual forms (e.g. pictures, photos, drawings, videos, etc.), depictions, or representations of the Sound Symbols Visual Prompts are also deemed to be part of the invention. Additionally, visually represented and written descriptions of the Visual Prompts correspond to both their representative sounds and the Visual Prompts addressed in Claim One and FIG. 2 of the invention.

The Consonant Chart is useful for looking up descriptions of specific Visual Prompts, albeit using the modified alphabetic format of the chart. For example, instructors who are learning to implement the invention can use this chart to quickly look up Visual Prompts for use in their lessons. Similarly, students can be taught to use the chart to look up either spelling of specific sounds or information on the pronunciations of specific written letters and combinations of letters. Using the “ch” example, students can see that “ch” is a distinct sound according to the chart. This chart can be used during all types of instruction, to facilitate development of speech and reading skills. This component of the invention also provides students with tools for understanding a variety of sounds and their written representations. This includes single sounds represented by multiple letters (e.g. sh, th, ch, etc.); single sounds represented through multiple forms or spelling (e.g. f, ph; ks, x, s, c; etc.); multiple sounds for single letters (e.g. g said as /g/ and /j/, c said as /s/ and /k/, s said as /s/, /z/, and/zh/, etc.); and letters that do not have their own sounds or share sounds with other letters (e.g. c, q, y, zh, etc.). Alternative written forms of various sounds can also be provided in select versions the chart, including both regularly used alternative forms and irregular forms.

The Consonant Chart contains a listing and description of special, novel labels that are assigned to specific groups and pairings of consonants. The function of these special labels, which are assigned to specific sounds, is to provide a novel means of facilitating student recognition and production of these sounds in spoken and written forms. Moreover, these special labels are particularly useful for reducing confusion about sounds and confusion about relationships between sounds and letters.

Some of these special labels include the designations of “Pretenders,” “Transformers,” “Chameleons,” “Twins,” “Special Agents,” “Resisters,” “Challengers,” “Responders,” and other names as assigned to specific sounds and sound patterns. These special labels help students understand how some sounds operate differently than other sounds, in general and in specific ways. In addition, these special labels are useful for recognizing and understanding various sound and letter patterns that are often thought of as “exceptions” in reading and writing tasks. Moreover, these special labels describe how sounds function and operate in distinctive, but identifiable ways while they also provide unique and specific information on sounds and sound patterns. (see Consonant Chart).

These novel or special labels can be applied in speaking and reading activities to help students understand similarities, as well as differences among spoken and written sounds. For example, the letter “C” is specified as a “Pretender” because although it has an alphabetic letter it does not have its own unique sound. Instead, “C” borrows its sound from multiple other sounds or combinations of sounds which are consistently represented by their own corresponding letters (e.g. k, s, ck). Other “Pretenders” include “Q,” “W,” and “X.” They are Pretenders because “Q” borrows its sound from “K”, while “W” borrows its sound from “U2,” and “X” borrows its sounds from a combination of “K” and “S” sounds.

Voiced (or loud) “TH” and voiceless (or quiet) “TH” sounds are labeled as “Twins” (note that the “th” sounds are also “Transformers”). The “Twin” label describes the close relationship between these two distinct sounds which differ only in their voiced and voiceless qualities. This label helps students understand the slight differences between these sounds. The “Twin” label can also be applied to other forms where applicable and where it is helpful in developing students' understanding of sounds.

Sounds like “CH” and “SH,” are identified as “Transformers,” where the letter “H” changes the “C” sound and “S” sound into other unique sounds when they are paired with “H.” In addition to these two combinations of “CH” and “SH” being presented as “Transformers” in the alphabetic listing of the Consonant Chart, additional sound patterns (e.g. th, ph, gh, etc.) may also be identified as “Transformers” (inserted adjacent to the listings of their corresponding sounds or highlighted as such). For example, in the invention the “h” in “gh” is identified as a transformer when “H” transforms “g” (or other sounds, such as t, p, s, c, etc.) into a changed but existing sound such as “F” (or into a different sound, as may be listed in the Consonant Chart). In many other contexts the presence of “H” indicates that a different but existing sound is to be produced, with the presence of “H” signaling changes in sound productions which do not comprise new or distinct sounds (e.g. ph=f, gh=f, etc.). At other times, the presence of “H” signals the existence of a unique sound which is not represented by a distinct letter form (e.g. sh, ch, th).

Differences in treatment of these sounds is done to identify actual or distinct sounds of the language (e.g. ch, sh, th) that are written or represented using a letter “H.” In the case of “CH,” “SH,” and “TH” it is determined that the purpose of the “H” is to signal a difference in the productions of “C” from “CH,” “S” from “SH,” and “T” from “TH” that results in or leads to productions of distinct or unique sounds. Where different written forms (e.g. ph, gh, etc.) of sounds are not representative of new or distinct sounds, but are different written representations of already identified sounds as listed on the left hand side of the Consonant Chart, these various ways of writing the already identified sounds can be listed in different sections of the Consonant Chart (in additional versions of the chart). This is done so that students learn to understand and distinguish the concepts explained herein.

During reading tasks many words are found which contain additional patterns where these special labels can be applied, even though the identified patterns do not represent new sounds. Additional forms of “Transformers” are presented in reading activities. “Transformers” that do not represent unique sounds are not addressed at the early phases of teaching about these types of sounds, where the focus is on individual sounds that correspond with specific written forms or letters. This is due to the fact that the spoken sound system is being focused on at these early stages of teaching about sounds. It is appropriate to point out additional “Transformers” when they are present in written form during literacy activities.

“Chameleons” are sounds that look like one sound or sound pattern, but take on another sound, similar to the manner in which a chameleon takes on various colors. For the purposes of this invention, the “ZH” sound is included and identified as a “Chameleon” because it is a distinct sound that has no corresponding letter representation in the alphabetic system in English. In other words, it is a distinct sound that “hides” or is camouflaged within other letters. While this sound is addressed in speech pathology literature, it is infrequently addressed in literacy materials. This may be due to the fact that the “ZH” sound- (also identified as /3/ in the International Phonetic Alphabet or IPA) is an infrequently used sound in the English language (International Phonetic Association, 1999). This sound is usually found in written forms using any of the following letters: si, g, s, z, or zi. During practice using the invention, this sound is initially written as “zh” (the symbol /3/ from the IPA may also be used, as is sometimes done in the field of speech pathology), to provide an anchor or consistent visual for teaching the sound, since it always borrows its letters from other sounds. The “zh” may be written above or below whichever letters correspond to this sound in the written word. The use of “zh” as a representation for /3/ is consistent with the format found in Webster's New Collegiate Dictionary (1977).

“Y” has its own letter, and some would assert that it has its own sound. For the purposes of this invention, however, “Y” is viewed as a sound that can function as a vowel sound (e.g. produced as “E” or “I”, etc.) or as a consonant /j/ sound. The letter “Y” and the International Phonetic Alphabet symbol for “y” or /j/ are used to represent a variety of sounds (International Phonetic Association, 1999). These productions of “y” or /j/ are represented by various letters (e.g. yes, you, Johann, onion, Utah, my, beyond, Europe, Hawaiian, tortilla, manual, infusion, barbecue, preview, beautiful, fjord, etc.). On the one hand, the letter “Y” is used for alternate spellings of various vowel sounds (e.g. gym, hymn, hilly, my, etc.), while the /j/ or “Y” sound is also found in words in which the letter “Y” is absent (e.g. onion, infusion, Utah, etc.), making its overall use quite unique. In some cases, the letter “Y” is used in the place of a different vowel sound. In the Consonant Chart, the Visual Prompt for “Y” most closely resembles a vowel prompt for the sound, however, with this sound it is important to remember to use whichever Visual Prompts best reflect the actual sounds produced in the words, whether they are spelled with “Y” (and then pronounced as “Y” or something else) or spelled with letters that make a “Y” sound. In light of the many ways in which “Y” functions, the term “Chameleon,” generally provides the most effective description for this sound because it also camouflages itself among other letters (as a sound) and other sounds (as a letter).

Other variations of written forms of spoken sounds exist. In such cases, the various alternate spellings of sounds are not considered to be new sound patterns, but represent alternate written forms of the sounds listed in the Consonant and Vowel Charts. Additional special labels, (e.g. “Special Agents,” “Resisters,” “Challengers,” “Responders,” and other names as assigned to specific sounds and sound patterns) which relate to reading patterns but not specifically to speech patterns, apply and are addressed in the reading component of the invention.

Color coding of sounds with these special labels and of distinctive features (e.g. place, manner, voicing) of sounds may be included in or incorporated into select versions of the Consonant Chart. The purpose of such additional features is to highlight and further facilitate student understanding of differences and similarities among sounds.

All of these various aspects of the Consonant Chart, described throughout, are likewise designed to facilitate the teaching and learning of the specific features and overall nature of spoken and written sounds. The manner in which these representations of sounds are presented and paired with directions for Visual Prompts, however, results in a unique and novel product in terms of the design and application of the Consonant Chart, as presented in this component of the invention. The specific items in and format of the Sound Symbols Consonant Chart should not be regarded, however, as restricting the range or application of this component of the invention or the invention itself.

Pertaining to Claim 1 and FIG. 4 a b c: Sound Symbols Vowel Charts

The system of Claim 1, wherein the present invention includes visual supports, diagrams, written descriptions, mnemonics, and information related to vowels and their corresponding Visual Prompts. The unique Sound Symbols Vowel Charts (also designated as “Vowel Chart or Charts” and “chart”) includes a description of each of the corresponding Sound Symbols Visual Prompts related to teaching and learning about vowel sounds. The sounds in these Vowel Charts are based on sounds normally spoken in the English language. These vowel sounds are also represented in various forms of Roman alphabet letters and symbols contained in the International Phonetic Alphabet (International Phonetic Association, 1999) or IPA, with modifications as noted. The Sound Symbols Vowel Charts are organized according to somewhat modified vowel information (in light of IPA, speech pathology, and literacy approaches) and presented in a manner that outlines the unique vowel system presented in the invention, while also providing additional information relating to the invention. The Vowel Charts provide a unique perspective on sounds that varies somewhat from conventional notions about the contained sounds. This unique component is useful for teaching and learning about sounds and sound patterns, with application to speaking and reading.

In the Vowel Charts, written descriptions, diagrams, and mnemonics for the corresponding Visual Prompts for vowels are provided in a fashion organized by place and manner of production (demonstrating the continuant nature of vowels). This includes mouth positions, shape, and movements, such as mouth opening and lip protrusion, rounding, and retraction. In other words, the Vowel Charts are ordered in specific patterns that correspond with facial positions and movements. When used with the Visual Prompts, information on form, function, and timing aspects or Sound Prosody, are provided. The Vowel Charts are designed to correlate with specific sounds and variations thereof (e.g. to reflect dialectical differences, to reflect errors in production, etc.). In the Charts, descriptions of the Visual Prompts correspond to their representative sounds and the Sound Symbols Visual Prompts component of the invention.

Each of the Visual Prompts in the Charts symbolize or represent both spoken and written sounds used in verbal language and written communication. Each vowel sound is distinguished by specific hand and arm positions (not finger positions, as hands are in fisted positions for vowels) and movements that correlate with how the sounds are formed physically, visually, and auditorily, with attention to qualities of Sound Prosody also being transmitted visually (refer to sections on Sound Prosody). These features of the Charts, when combined with the Visual Prompts and their corresponding motions, facilitate associations between spoken sounds and written sounds. Associations are strengthened by the unique connections established between the Charts, Visual Prompts, spoken and heard sounds, written forms of sounds as letters, and proprioceptive, tactile, kinesthetic, auditory and visual senses. Use of the Sound Symbols Vowel Charts and Visual Prompts in the invention provides specific and unique benefits to teachers and students that facilitate recognition and use of vowels in speaking and reading tasks, with application to writing and spelling.

The Vowel Charts and Visual Prompts can be used during all types of instruction, to facilitate development of speech and reading skills. The Vowel Charts can also be used to look up the Visual Prompts for vowels. For example, instructors who are learning to implement the invention can use these Charts to quickly look up Visual Prompts for use in their lessons. Students can be taught to use the Vowel Charts to find information on how to pronounce specific vowels or how to spell specific sounds. Teachers and students can use the Vowel Charts to compare written forms of vowel productions with actual productions, or the actual sounds uttered during production of specific vowel sounds (e.g long “i” containing “i” and “e”). The Vowel Charts can also be used to address and demonstrate numerous kinds of sound variations, such as dialectical differences and distortions, omissions, or substitutions of sounds. Being able to visually demonstrate variations in sounds is particularly useful when addressing common variations in productions of vowels in spoken and written forms, in dialectical variations, where differences in sounds or sound productions occur in conjunction with speech impairments, or where variations are the result of language differences (e.g. learning English as a second language).

This component of the invention provides students with specific supports for understanding a variety of sound representations. Alternative spoken and written forms of various sounds can be demonstrated using the Charts, including both regularly used alternative forms and irregular forms. For example, the Vowel Charts and Visual Prompts for the vowels are useful for demonstrating the various forms that “Y” can take in spoken and written forms. The Charts and Visual Prompts are also useful for facilitating understanding of vowels written as single letters which are actually verbalized as multiple sounds, (e.g. long “A” comprised of “eh” and “ee” or long “I” comprised of “ah” and “ee”). In other words, using this invention we can see and understand that letters, which represent vowels in written form may actually embody multiple spoken vowels and that there are multiple ways of writing and representing specific spoken vowels.

As part of the invention, the Vowel Charts incorporate unique mnemonics that are assigned to specific groups of vowels. The function of these mnemonics is to facilitate student recognition and production of the targeted vowel sounds in spoken and written forms. An additional purpose for these mnemonics is to reduce confusion about sounds and confusion about the relationships between sounds and letters. In fact, all of the elements of the Vowel Charts are designed to facilitate student recognition and production of sounds in spoken and written forms in a manner that also reduces confusion about sounds and confusion about the relationships between sounds and letters.

The purpose of this component of the invention is to facilitate student understanding of the differences and similarities among vowel sounds, as well as the ability to produce and read target vowel sounds. All of these various aspects of the Vowel Charts, described throughout, are likewise designed to facilitate the teaching and learning of the specific features and of the overall nature of spoken and written vowel sounds. The descriptions and types of representations of vowels presented in the invention help students develop their understanding of sounds and sound patterns in ways that differ from current programs. The Vowel Charts provides students with unique visual and written information on and ways of understanding a variety of sound representations. It should be noted that details on the use of the Visual Prompts are further addressed in relation to additional components in the invention. The specific items in and format of the Sound Symbols Vowel Charts should not be regarded as restricting the range or application of this component of the invention or the invention itself.

Pertaining to Claim 1 and FIG. 5: Sound Symbols Sound Circle

The system of Claim 1, wherein the present invention includes a unique visual tool identified as the Sound Symbols Sound Circle (or herein also designated as “Sound Circle” and “circle” and Sound Symbols Circle of Sounds) for the teaching and learning of speaking and reading skills, with application to writing and spelling. The Sound Symbols Sound Circle provides a unique component of the invention that can facilitate teaching and learning of accurate conceptions (both spoken and written), productions, manipulation, and use of sounds and sound patterns. This component of the invention may be used individually or in combination with other elements of the invention in order to promote the development of speaking and reading skills. An important aspect of the invention is that it provides concrete demonstrations of abstract aspects of speech, reading and language concepts. The invention can provide concrete visualizations of sounds through use of the Sound Symbols Sound Circle alone, as well as when use of the Sound Circle is combined with use of the Sound Symbols Visual Prompts.

This unique component of the invention provides a vehicle for facilitating the teaching and learning of correct pronunciations of sounds, including correct pronunciations of combinations of sounds as well as of particular individual sounds. Skills learned during use of the Sound Circle apply to combinations of sounds in blends, syllables and words, with application to connected sounds in speech and reading. The unique circular and visual design of the Sound Circle promotes teaching and learning about the distinctness of individual sounds while being able to simultaneously portray the connected nature of how sounds are used. The fixed use of vowels in the Sound Circle design facilitates student learning about sounds patterns while at the same time reducing the memory load that words and linear patterns impose.

This unique component of the invention, with its distinctive processes and procedures, promotes teaching and learning of associations between spoken sounds and written letters (both individual letters and letter combinations) by consistently pairing spoken sounds with written sounds or letters that correspond with the presented sounds. When presenting combinations of sounds and letters, a clear focus on the sounds, instead of on the letters. The Sound Symbols Sound Circle is used for pairing spoken and written sounds during the presentation of specially designed activities for the teaching and learning of recognition, production, sequencing, manipulation and recall of sounds. Sound Circle activities also facilitate learning about sound patterns. This format contrasts significantly with the approach traditionally used for teaching about sounds that emphasizes knowledge of letters and letter names. The Sound Circle and related activities, which typically includes use of the Sound Symbols Visual Prompts, are particularly helpful for developing associations between spoken sounds, written sounds (or letters), and means of production.

The Sound Circle consists of a large circle with a smaller circle centered within the larger one. Consonant sounds (or letters representing such) are placed within the smaller circle. The sounds (or letters for the sounds) “a”, “e”, “i”, “o”, and “u2” are placed inside the large circle, equidistantly around the outside of the smaller circle. The “u” has a small “2” attached to it as a signal to pronounce the “u” sound like the “oo” as in “two” or “too.” The purpose of this is to avoid saying “ee-oo” or “ee-you,” given that such vowel pronunciations do not represent the selected “u2” (oo as in two) form of production. This form also serves as a signal to students early on in the learning process that not all vowels say their own letter names (i.e. not all vowels are long vowels) in the invention, as well as in reading tasks.

The Sound Symbols Sound Circle pairs spoken and written sounds during teaching and learning of recognition, production and manipulation of sounds. The visuals provided in the Sound Circle, and activities related to use of the Sound Circle, promote student understanding that sounds and words consist of distinct but connected sound bites. Moreover, by combining use of the Sound Symbols Sound Circle with the Sound Symbols Visual Prompts powerful and unique ways of achieving mastery over concepts related to spoken and written sounds can be easily learned and applied.

The visual supports in the invention promote development of this understanding and of skills related to the segmenting and combining of sounds. The fact that this tool is useful for demonstrating and teaching both segmenting and combining of sounds is one of the things that make it unique in terms of form and function. Use of this component provides a systematic way of breaking sound combinations and words down (or segmenting) and putting them together again, particularly through use of the Sound Symbols Sound Circle and the Visual Prompts. This component (including processes, procedures, strategies, and tools) helps students visualize and utilize strategies, such as sound separations, to achieve improvement when they are having difficulties producing spoken sounds in words or connected speech and when they are having difficulties reading written words (e.g. facilitates sounding out of words). Moreover, this component of the invention has been designed to be particularly efficient and effective for making improvements or changes in students' productions of sounds during speaking and reading tasks.

An important function of the Sound Circle revolves around its use in demonstrating the connectedness of speech sounds, using a continuous circular motion, movement, and transitioning from sound to sound. At the same time, the Sound Circle can be used to indicate the distinct or separate nature of each sound, as shown by tapping and moving distinctly from sound to sound. The Sound Circle is particularly unique because of how it presents and treats the continuous connection of distinct sounds (including tapping and sliding).

The processes and treatment of sounds in this component relate to spoken language in a manner that facilitates understanding of aspects of sounds that are not as readily apparent in linear presentations of sounds and words. This is because of the fact that the ongoing nature of speech flows from sound to sound and word to word, where distinct boundaries between sounds and words are often not readily apparent. In other words, ongoing speech and reading are not consistently divided into separated sounds and words. Although we are not surprised when nonnative English speakers have difficulties with sound and word recognition, we do not usually attribute these same problems to native English speakers or readers, even though difficulties with these skills (e.g. segmenting skills, identification of isolated sounds within words, word recognition, etc.) can be found in students with disabilities. Moreover, students are not born having these skills, but acquire them in during development or in developmental stages.

On its own, the Sound Symbols Sound Circle provides a primarily visual tool. This component of the invention, however, also includes directions for unique multimodal methods (including visual, auditory, tactile, kinesthetic, and proprioceptive) of use, applying processes, procedures, and strategies that are important features of this invention. The processes, procedures, and strategies used with the Sound Circle are described in detail below. Even the visual supports alone, provided by the Sound Circle (without any additional components), can simultaneously facilitate learning about spoken and written sounds, given the ways in which sounds and supports for understanding sounds are presented and learned about using this component. The Sound Circle component of the invention is designed to provide a concrete, easily understood, easily used, and readily remembered tool for supporting identification, recall, production, and manipulation of sounds, while providing a tangible road map for doing so.

In particular, the Sound Symbols Sound Circle (as well as the Sound Symbols Visual Prompts and related components in the invention) allows learning and practice to occur in fluid, circular, word-like patterns of sounds that promote attention to sounds and sound sequences without the distraction of words. It should be pointed out that the sound combinations presented through use of the Sound Circle do exist as parts of actual words. Because these sound combinations and patterns closely resemble parts of words, students are not likely to react to them as either known words nor as resembling nonsensical utterances. This reduces confusion and distractions that can occur with both words and nonsensical sounding speech. Moreover, by utilizing circular, non-word patterns, many skills that are part of everyday speaking and reading can be embedded into the invention's activities.

Exposure to the processes and vocabulary imparted when utilizing the “Sound Symbols Sound Circle” increases students' grasp of concepts such as sound positions, including initial or beginning, middle and ending sound positions (also refer to additional sections detailing vocabulary used and applied). In addition, when students use the “Sound Symbols Sound Circle” they can simultaneously engage in visual tracking of corresponding written letters and letter patterns while noting and producing sounds in various positions in syllables. The structure, flexibility, efficiency, and effectiveness of the processes used in conjunction with this component of the invention, allow students to be simultaneously taught about sounds while learning to make associations between sounds and letters. This allows avoidance of the pitfalls that occur when teaching letter names, where a separate step in the learning process is required in order for students to make associations between sounds and letters. Other problems with approaches which center around learning of letter names over sounds were discussed in previous sections. In contrast, in this invention the emphasis is on learning to discern, produce and manipulate sounds at the same time that associations are made between sounds and letter combinations.

All of these aspects of the Sound Circle contribute to the unique and useful nature of the invention overall. The Sound Circle is a functional tool with easy recognition and recall value which can be used to facilitate teaching and learning of recognition, production, sequencing, segmenting, combining, and manipulation of sounds. In addition, the Sound Circle is useful for encouraging self-monitoring, self-cueing, and self-corrections, as well as for encouraging student practice using target sounds in speaking and reading activities. Moreover, the invention differs significantly and in numerous ways, as outlined above, from prior art in the areas of speech pathology and reading instruction.

This practical tool can promote rapid learning, is easy to use, and is valuable for teaching a range of concepts related to speaking and reading. For these reasons, the Sound Circle is a unique and important component of the invention which is helpful for teaching and learning about specific aspects of spoken and written sounds. The specific items in and the format of the Sound Symbols Sound Circle and related processes presented herein should not be regarded as restricting the range or application of this component of the invention or the invention itself.

Pertaining to Claim 1 and FIG. 6: Sound Symbols Sound Circle: Methods, Processes and Procedures

The system of Claim 1, wherein the present invention presents a unique combination of methods, processes, procedures, and strategies, particularly as relates to use and application of the Sound Symbols Sound Circle (or herein also designated as “Sound Circle” and “circle”). These methods, processes, procedures, and strategies related to use and application of the Sound Symbols Sound Circle, provide unique approaches to teaching and learning about sounds. Moreover the described use of the Sound Circle facilitates teaching and learning of accurate conceptions (both spoken and written) and productions of sounds for speaking and reading purposes, with application to writing and spelling. While this section describes the processes, procedures and strategies used with the Sound Circle, these processes, procedures, and strategies can also be used in combination with other components of the invention in order to further the development of speaking and reading skills. Note that FIG. 6 contains the specific directions for instructional use of this component of the invention.

The information in this component relates in particular to use of the Sound Symbols Sound Circle, in addition to relating to the invention overall. Note that many of these processes can also be applied during reading activities. The sounds presented using these processes, procedures, and strategies, are based on sounds normally spoken in the English language which are represented using Roman alphabet letters, symbols from the International Phonetic Alphabet (International Phonetic Association, 1999) or IPA (previously identified as prior art), and modifications or variations of these systems.

Specific processes, procedures, and strategies for teaching and learning about speaking and reading skills, through use of the Sound Symbols Sound Circle, are herein described. An aspect of these processes derives in part from previous art (e.g. Van Riper, 1978) found in the field of speech pathology, in the sense that consonant sound positions of “initial, medial, and final” are identified and targeted during speech therapy activities (e.g. beginning, middle and ending sounds). Such identification of consonant sounds according to position has become common in the field of speech pathology. Although identification of consonant sound positions is incorporated into this invention, the manner in which consonant sounds are treated in these various positions in the invention is unique and differs from the treatment found in prior art. For example, the invention includes unique skills and strategies for teaching and learning about sounds in syllables and words, using verbal, visual, written, gestural, tactile, kinesthetic, and proprioceptive supports, as described throughout. The treatment of sounds and the processes, procedures, and strategies used in teaching and learning activities herein are unique to this invention.

The act and process herein of using a circular position and back and forth motions, moving from consonants to vowels (or from vowel to consonant, or moving back and forth multiple times between vowels and consonants), is a unique format for teaching about sounds. This format contrasts significantly with the linear format that is generally used for teaching about sounds. This invention thereby promotes understanding of sounds as connected and flowing in predictable patterns and increases discernment of these patterns in spoken, ongoing interactions and in reading.

When introducing the processes used with the Sound Circle, a single target consonant is selected, the consonant is written in the small center circle of the Sound Circle and then labeled verbally while pointing to the target consonant sound in the small circle. The student is encouraged to model the target consonant sound after the instructor has said the sound. After this sound is correctly modeled by the student (or attempted several times if errors in modeling are noted), the process of presenting the target consonant in initial positions of syllable combinations begins (note that this next step can be started even when completely accurate models are not yet achieved and in this event both isolated sounds and syllables can be practiced alternately).

During the process of using the Sound Circle, students are taught to recognize isolated sounds without the addition of extraneous sounds, such as “uh” being added to consonants like b, t, g, etc. (as in “buh,” or “tuh,” etc.) or “eh” being added to sounds like f, l, n, etc. (as in “ef,” “el,” “en,” etc.). Taking care to avoid adding these extraneous, unneeded sounds eliminates the confusion about sounds that occurs when they are included during the teaching process (e.g. students read “b” as “buh” during reading activities, instead of as “b” and do not discern these differences, meaning they view “b” and “buh” as equivalent).

Deletion of these extraneous, unneeded sounds in a deliberate and explicit manner contrasts significantly with the format traditionally used for teaching about sounds (in speaking and reading instruction). Typically, instruction on sounds incorporates such extra sounds, presenting both sounds as though they were equivalent to the one sound actually being taught (e.g. students are taught “b” as “buh” during reading activities, instead of as “b” and do not discern these differences or view “b” and “buh” as equivalent). The invention is useful for facilitating recognition of these differences.

The processes and procedures applied to sounds herein intentionally target multiple skills simultaneously, instead of teaching single sounds at a time. Students are learning multiple skills simultaneously when using the Sound Circle, beginning with modeling of the first target sound in the initial position in syllables. For example, students learn about sound boundaries and qualities of sounds when modeling isolated sounds. Using the Sound Circle, students practice correct productions of the target consonant sounds, even as they learn to recognize and produce the vowel sounds in the Sound Circle. Students also immediately learn about the processes in the invention and the nature of sounds; such as qualities or features of sounds, sequencing of sounds, timing of sound productions, manipulation of sounds, visual appearance of written sounds and spoken sound production, and boundaries of sounds, etc. (including additional aspects addressed throughout this description of the invention). After working on modeling of syllables with target consonants in the initial position in syllables, work proceeds to use of the Sound Circle with the target consonant in the medial or middle position, followed by work with the target consonant in the final position of syllables. It should be noted that this sequence or the positions of target sounds may be altered based on the needs of students (e.g. Initial, Final and then Medial sound positions, etc.). This format contrasts significantly with the approach traditionally used for instruction, where teaching typically focuses on single sounds at a time, without regard to the qualities of the sounds being presented.

Syllable patterns are then combined. For example, initial and medial syllable patterns or initial and final syllable patterns are combined, followed by the combining of initial, medial and final syllable patterns. Using this component of the invention, additional skills and strategies are also taught using these processes, as addressed below as well as in other sections herein. An example of a sequence of syllable patterns is shown as follows:

Full Set of Alternating Syllables

Beginning or Initial Positions in Syllables

Say and Prompt target sound (pause) Say and Prompt vowel “a”—long a, as in wake (pause)

Say and Prompt target sound (pause) Say and Prompt vowel “e”-long e, as in we (pause)

Say and Prompt target sound (pause) Say and Prompt vowel “i”—long i, as in my (pause)

Say and Prompt target sound (pause) Say and Prompt vowel “o”-long o, as in knows (pause)

Say and Prompt target sound (pause) Say and Prompt vowel “u2”-u2, as in blue or who (stop)

Middle or Medial Positions in Syllables

Say and Prompt:

“a” long a, as in wake (pause) Say and Prompt target sound (pause) “a” long a (pause)

“e” long e, as in we (pause) Say and Prompt target sound (pause) “e” long e (pause)

“i” long i, as in my (pause) Say and Prompt target sound (pause) “i” long i (pause)

“o” long o, as in knows (pause) Say and Prompt target sound (pause) “o” long o (pause)

“u2” u2, as in blue or who (pause) Say and Prompt target sound (pause) “u2” as in who (stop)

Ending or Final Positions in Syllables

Say and Prompt:

“a” long a, as in wake (pause) Say and Prompt target consonant sound (pause)

“e” long e, as in we (pause) Say and Prompt target consonant sound (pause)

“i” long i, as in my (pause) Say and Prompt target consonant sound (pause)

“o” long o, as in knows (pause) Say and Prompt target consonant sound (pause)

“u2” u2, as in blue or who (pause) Say and Prompt target consonant sound (stop)

The act herein of separating consonants from vowels, while maintaining a level of proximity to vowel sounds in letter form, is a unique format for teaching about sounds. This format contrasts significantly with the linear, connected format that is traditionally used for teaching about sounds and their relationships.

Although it is regular practice in the field of speech therapy to teach students about initial, medial, and final sounds in words and even syllables, the treatment of syllables in this invention differs from usual practice in numerous ways. As noted above, the invention includes unique skills and strategies for teaching and learning about sounds in syllables, by incorporating procedures, processes, strategies and supports using verbal, visual, written, gestural, tactile, kinesthetic, and proprioceptive means as follows.
a. Circular format: Sounds are presented in a circular format, instead of a linear fashion.

This promotes understanding of sounds as connected and flowing in predictable patterns, as can be discerned in spoken, ongoing speech. This is in contrast with the image of distinct, discrete sound bits or sound chunks presented as isolated letters or single words presented in linear fashion. The act and process herein of presenting connected sounds in a flowing, circular, syllabic but non-word format is a unique format for teaching about sounds. This format contrasts significantly with the linear, syllabic format that is regularly used for teaching about sounds.
b. Segmenting and connecting sounds: Syllables are presented with individual sounds segmented and then in combined forms, maintaining word-like patterns and flowing sound productions while utilizing the visual support of the Sound Circle in combination with pointing actions that guide in production of sounds.

Using this approach it is possible to cycle back and forth between segmenting and combining of sounds. Skills for teaching separation (or segmenting) and combining of sounds are readily able to be taught concurrently or in an isolated fashion, with the visual support of the Sound Symbols Sound Circle (combined with pointing actions) to guide in production of sounds. As such, these approaches to sound productions are integrated into use of the Sound Circle and the Sound Circle processes. A mix of segmented and combined sounds are presented in order to avoid perceiving such treatment of sounds as totally distinct or unrelated activities. In fact, students are encouraged to “play” with sounds in this manner in order to increase their familiarity with features of sounds and their control over sound productions. Students thereby learn to both segment and combine sounds as they manipulate them while simultaneously learning to associate sounds and their representative letters. These skills are foundational in speech and reading mastery, with application to writing and spelling.

The act and process herein of simultaneously presenting sounds as being able to be separated while also being able to be used within a flowing, syllabic but non-word format is a unique approach for teaching students about sounds. This combined format contrasts significantly with the format that is traditionally used, where segmenting and connecting of sounds are each viewed and taught as discrete skills, instead of being viewed as a skill set related to manipulation of sounds.

In other words, the invention is useful for presenting syllables with individual sounds segmented, as well as for presenting sounds in combined forms, while maintaining word-like patterns and flowing sound productions. One way the invention accomplishes this is by utilizing the visual support of the Sound Circle in combination with pointing actions (using both staccato-like, bouncing motions while moving from sound to sound and using smooth motions gliding from sound to sound) to guide students in the production of sounds.

Using the processes herein involves pointing and movement activities that are unique to the use of the Sound Circle. As such, these approaches (e.g. pointing, moving back and forth, etc.) for working on sounds are integrated into use of the Sound Circle and the Sound Circle processes. Moreover, this is done in a manner that demonstrates to students that both skills (segmenting and combining sounds) are useful when producing sounds, are necessary when manipulating or correcting sounds, and are beneficial during efforts to sound out words.

Moreover, pointing to the target sounds while producing the sounds gives students important information on timing and sequencing aspects that relate to both speaking and reading tasks. It is important to note that the manner of pointing in the invention includes both distinct pointing actions (e.g. firm pointing and removing finger from target sounds using separated, staccato-like movements) and continuous pointing (e.g. sliding finger from sound to sound using connected, legato-like movements) actions to signal sound features and the length or brevity of sound productions. The movements involved in such pointing actions and the demonstration of corresponding Visual Prompts provide additional valuable information on sounds and their boundaries, length and intensity that are generally left unaddressed in typical instruction. Providing this information further contributes to student understanding of various aspects of sounds and facilitates the ability to recognize, produce, sequence, transition between, and manipulate sounds.
c. Recognizing sounds: Use of the small center circle of the Sound Circle promotes recognition of the individual consonant sounds, whether the consonants are being taught in isolation or in syllable combinations. At the same time, use of the small circle of the Sound Circle during instruction, promotes recognition of the limits or boundaries of the consonant sounds and recognition of the distinctive features of each sound.

This leads to decreases in errors in sound productions, by limiting the inclusion of inappropriate sounds or sound features as part of learned conceptions of individual sounds. In other words, students can simultaneously learn about the distinct nature of sounds, which allows them to segment sounds, while learning about the skills and patterns needed for combining sounds. These skills easily transfer from the syllable level to the word level. As a result, students are better able to recognize, produce, segment, combine, and manipulate individual sounds in words through this unique process and work at the syllable level.
d. Lack of sound: Use of the Sound Circle in combination with the process of decreasing and increasing separations facilitates recognition of lack of sound productions between sounds and thereby promotes learning and correct production of even difficult target sounds, while systematically teaching about sequencing, organization, and flow of sound productions. These same processes promote teaching and learning about manipulation and use of sounds in speaking and reading tasks, as well as being particularly applicable to learning about sounding out words and understanding silent or unused sounds.

This format reduces the reliance on models alone for achieving improvements in sound productions. This format also contrasts significantly with the format traditionally used for teaching about segmenting and connecting sounds where models alone are typically used to signal segmenting and connecting of sounds. Traditionally, specific skills on how to segment or connect sounds are not typically taught, whereas the invention provides specific processes, procedures, and supports for the teaching and learning of these skills, while attending to the lack of sound productions between sounds (as well as to the continuation of sound when connecting sounds).

Moreover, the processes and procedures applied to sounds herein intentionally target and draw attention to space between sounds (or silence) as being important for learning how to discern distinct sounds from the various forms that connected sounds take. This includes paying attention to the length of time (or brevity) between sounds as well as the absence of sound. This format contrasts significantly with the format traditionally used for teaching about sounds, where attention to an absence of sounds is not typically addressed or taught.
e. Sound patterns: The visual supports in the Sound Circle (e.g. Sound Circle itself and the visually presented processes used with the Circle) promote learning, recognition, and retention of sound patterns (spoken and written), facilitating retention even when changes in target consonants occur. This is accomplished by providing patterns that can be applied to use with any consonants, while maintaining consistent vowel sound selections and sequences.

The processes and procedures applied to sounds and sound patterns, which do occur in words, herein intentionally provide and target sound patterns in non-word or syllable contexts in order to promote learning without the distraction of words. In real words, repeated productions of learned errors can interfere with the establishment of new and different sound patterns. At the same time, productions of Sound Circle patterns transfer easily to correct productions in words (spoken, read, and written) as students learn to apply and expand upon the Sound Circle patterns and strategies. Moreover, these visual supports and processes in the invention teach and promote understanding of relationships between written and spoken sounds.

These patterns focus initially on consonant sound variations, where a select set of vowels remains constant. This is designed to develop students' abilities to subsequently recognize similar patterns in words, in connected speech, and in reading activities. This format contrasts significantly with the format traditionally used for teaching about sound patterns, where attention is typically focused primarily on vowels and varied vowel productions. Such instruction typically emphasizes the learning of all possible vowel productions (particularly short vowels), instead of focusing on the patterns formed by consonant and vowel combinations as is done in this invention (using a wide range of consonants and limited vowels).
f. Associating multimodal information: Combining Sound Circle activities with other unique multimodal supports in the invention, such as the Sound Symbols Visual Prompts and Sound Prosody information (refer to related sections), promotes learning, production and retention of sounds and sound features in syllables and then words and ongoing speech.

This is due to the multiple ways in which aspects of spoken sounds (including distinctive features, visual qualities, etc.) can be associated with their written counterparts (e.g. letters, syllables, words, etc.) and other multimodal information (e.g. Visual Prompts, gestures, movement, tactile, kinesthetic and proprioceptive information, auditory or heard qualities, etc.). Moreover, the Sound Circle and related activities, which include use of the Sound Symbols Visual Prompts, are useful for developing associations between sounds, letters, and means of production. More frequently sounds and means of production or sounds and letters are associated, but these three aspects (sounds, letters and means of production) do not usually receive combined attention. The invention uniquely promotes learning and recall of these associations through use of the Sound Circle and related supports and activities.
g. Sound sequencing and manipulation: Sound Circle activities and processes include work on sequencing and manipulation of sounds in syllables, while simultaneously addressing timing aspects of sound productions.

These are skills which are necessary for learning and mastering speaking and reading skills. The inclusion of timing features is vital in this work on sequencing and sound manipulation, as timing significantly affects transitions among and between sounds, as well as the rate of production of sounds. This combination is unique and provides students with effective strategies for correctly producing sounds in speaking and reading activities while paying attention to various aspects of sounds, including timing aspects.
h. Feedback on actual errors: Instruction with the Sound Circle in combination with related feedback, which can include use of the Sound Symbols Visual Prompts, is useful for increasing recognition and correction of production errors.

These include errors of transposition, sequencing errors, errors of overgeneralization, errors in addition of inappropriate sounds, timing or Sound Prosody errors in syllables (which transfer to sound productions in words), and deletion of sounds. Use of the Sound Circle and Visual Prompts also provides a means of sharing information on and demonstration of the actual errors that have been made, as well as the ways in which said errors contrast with the target productions. Such feedback is useful during speaking and reading instruction and helps students understand their errors while simultaneously increasing their attention to said errors.

In the invention, unique feedback on student productions can be provided by coordinating use of the Sound Circle and the processes used herein. Instruction which combines use of the Sound Circle and the Sound Symbols Visual Prompts can offer students specific feedback on their sound productions. Instruction which combines these components of the invention, allows instructors to teach students about sound errors and corrections, and to promote student use of self-cueing and self-corrections. Such instruction is useful for increasing recognition and correction of production errors. Improvements in these areas during production of syllables can transfer to increased accuracy in productions of sounds in words and in ongoing speech and reading productions. Traditional instruction does not generally provide such specificity on errors or similar feedback.
i. Demonstration of errors: Instruction which combines use of the Sound Circle and the Sound Symbols Visual Prompts can be utilized to teach students about corrections and to promote their effective use of self-corrections, by providing specific information on student errors.

Such instruction is useful for increasing attention to and correction of production errors, including errors of transposition, sequencing errors, errors of overgeneralization, errors in addition of inappropriate sounds or features of sounds, timing, and Sound Prosody errors in syllables. Use of the Sound Circle and Visual Prompts also provides a means of demonstrating the actual errors and the ways in which errors differ from the target productions. It is also possible to give students feedback on how changes in their sound productions move closer to or further from the target. As a result, students can learn to understand, as well as recognition and attention to their errors.

This approach leads to further increases in self-monitoring, self-cueing, and self-corrections. Such work on corrections is useful during speaking and reading instruction and provides processes and supports that students can use to increase their ability to change sounds or errors independently following initial guided practice using the invention. This format contrasts significantly with the format traditionally used for teaching about sounds wherein feedback to students on errors has generally been limited to pointing out what the correct response or production should be, with very limited (if any) information given on the nature of the error. The process of presenting sounds herein uniquely approaches the teaching and learning of making corrections (including self-monitoring, self-cueing, and self-corrections) when errors occur.
j. Carry-over: The Sound Circle and related activities, which can include the Sound Symbols Visual Prompts, are helpful for transitioning from syllables to verbal production and reading of words using skills learned during instruction with the Sound Circle (e.g. separation and combining of sounds, sequencing of sounds, correct production of sounds, etc.).

At the same time, the Sound Circle and related activities are also useful for decreasing errors when transitioning from sound and syllable productions to verbal production or reading of words. The invention is useful for facilitating recognition and correction of errors at this phase or at the word level (similar in nature to activities at the sound and syllable levels). This includes recognition and correction of all of the types of errors found in modeling of sounds, such as production errors, errors of transposition, sequencing errors, errors of overgeneralization, errors of inappropriate additions of sounds or features of sounds, timing, and Sound Prosody errors.

Use of the Sound Circle and Visual Prompts provides a means of understanding connected or ongoing speech patterns (during speaking and reading activities) as well as a means of demonstrating the actual errors made in production at these levels. Recognition of the ways in which errors at the word level and beyond contrast with desired target productions (corresponding to activities at the sound and syllable levels) can be facilitated in connected speech through use of the invention. Such work on corrections is useful during structured and ongoing speaking and reading instruction. This component of the invention provides processes and supports that students can use to increase their ability to change sounds or errors independently during production of words and connected language (while speaking or reading), following initial guided practice using the invention at syllable levels.
k. Pointing Supports for prosody: Using the processes described herein involves pointing and movement activities that are unique to the use of the Sound Circle. Pointing to the target sounds while producing the sounds gives students important information on timing and sequencing aspects that relate to both speaking and reading tasks.

It is important to note that the manner of pointing in the invention includes both distinct pointing actions (e.g. firm pointing and removing finger from target sounds using separated, staccato-like movements) and continuous pointing (e.g. sliding finger from sound to sound using connected, legato-like movements) actions to signal sound features and the length or brevity of sound productions. The movements involved in both types of pointing actions and the demonstration of corresponding Visual Prompts provide additional valuable information on sounds and their boundaries, length and intensity that are often left unaddressed when students are given instruction about sounds. Providing this information further contributes to student understanding of various aspects of sounds and further facilitates the ability to sequence, transition between, and manipulate sounds.
l. Inclusion of language concepts: The processes, procedures, and strategies which are taught during use of the Sounds Symbols Sound Circle include and simultaneously address language concepts. The inclusion and teaching of language concepts facilitates further understanding of the nature of sounds in speech and reading.

Language concepts presented and addressed during use of these processes include (but are not limited to) the following: beginning, middle, end, first, second, third, last, next, next to, then, before, after, fast, slow, short, long, continue, stop, go, together, apart, separate, hard, harder, soft, softer, gentle, loud, louder, quiet, between, behind, together, above, back, front, side, up, down, forward, over, under, out, in, further, more, less, same, different, like, and instead (etc.). These language concepts relate to the sound features being taught and are integrated into associated demonstrations during use of this component of the invention. Incorporating and making this vocabulary and language explicit, during teaching and learning about sound productions and manipulation of sounds, contributes to the unique nature of the invention. This attention to language and vocabulary also differentiates this invention from other more traditional reading approaches that do not specifically address these types of language skills and vocabulary during instruction.

Use of the Sound Circle will be all that most students will need in order to transition from spoken sounds to written words. On the other hand, some users may be more comfortable having a more familiar linear format available for making this transition. Tools using a linear form can be included in order to facilitate this transition process where users feel they are necessary. The tools transform the circular, fluid approach used in the Sound Circle to a similar, but linear and visually segmented format, with connected linear forms also included. For example, after learning and using the circular movements described in the instructions for the Sound Circle, students can be shown linear forms of sounds and sound patterns, modeled on the same sound patterns used in the Sound Circle (e.g. “ba,” “aba,” “ab”, etc). Similarly, presentations of other sound combinations, (including any variety of sound combinations) may be provided by inserting them into the Sound Circle before transitioning back to linear presentations of the sound patterns (e.g. using varied vowel patterns such as “abe, abi, etc.; using other less common consonant and vowel patterns like “pho” as in phone, etc.; and using other vowel productions such as those presented below in the Reading Processes component of the invention; etc.). The Sound Circle and syllable choices may also be expanded by adding additional circles to the Sound Circle.

Practice using additional types of sound patterns with the Sound Circle and then transitioning back to words, either with or without using the linear forms, can be very helpful for expanding understanding of sounds in both spoken and written forms. The additional practice suggestions here may be presented immediately following instruction and practice using the Sound Circle, or they may be presented as needed. For example, many students may not require the additional practice and may readily apply the skills and strategies learned through use of the Sound Circle to new contexts. On the other hand, some students may require additional practice or support in learning how to make transitions to new sound patterns.

After students have begun to work specifically on connected sounds in speaking or reading tasks, it can be helpful to review sound patterns on the Sound Circle. Use of the Sound Circle at this point can be helpful for increasing self-corrections and fluency during student productions. Some students may need to return to practice using and applying the Sound Circle on only select sounds or with isolated sound patterns. This flexibility in application and use of the Sound Circle is intentional in order to promote both efficiency and effectiveness in teaching and learning about sounds, with application to a wide range of sounds and sound patterns.

This is accomplished through the unique skills and strategies provided for teaching and learning about sounds. This component of the invention focuses primarily on sounds and syllables, using novel verbal, visual, auditory, written, gestural, kinesthetic, tactile, proprioceptive, and movement based supports. The skills and strategies learned through use of the Sound Circle transfer readily to teaching and learning activities involving sounds in increasingly longer contexts (e.g. words, structured and ongoing speech, reading and writing). The invention encourages student attention to and involvement in learning and manipulation of sounds and can lead to playful use of sounds in sound combinations and even words.

The processes and procedures used with sounds herein promote skill development in sound sequencing and organization by presenting specific and unique ways of organizing and manipulating sounds in non-word contexts. Students can thereby learn to organize, to sequence, to recall, and to manipulate sounds without the distraction of words. These skills, nevertheless, transfer to the word level and beyond. This format contrasts significantly with the format traditionally used for teaching about sound sequencing using alphabetic principles with minimal, if any, attention being given to manipulating sounds (outside of rhyming words), at either the syllable level or beyond. These skills, particularly as presented in this invention are useful for learning to manipulate sounds in reading tasks, as well as being particularly applicable for learning about the “sounding out” of words and developing proficiency in “sounding out” even unknown words.

The processes used with sounds herein uniquely facilitate teaching and learning about various aspects of sounds, including timing and ordering of sounds, that relate to both speaking and reading tasks. As noted above, unique pointing, gesturing and movement activities used with the Sound Circle provide valuable information on sounds, including the length, intensity, boundaries of sounds and vocabulary related to sounds, that is often left unaddressed. Providing this information contributes in innovative ways to student understanding of various aspects of sounds and facilitates the ability to recognize, produce, sequence, transition between, and manipulate sounds. This invention and its use contrasts significantly with traditionally used formats for teaching about recognizing and sequencing sounds by emphasizing letter combinations, while overlooking additional information of the types presented herein. The unique processes and procedures presented herein promote recall and retention of spoken and written sounds, sound patterns, and sound features (in isolation, syllables, words, and ongoing contexts) by combining numerous components and supports in the invention (e.g. Sound Symbols Visual Prompts, Sound Prosody information, Feedback System, and means of production, etc.).

Given the multiple the ways in which spoken sounds (including distinctive features, visual qualities, etc.) can be associated with their written counterparts (e.g. letters, syllables, words, etc.) and other multimodal information (e.g. Visual Prompts, movement, kinesthetic, tactile, and proprioceptive information, auditory or heard qualities, etc.), student retention and recall of sounds and sound patterns can be readily improved. The format in the invention contrasts significantly with the approach traditionally used for teaching about sound and letter pairs. Traditional approaches tend to rely primarily on repetition or drills while looking at given letters and saying their corresponding names or sounds using related phrases (e.g. “A is for apple; B is for boy,” etc.). All of the above aspects of the Sound Circle and related supports, processes, procedures, and strategies promote unique ways of teaching and learning about speaking and reading skills.

The specific items in and format of the Sound Symbols Sound Circle and corresponding methods, processes, procedures, and strategies presented herein should not be regarded as restricting the range or application of this component of the invention or the invention itself.

Pertaining to Claim 1 and FIG. 7: Sound Symbols Tracking Form

The system of Claim 1, wherein the invention includes a unique Tracking Form designed for planning, observing, recording and evaluating purposes as relates to use and application of the invention to teaching and learning about sounds. The Sound Symbols Tracking Form provides a means of recording progress during teaching and learning about sounds and their use, as presented in the invention. This Tracking Form (herein also referred to as the “Sound Symbols Tracking Form,” “Tracking Form,” or “Form”) is useful for tracking activities during all phases of work and all activities related to the invention. The Tracking Form or chart is designed for tracking information by sounds and sound productions, rather than by letter knowledge or letter recognition. Tracking and charting with a focus on sounds instead of letters helps to maintain student attention on sounds, which is helpful for reducing confusion between sounds and letters during the teaching and learning process.

The Sound Symbols Tracking Form is organized according to modified alphabetic information and is presented in a way that outlines the sound system presented in the invention, while also providing information related to the invention. The unique Tracking Form contains written versions of the sounds used in the invention that are based on spoken standard English sounds, being loosely based on the International Phonetic Alphabet or IPA (International Phonetic Association, 1999) and a slightly modified Roman alphabetic system that is more consistent with the invention. The sounds in this form are based on sounds normally spoken in the English language, as represented in various forms using the modified versions of Roman alphabet letters and symbols contained in the IPA.

The Tracking Form is a sound chart and is thereby organized by sounds in a form that is not strictly alphabetical, but is nevertheless organized in a semi-alphabetical format so that users can make use of familiar and frequently present alphabetic cues. The Tracking Form outlines aspects of the sound system presented in the invention using this modified alphabetic form that correlates with the sounds as taught and learned in the invention. Because the Tracking Form provides a visual support that more closely relates to the actual sounds used in speaking and reading tasks, it thereby increases its usefulness for teaching and learning about spoken and written sounds. This approach differs from traditional reading methods that maintain a letter-based focus.

The Tracking Form draws attention to and promotes recording of performance on specific skills at all levels (syllable, word, sentence, etc.), including the ability to separate and/or combine sounds, sequencing skills, and types of errors in sound productions (substitutions, omissions, distortions). This approach differs from traditional reading approaches that focus on recording errors, but do not tend to address types and patterns of sound errors, errors in sequencing skills, or errors related to an inability to separate or combine sounds.

The Tracking Form can be used to record, monitor, promote improvement, and address student difficulties with modeling of corrections and making self-corrections. This approach differs from traditional approaches which do not tend to pay ongoing attention to these skills or their development. In addition, the Tracking Form is useful for looking up written forms of sounds to ascertain their corresponding sounds or verbal productions. The Tracking Form can be a valuable tool for students who have difficulties using dictionaries for this purpose. The Tracking Form also provides an efficient and effective means of addressing these needs. This approach differs from traditional reading approaches where students must rely on learned rules to address irregular written word forms.

The form is more than a listing of sounds in the invention, as this form provides a way to document the various ways in which sounds are used by students (both correctly and incorrectly). For example, there is space for tracking and documenting student sound productions in the following contexts: in isolation; in all positions in syllables (initial, medial, final, multiple syllables); in all positions in words (initial, medial, final); in blends, phrases, and sentences; in structured speech and reading; and in ongoing speech or reading. The Tracking Form allows for recording of specifics at all levels (e.g. syllable, word, sentence, etc.), such as the ability to sequence, separate and combine sounds. The types of errors made in sound productions (e.g. substitutions, omissions, and distortions) can be documented on the Tracking Form. In addition, teachers can also use the Tracking Form to record and monitor the ability of students to model corrections, self-cue and make self-corrections. This approach differs from traditional reading approaches which proceed from a letter based focus to a word based focus, with limited attention given to the consonants and vowel sounds in various types of syllables and other contexts (e.g. medial and final positions) or patterns.

Use of the Tracking Form facilitates effective and efficient use of the invention. It also functions as a blueprint or guide for using the invention. In addition, the Tracking Form can be used to facilitate identification of areas that need additional or special attention. The uniquely designed Tracking Form, as a component of the invention, is a useful tool for teaching and learning about sounds and sound patterns, with application to speaking, reading, writing, and spelling. The specific items in and format of the Sound Symbols Tracking Form and corresponding methods, processes, and procedures presented herein should not be regarded as restricting the range or application of this component of the invention or the invention itself.

Pertaining to Claim 1 and FIG. 8: Sound Symbols Reading Processes, Procedures, Strategies, and Activities

The system of Claim 1, wherein the present invention is characterized as a unique system for the teaching and learning of reading skills, as well as speaking skills, with application to writing and spelling. Said system facilitates learning of accurate conceptions, recognition, productions, sequencing, and manipulation of sounds in reading tasks. The invention also facilitates accurate understanding of how sounds and subsets of sounds (or allophones of phonemes) are organized into sound categories or groups, while facilitating students' understanding of the relationships between spoken sounds and written letters. The invention provides teachers and students with a systematic approach for considering options during reading, as well as ways of facilitating correct sound selection and productions in reading tasks. The unique component of the invention known as the “Sound Symbols Reading Processes” (also identified throughout as “Reading Processes” or “reading approach”) is useful for teaching and learning about reading with a focus on sounds and sound patterns, with application to speaking, writing, and spelling.

Moreover, the invention is a unique combination of methods, processes, procedures, strategies, materials, items, tools, and kit components, which are all designed to facilitate teaching and learning of speaking and reading skills. While all of the components of the invention contribute in distinctive ways to the unique nature of the invention, the components and elements of the invention may be used individually or in combination in order to contribute to the development of reading skills, as well as speaking skills. Although this component of the invention focuses on the teaching and learning of reading skills, aspects of speaking skills are clearly included herein. Speech skills may be easily addressed (or combined) during learning, use, and practice of the skills and activities related to this component of the invention. Furthermore, unique emphasis and recognition in this invention are given to the role that spoken sounds and speaking skills play in the understanding of written sounds and the development of reading skills. In this invention, the act of reading is looked at primarily as a means of generating sound productions, using written representations of sounds that connect to form words in ongoing written language. The act of reading in this invention is further construed as the verbal identification (whether spoken out loud or internalized as speech) of sounds, represented in written forms as sound patterns and words, that can be converted into meaningful and shared language, including but not limited to words, phrases, sentences, ongoing interaction, and ideas.

The Reading Processes component of the invention provides teachers and students with a unique, systematic approach for considering options when deciding on which sound productions to use or to apply in reading tasks. This format differs significantly from traditional approaches used for instruction that present letter to sound associations as more fixed or static in nature. The Sound Symbols Reading Processes in this component of the invention includes those specific series of actions, or steps, and strategies used to learn about sounds to achieve understanding and attainment of accurate word pronunciation in reading activities. This process is related to what is sometimes referred to as “decoding” or “sounding out” words.

During preliminary reading instruction, many approaches focus on helping students learn the names of letters. Next, in such programs, letter names are converted into words and sounds are paired with the words (e.g. “a, apple, ae”). In contrast, the focus in this invention is on spoken sounds which are connected to form words, while being paired with written symbols. The invention emphasizes the view that sounds are used to form words, whether those words are spoken or written. The focus here is not on learning the names of letters, whether in isolation, in alphabetic order, or as the letter names corresponding to sounds (e.g. students are not working on learning “bee” for “b”). In this invention, letters function as symbols that represent sounds, where naming of letters is not necessary or even useful. Since letters are used as visual, written symbols for sounds, where the focus is on the sounds, there is consequently no need for students to learn the names of the letters during initial instruction in speaking and reading skills when using this invention.

In fact, this inventor has found that early teaching of the names of letters during reading instruction may actually cause confusion for students who are not able to differentiate between letter names and letter sounds. These same students often have difficulties discerning variations in spoken or written sound patterns and understanding of the varied roles that sounds and letters can have in speech and literacy activities. Such distinctions in reading approaches may seem like minor differences. However, the view that spoken utterances are of primary importance and written utterances are of secondary importance, allows emphasis and attention to be focused on what students actually say and understand during speaking and literacy training. In other words, the focus is first on what we say, while identifying sounds and then words and language patterns, as associations are made between sounds and the written letters which represent said sounds. Using the invention, sounds are attached to letters in specific ways that allow letters to represent the sounds, so that words are looked upon as being derived from the sounds, such that students understand that words are represented first in spoken forms and then in written forms.

As part of this approach, students are taught that spoken sounds are presented or paired with written letters and letter combinations. For example, the single sound /s/ is represented by a single letter “s” and the single sound /h/ is represented by a single “h”, while the single sound /sh/ is represented by the combined letters of “s” and “h.” Students are taught that /sh/ is a distinct or different single sound even though the same letters are used for separate sounds (or “s” and “h”). The focus in the invention then, is on learning the sounds and seeing or recognizing the letters only in relation to the sounds. The invention focuses on facilitating student recognition of unique aspects of sounds and variants (or allophones of phonemes) of sounds in isolation and in sound sequences, while promoting the ability to differentiate sounds from one another. The invention also promotes the ability to recognize the positions of sounds in sound sequences and to produce and manipulate sounds using specific sound patterns (see also sections on Sound Circle use).

Consistent with this approach, the initial steps of the reading component of the invention incorporate information from the previously presented components. In this component, students learn about and acquire additional skills in recognizing, producing, using, sequencing, and manipulating sounds through other components of the invention. In this component of the invention, students are taught and learn specific ways of applying information about spoken sounds to written words in order to become skilled at recognizing and using written sound patterns that lead to mastery of reading skills, as well as speech skills.

The Reading Processes component of the invention includes visual or written cues that can be used to support and inform students as to how words should be deciphered. For example, when verbal productions of written consonants differ from their usual written forms, the correct spoken form is represented in writing above the written word. Slashes and dots are also used in a unique manner to signal unused sounds (consonants and/or vowels) and to signal the unique treatment of vowels and variations in vowel productions found in the invention. These markings point out what would normally be termed “exceptions” and promote efficiency and fluency during the learning process. Alternate written forms for sounds can also be looked up or found by students through use of the Sound Symbols Consonant Chart, the Sound Symbols Vowel Chart, and the Sound Symbols Tracking Form. These visual supports serve multiple purposes in the invention, thereby promoting learning and development of skills related to speaking and reading in multiple ways. Although some reading programs do provide visual cues beyond the presence of written letters, the cues used in the invention herein are uniquely designed and uniquely applied.

The Reading Processes component of the invention includes unique steps that are applied when deciphering words (which steps also allow for combined use of other components of the invention and shaping of sounds as described in the invention). These steps were developed to promote efficient and effective means of learning how to decipher words. It should be noted that the order of these steps can vary (or are interchangeable, except that the vowel steps should not be used first). Students are also taught that not all of the steps are necessary for decoding any given word. Before beginning these steps, unused sounds (some of which have traditionally been called “silent” vowels) may initially be crossed out or marked with a slash to signal to students that they do not have to use or produce sounds for these letters (whether vowels or consonants). Later, as students learn to recognize sound and letter patterns, these slashes are deleted. Some of the unique processes, procedures and strategies in the Reading component of the invention (in abbreviated form) and related aspects include the following.

It is best to begin implementing this component once students have some experience recognizing, using and manipulating sounds and have some understanding of the ways in which sounds are paired with their associated letters. While the use of the previously present components is encouraged prior to implementing this component, this is not absolutely required. As such, this component of the invention may be used with students who have already learned about and can identify letter names and sounds associated with letters. These students can certainly still benefit from using this present component of the invention and can learn important skills that will facilitate their ability to read. In other words this component, like the other components in the invention, is designed so that it may stand alone. Although this component may be used alone or in lieu of other components, it is stressed that the overall invention is designed to be most effective and efficient when used as a whole.

It is important to note that regardless of which components of the invention are selected for use, it is still beneficial to include the Sound Symbols Visual Prompts throughout implementation and use of this component. The Sound Symbols Visual Prompts can be used at any time during implementation of this component of the invention. During reading instruction, the Visual Prompts can be used to augment or highlight the regularly available auditory, visual, tactile, kinesthetic, and proprioceptive information on sounds that teachers and students often do not attend to or which they frequently take for granted. The Visual Prompts are particularly helpful for teaching about sounds, for teaching sound and letter associations, and for facilitating corrections when errors are made in sound productions during reading tasks. Use of the Visual Prompts in the Reading Processes component also facilitates learning and recall of this information, including recall of sounds and their associated letters. This unique format contrasts significantly with traditionally used approaches for instruction that do not provide such additional, systematic, multimodal information on sounds and instead rely on repetition and modeling of sounds and the teaching of rules.

The Sound Symbols Reading component includes the following Sound Symbols Reading Processes, Procedures, Activities, and Strategies. In this reading component of the invention students continue to expand their understanding of sounds as they learn about a growing variety of sound patterns and how they are represented by written words. They also learn how to recognize, manipulate, and use sound patterns as they develop their understanding of the ways in which words are formed by connected sounds. It should be noted that in this invention, understanding sounds and understanding how sound patterns operate in written forms are treated as two related, even layered, but somewhat discrete but intertwined aspects of sounds. The main focus in this component of the invention is on increasing student understanding of how sounds are used to form words and how sound patterns operate in written forms.

### Component Steps for Implementing the Sound Symbols Reading Processes, Procedures, and Strategies

Specific aspects of the invention and the Sound Symbols Reading Processes, Procedures, Strategies and Activities are described and can be implemented as follows.

1. Initial Reading Processes: Identification of Consonant Sounds; Identify and Say the Consonant Sounds in the Words, without the Vowels.

Stage one begins by having students say the consonant sounds in target words (not the names of the letters) without saying the vowels. If accurate word production is attained, determine if the word is discerned or understood by the student. If the word is not discerned or understood, have the student repeat the word several times, checking again if the word is discerned. If the word is not discerned after several attempts, read out the sounds in the word to the student several times (with brief spaces or pauses between the sounds), then read the full word several times. By this time, the student should discern or understand the word and show awareness that they recognize the word. This step should be done using words which are familiar to the student in terms of meaning, being recognizable to students when the words are heard by them.

During initial instruction using these processes, written consonants that differ from their spoken sounds should have the actual spoken sounds represented in writing above the written word. Note that alternate written representations of spoken sounds can also be found or looked up by students through use of the Sound Symbols Consonant Chart when the actual sounds are not written above the word.

When specific written consonants are not used or are not spoken during verbalization of a word, these sounds should be crossed out during the initial learning stage. These written letters are identified as “unused” sounds. These actions further facilitate student learning of sound patterns, as they are represented in written form. This step helps students develop awareness and understanding of the fact that not all letters that represent consonant sounds are spoken or used during the production of words from their written forms. This step also helps students learn that spoken sounds may be represented using a range of written forms. This is important, given that these phenomena do not exist in speech or spoken words.

This phase, which focuses on consonants, can be carried out by just identifying the consonant sounds in text or through the use of activities where teachers or students “pull down the consonants” (e.g. rewriting just the consonants below the word in order to separate and focus on only the consonants and to distinguish them from the vowels in the word). For older students in particular, it can help to distinguish this phase of word identification by applying the term “pull down the consonants.” Other means of identifying consonants, such as underlining, circling, or highlighting may also be used.

Note that this stage in the invention is unique given the traditional focus on vowels or on all sounds when learning to decode words. It is inefficient to always include steps pertaining to vowel sounds, or work on vowels, when they are not needed, making the approach and focus in the invention different from traditional approaches. Many words can be identified using just this process or step. For those words that cannot be discerned with only the consonants, proceed to the following steps.

2. Initial Reading Processes: Identification of Vowel Sounds

In stage two, students say the consonant sounds in the target word again, but this time vowels are included using the following procedures. It should be noted that the order of identification of the different types of vowels (silent, short, long) can vary, based on the target words and the needs of students.

Initial Identification of Silent and Short Vowels; Use a “Beep” Sound for Vowels, Replacing Each Vowel with a Neutral, Place Holding or “Waiting Sound”

After working on consonants, the next action is to “Pull down” the letter for each vowel (one at a time). An optional action is to replace each vowel sound (e.g. instead of reading or saying the vowel sound) with a neutral, place holding or waiting sound, which is called a “beep” in the invention. These beeps or place holding sounds (waiting sounds or sounds that separate the consonants) can be marked above the vowels using a single dot. The dot is used in this manner primarily for ease of reading and to support efficiency in using this part of the process. The dot functions as a signal to the student to insert a beep sound between, before, or after consonant sounds, in lieu of the target vowel sound. The “beep” sound produced may resemble an “uhh” sound, a grunt, or a schwa sound. It should be noted that the schwa sound, even when not used in this manner as a holding sound, is reported to be the most common vowel sound in the English language (Blevins, 2006).

Only one vowel at a time is added to the consonants which have been pulled down (or identified for use in any word which has not been “pulled down”), using this process. As one vowel or beep sound is added, the consonant sounds are verbalized along with the single vowel. If the word contains more than one vowel, remaining vowels that are actually verbalized are added in one vowel at a time. This process facilitates development of students' skills for sounding out words. This process also simultaneously develops the ability of students to identify (or discern the meaning of) the words which are represented by the sounds.

During initial instruction pertaining to vowels, teachers may shape these sounds slightly to more closely resemble the specific form of the vowel in the word. For example, in the word “mom,” the beep or “uh” may be shaped slightly to more closely resemble a very short “ah” sound. Once the student becomes familiar with the vowel sounds and knows how to utilize the overall vowel process, this slight shaping of sounds can be quickly eliminated.

When vowels are not used, not verbally produced or spoken during production of words, letters corresponding to these sounds should be crossed out during the initial stages of instruction or learning. These written letters representing “silent” vowel sounds are identified as “unused” sounds. This step further facilitates student learning of sound patterns, as they are represented in written form. This step helps students develop awareness and understanding of the fact that not all letters representing vowel sounds, or consonant sounds for that matter, are spoken or used during the production of words that are in written form. This is important, given that this phenomenon does not exist in speech or spoken words.

This stage and strategy in the invention is unique given the traditional focus on learning exact productions of vowels, particularly short vowels, when learning to decode words. Moreover the use of a single dot to mark and contrast short vowels with long vowels is also unique, as is teacher shaping of short vowel sounds to facilitate the learning process.

The Sound Symbols Visual Prompts for vowels (as well as consonants) may also be used at any time during these procedures. As noted above, these Visual Prompts are helpful for teaching sound productions, identifying sounds, teaching about sound patterns, and facilitating corrections when errors are made in sound productions during reading tasks.

Initial Identification of Sound Circle Vowels; Using the Invention's Sound Circle to Guide Pronunciation of Vowels (Primarily Long Vowels, Except “U2”)

When the vowel sounds in words are Sound Circle vowels or long vowels (or say their own name and/or match the vowel sounds on the Sound Circle) in spoken and written forms (e.g. a, e, i, and o, as well as U2, where treatment of U2 was previously addressed), dots are not placed over these vowels. Nor does the “beep” process apply to these sounds. Students should be able to recognize most if not all of these sounds and their corresponding letters by the time they begin to work on written words.

Even though students may recognize these long vowels quite easily, the process of initially deleting the vowels (e.g. first identifying consonant sounds, then adding in vowels) and using “beep” sounds where applicable should still be used, since this process is an important part of learning how to sound out, recognize and identify words. In other words, activities at this stage are about more than simply saying the sounds that correspond to the letters, they are about learning the processes for sounding out words. Likewise, the procedure of adding individual vowels back into words is a significant part of this process, whether the vowels are considered to be the more easily recognized long vowels or the short vowels, as traditionally identified.

At this stage, vowels in the invention are divided into the groups presented above, as “Sound Circle sounds” (also called “Sound Circle vowels” and “Circle sounds” and are similar to but not fully equivalent to long vowels), as “beeps” or waiting sounds (some of which are traditionally called short vowels), and as “unused” sounds (some of which are traditionally called silent vowels). While some of these beep sounds (whether shaped or not) and unused sounds are traditionally called short vowels or silent vowels, this does not mean that the approach used in this invention can be characterized as a traditional approach.

This is due in part to the finding that words can often be accurately identified by sounding out only the consonants, without having to use, include or address vowel sounds. Furthermore, the ability to sound out words using only consonants increases when context cues are available, making it inefficient to include steps pertaining to vowel sounds when they are not needed to ascertain the meaning of the target word or words. Moreover, in this invention, “unused sounds” can refer to consonant as well as vowels. This step and strategy in the invention are unique given the use of the Sound Circle as a tool for facilitating reading. These and other aspects of the reading component of the invention differ from traditional approaches, as described here and below.

Combined Vowel Processes

The invention provides simple processes and procedures for producing and identifying written words, thereby avoiding the need for memorizing a myriad of rules and exceptions to rules. This supports students in being able to quickly experience success in reading tasks. The processes and procedures in the invention are also very flexible, allowing them to be used in a fluid manner for the most efficient and effective outcomes possible. For example, the order in which the above processes relating to vowels are used can be changed or can vary from the specific order listed above once students have learned the steps or processes to be used.

It is also important to note that more than one of these processes may facilitate student decoding of any given sound. For example, a student may discern the correct use of a particular vowel sound in a specific word through the use of only consonant sounds (e.g. student is able to identify the word after verbalizing only the consonant sounds), through the use of “beep” sounds, or through the use of Sound Circle vowels. In other words, there is not necessarily a one to one correspondence between the identification of vowel sounds and the specific process used. Moreover, a student might discern a particular vowel sound using one process in one instance and may discern the same sound through the use of another step in the process at a different time. This means students have more opportunities for success without being constrained by having to use exacting and narrowly limiting or rule-bound approaches to decoding.

Once students are able to engage in the above processes, their ability to accurately produce and read words may be relatively good (particularly if instruction in use of the Sound Symbols Sound Circle has been provided). In other words, students should be able to demonstrate the ability to read simple words when they can identify and produce consonants in words (also demonstrating an ability to identify simple target words) without vowels being incorporated; can similarly produce and identify words containing unused sounds (both vowels and consonants); can produce and identify words using the “beep” strategy to replace vowels; and can produce and identify words with Sound Circle vowels (or long vowels). Students as young as age four may be able to easily learn and use these strategies.

After students have learned and practiced using these processes for identifying words and handling both consonants and vowels with some supports, they are ready to increase independent levels of functioning. The invention includes mnemonic tools or devices to assist with this. For example, the mnemonic device “Stop in and help us.” can be used to expand independent identification of the “beep” sounds (or short vowel sounds), particularly where shaping assistance was given (or when needed at high levels). Using this mnemonic device, students have quick access to target words that contain vowels that can be matched with the vowels in other words. Students can use these “helper” words (or similar words and phrases) by matching vowels (in terms of sounds and letters) from new words to the mnemonic device or vice versa. It is best to teach use of this mnemonic device in stages by introducing the mnemonic and then applying it to reading tasks one vowel (or word by word from the phrase) at a time. This and other mnemonic devices in the invention have been designed to systematically facilitate modeling and recall of sounds and to promote self-cueing and self-correcting on sound productions during the learning process.

Independent levels of functioning can also be developed and strengthened by encouraging use of the Sound Circle for recall and self-cueing on long vowel sounds or Sound Circle vowels. Other tools and charts in the invention can also be selectively utilized to facilitate progress and growth in terms of independent levels of functioning.

### Reading Fluency, Reading Comprehension and Progressive Skill Development

Using the reading component of the invention, students first learn to identify and produce the consonant sounds in words in a straight-forward manner. For those words that need to be accommodated in different ways (than this simple approach) there are additional strategies that students can learn and apply, which will help them decipher the majority of the words in the English language when used in combination with the above processes and strategies. These additional strategies are described in the next section. The streamlined approach to reading, which is offered through use of this invention, significantly increases efficiency, reduces the memory load for learning how to read, and at the same time increases understanding of the patterns or rules of the language that pertain to sounds and sound patterns in reading. The approach presented here decreases the need to address exceptions to rules, thereby promoting faster learning of more words, higher levels of accuracy and decreased difficulties. Reading skills can develop more quickly due to the reduction in the overall number of “rules” that must be learned and the reduced impact and role of the many exceptions to the plethora of rules normally included in most reading programs. As a result, reading mastery and fluency can be achieved at faster rates and with relative ease.

It should be noted that it should not generally be necessary to use all of the stages or strategies described below for deciphering each word. Many words can be deciphered in more than one way, as was noted above. For example, two (or more) of the four ways could potentially be used to successfully decipher a given word. This also sets the invention apart from other methods where single methods for decoding words are more the norm and many exceptions for words that don't follow the single “rule” approach must be memorized. Reducing the memory load by decreasing the role of rule memorization can contribute to development of reading fluency.

In this invention, flexibility and fluidity are emphasized in the decoding process. Another one of the ways this approach accommodates exceptions and promotes flexibility and fluidity is by facilitating deciphering of words that are very similar in look and letter usage. For example, correct production of exceptions for both consonants and vowels can initially be marked above the letters, so that efficiency and fluency are not impacted while students learn to recognize said exceptions. These cues can be dropped off quite quickly as students learn to recognize the words and as they become familiar with the strategies used for deciphering words. Students can also be taught to refer to the Sound Symbols Consonant and Vowel Charts to learn, understand, and recognize so-called exceptions.

Decreasing the emphasis on one to one correspondence between rules and sound productions also enables a greater amount of flexibility to be built into the entire process of decoding that is possible through use of this component. In other words, the invention uniquely demonstrates that multiple approaches can be used for decoding words. Moreover, a flexible approach can be more supportive of attitudes that promote student playfulness and engagement in exploration when working on the discernment of words from written sounds. Flexibility, playfulness, and a willingness to participate in exploration can lead to improved and high levels of engagement, resilience, and persistence as well (including in efforts to understand sounds and decode words). Furthermore, these attitudes and related actions send the message that it is acceptable to make mistakes and to make corrections during the reading process, as well as during the learning process. Through all of these means, student accuracy and fluency can develop and improve.

3. Combining Consonant and Vowel Sounds; “Connect the Sounds”

Using the above processes and strategies, many words can be correctly produced. By this stage, many words will have been correctly identified. For those words that are not yet identified, work should proceed by having students say the sounds while connecting them. At this phase, instructors and students combine work on segmenting and connecting sounds with work on verbally reading words. This stage and related strategies in the invention are unique, given the attention to segmenting and combining of sounds, as well as related attention to the insertion, extension and deletion of pauses or sound breaks between sounds, when decoding and identifying words during reading instruction. This technique of separating and connecting sounds, while deciphering words (see related descriptions herein) facilitates student learning and skill development in reading (or production) and comprehension of words. This approach differs from traditional reading approaches which do not address these aspects of sound productions as related to reading instruction.

It should be noted that during initial learning phases, students may tend to naturally insert and extend pauses (or sound breaks) between sounds when they work on deciphering or reading words. It is possible that skilled use of variations in timing of sound productions may be related to the learning process and may be particularly relevant to learning how to manipulate and sequence sounds.

Word recognition may be limited at this point, when students focus primarily on sounds and don't yet have a strong or established sense of the relationships between sounds and words. As students improve their sound productions (during both modeling of sounds and during identification of words from sounds paired with written letters), they are likely to be able to decrease and then eliminate the extra or extended pauses. Moreover, producing sounds in a flowing and connected manner, like they are produced during ongoing speech, may increase student recognition of the words they are reading. Consequently, helping students make these transitions as they actively work on connecting sounds is incorporated into the invention's processes and activities.

Initially, this can be accomplished by modeling separated sounds and then modeling words using connected sounds, modeling the transitions from one sound to the next. During reading activities the action of connecting of sounds is modeled (separating and then connecting sounds), encouraged, and even practiced once students are able to independently identify sounds in written words. Young students who are just learning to associate sounds with written words will need specific instruction and practice in segmenting and combining sounds during reading activities, particularly if the Sound Symbols Sound Circle has not been used. It is important to realize that these skills are viewed as an integral part of reading and not simply developmental or prereading skills, as is sometimes thought. Moreover, the ability to manipulate sounds and control sound productions can contribute to reading comprehension and reading fluency. It should be noted that word comprehension can be increased through use of these strategies and components of the invention, whether they are introduced early on or are used in later stages of the process (e.g. during Sound Circle use and later in reading processes).

Younger students (or students new to reading activities) can progress to the next stage once they are able to consistently model production of single sounds and connecting of sounds into words and can discern at least several words. Students who can read some words and have already learned the sounds associated with all or most of the letters, but still struggle with reading skills, can begin working on the next stage below:

4. “Pull Down the Consonants” (Expanded from Stage One Above)

At this stage, students say the consonants in the word, without the vowels. If accurate word production is attained, the teacher determines if the word is discerned or understood. If not, the student repeats the word several times while attempting to discern the word (teacher continues monitoring to determine if the word is discerned). If the word is not discerned after several attempts, the teacher reads the sounds of the word to the student several times, then reads the word several times. Then students model this strategy in order to learn and become proficient at applying it. Many words can be identified using just these steps and processes. If the word cannot be discerned with only the consonants, proceed to the following step.

As part of this stage, you can also “pull down the consonants,” underline, circle, or highlight them to make it easier for students to identify and verbalize only the consonants. Also refer to “The Sound Symbols Reading Procedures” listed above for additional information which can be useful during this stage as well, such as the use of written supports. The main difference between this stage and Stage One above, is that the written supports and the pauses or brief spaces between the sounds are no longer used or are phased out whenever possible. If students do need additional supports, it may be beneficial to either continue to incorporate these supports or to revisit Stage One and proceed through subsequent steps from that point.

5. “Find the Words”

After using the above strategies for identifying consonants (e.g. “pull down the consonants,” underline, circle, or highlight the consonants, or simply sound out the consonants), the next step is to identify any word or words located within the target word that can be recognized. This step is only implemented when students have not been able to read or identify the target word. Any words within the target word (including consonants and vowels that form words within the word) can be “pulled down,” underlined, circled, or highlighted to separate them from parts of words not yet identified. Next, students say the sounds of the rest of the consonants situated around the identified word (e.g. before and/or after any word or words which have been identified).

At this point, any sounds (e.g. silent vowels and/or consonants that do not contribute sounds to the whole word) that are not used in production of the full word can be crossed out. If accurate word production is attained, determine if the word is discerned or understood. If accurate word production is attained, but the word is not discerned or understood by the student, see Stage 4 above. If the word cannot yet be accurately produced using only consonant sounds, proceed to the following step.

6. “Pull Down the Vowels” (Expanded from Step 2 Above)

The next strategy involves pulling down the remaining vowels, one vowel at a time (underlining, circling, or highlighting vowels one at a time are also options). At this point, the Sound Symbols Sound Circle can be used or brought out to facilitate pronunciation of the vowels during attempts to produce and identify the word. Many words can be identified using this process and the above steps. When alternate productions of vowels (e.g. short vowels or silent vowels) are necessary in order to identify words, application of alternative pronunciations and marking of vowels using the “beep” process and mnemonic tools (e.g. “Stop in and help us”) can be helpful. Shaping assistance can also be provided when needed (see above vowel sections under Stage 2 for additional information). Vowels are “pulled down” (underlined, circled or highlighted) and inserted one at a time, then an attempt to identify the word using the consonants and the included vowel (or vowels) is made again, after each vowel is added. This process is continued until all the vowels have been included or “pulled down.”

Students should be able to identify the target word by the time all the vowels have been included. If not, teachers should produce the sounds (keeping them slightly separated yet) in the words that have not been identified by the students, making any corrections or adjustments that are needed. Once the sounds contained in the word have been correctly produced or presented, students should repeat the sounds and then attempt to produce the word several times in a row, with the teacher again checking to see if the word has been discerned. If the word is not discerned after several attempts, the teacher should read the sounds of the word again several times, first with sounds slightly separated and then with sounds combined. After the teacher reads the word several times in this manner, the student should then model what the teacher has said by saying the sounds one at a time and then combining sounds to produce the full word.

The main difference between this step and Stage Two above, is that the written supports and the pauses or brief spaces between the sounds are not generally used throughout this stage. These supports may, however, be inconsistently used as they are being phased out. If students do need these additional supports on a consistent basis, it may be beneficial to either continue to incorporate these supports or to revisit Stage Two. Note that the Sound Symbols Visual Prompts may also be used at any time during these procedures to provide extra supports. The prompts can be useful for helping students identify target sounds in the words, as well as being helpful for visually demonstrating aspects of connected sounds. The Visual Prompts are also useful for facilitating corrections when errors are made in sound productions during reading tasks.

At this point students are encouraged to identify vowel productions using the invention's processes while cycling between the various ways in which vowel sounds may be correctly identified or discerned. In other words, at this stage students should be able to insert “beeps,” use the Sound Circle, use mnemonic tools or devices (e.g. “Stop in and help us”), and apply the “unused” strategy for sounds, with growing levels of independence as they work on simultaneously identifying and matching up vowels in target words.

At this point, students will need to be able to alternate between the component's strategies (e.g. “beeps,” Sound Circle, mnemonic devices, and unused sounds) in order to correctly identify words. Engaging in this process may be somewhat slow and laborious compared to other aspects of the invention, but work on skills at this point are important for moving toward reading proficiency. Moreover, using these processes will support student efforts to develop their ability to automatically recognize words. Pressure to develop sight words at this point, however, should be avoided as the benefits of learning to use these processes for sounding out words will far outweigh the acquisition of a few sight words. As students learn to apply these processes and strategies, they should begin to be able to accurately sound out words that are new or even unknown to them, because they are learning the sound patterns and rules for the language.

Combining Processes and Strategies

Following practice using these strategies with various sets of words, strategies for identifying words can be combined and presented by instructing students as follows: “Pull down the words; Pull down the consonants; Pull down the vowels.” Instead of saying “pull down” the action and instruction “identify” could be used instead (without “pulling down,” circling, underlining, or highlighting).

Notice that this is a change, where any identified words are “pulled down” or identified first, instead of second. Also note that the step, “pull down the words,” can refer to words identified within the word or it can refer to pulling down a full word within a phrase or a sentence, depending on the level of performance of the student. It can also refer to identification of the words, consonants, or vowels without pulling them down, as previously described (e.g. underlining, circling, or highlighting words, consonants and vowels one at a time, as options). While the above steps are interchangeable, the step of “pulling down” identified words first should be implemented after students have practiced the previously presented processes and related strategies and are readily able to identify several words as a result of practicing these aspects of the reading component. Once students can identify a range of complete words, as well as words within words, the step of identifying words within target words can be interchanged with the other steps as needed and as seems most beneficial to the students being taught.

“Connect the Sounds”

Lastly, the process cycles back to the strategy of connecting the sounds (see Stage 3 above). This step is needed only if use of the previous steps did not lead to identification of the target words. It should be noted that students may be able to produce all of the sounds correctly by this time and may even be saying the target word in an intelligible manner although they may not yet recognize the word that they are saying. This may result from students' intense focus on sounds, such that they do not yet register their own production of words. This can also occur when the sounds in words are spoken separately where the lack of connectedness inhibits the ability of the student to “hear” or recognize the word. Failure to recognize correctly read and spoken words may occur even when students clearly say target words.

Early in the process of connecting sounds, some students may rely heavily on teacher support. After students have learned and can use the above strategies, students can then apply the strategy of connecting sounds while they attempt to determine the meaning of the words expressed by the sounds they are producing. This can be accomplished by applying this strategy, of connecting the sounds, as students practice transitioning from production of sounds to production of words (as described previously). As students learn to connect sounds, supports (such as use of the Sound Symbols Visual Prompts) may gradually be faded out until students are able to use this process independently. For example, after students have used the other processes previously learned and have not yet determined the meaning of a target word, they should apply use of this process independently, whenever possible, to decipher words.

By this point, students should begin to be able to cycle between consonant and vowel productions and the connecting of sounds (similar to the description in the above vowel section regarding rotating between short, long, silent and unused vowels) as they listen to their productions of potential words. At the same time, students will also begin to work on determining whether or not their attempts to identify target words are successful. At this stage, students should being to develop an ability to work flexibly with sounds by increasing their ability to manipulate sound combinations and parts of words, while further developing their understanding of how sounds are connected. In other words, these processes can promote students' abilities to connect and manipulate individual sounds, sound patterns and sets of sounds (e.g. digraphs, blends, etc.), parts of words, and whole words. These sound skills may appear to be somewhat discrete from the ability to recognize words from sounds, while retaining an important relationship to being able to decipher word meanings. They are nevertheless related though, because students must be able to cycle back and forth between these skills when their initial attempts to identify words are unsuccessful and repeated use of these processes is necessary in order to correctly identify target words.

Sound Patterns

In order to be able to accurately connect sounds and decipher words, students must correctly match sounds and corresponding written letters. They must be accurate in their sound selections in terms of both individual letters and in terms of sound patterns. This requires an ability to either know and recognize all of the possible sound patterns or an ability to explore and figure out the patterns that can apply to words in general as well as in specific word contexts. Students who are learning to read clearly do not yet know all of the rules that apply to reading, nor do they consciously recognize or know all of the possible sound patterns. Consequently, they require instruction in these areas.

In this component of the invention students are taught to look for patterns in words, instead of being taught to learn long lists of rules. Students are also taught to view sounds and sound patterns as flexible and fluid. In order to successfully recognize the many ways in which sounds may be used, students are encouraged to explore or “play” with possible sound productions and to flexibly manipulate sounds. In fact, the establishment of rigid conceptions of sounds and sound patterns is intentionally avoided in the reading component of this invention.

Even if students learn a plethora of rules, they will not do well deciphering words if they lack these types of skills or if they regularly approach reading with an inflexible, narrow, rule bound mindset. Students must develop a mindset that allows them to approach individual sounds and groups of sounds as layers of sound patterns that connect across words in predictable ways. This component of the invention promotes a flexible understanding and conception of sounds and sound patterns. In fact, the stance that applies to this component of the invention is that students need to develop the ability to be flexible along with an ability to envision multiple ways of representing sounds. Flexibility and a willingness to manipulate sounds contribute significantly to the student's ability to produce and discern spoken words from their written representations. This component of the invention promotes this conception of sounds in contrast with traditional approaches that have a much more rigid, narrow, and rule-bound view of reading and reading skills.

In addition to teaching students to approach deciphering of words in a playful, explorative manner, this invention also provides tools to guide student selection of appropriate sound choices. The Sound Symbols Consonant Chart and Sound Symbols Vowel Chart include various written forms of sound productions that can be used to express or describe the sounds listed in these charts. Special labels to describe sounds and sound patterns have been created as part of the invention and include such designations as “Pretenders”, “Transformers”, “Chameleons,” “Special Agents,” “Resisters,” “Challengers,” and “Responders,” or other names as assigned to specific sounds and sound patterns (refer to the designated charts). These special labels help students understand how the respective sounds operate differently than other sounds in general. This includes for example, sound patterns such as /h/ functioning as a transformer (where the presence of /h/ signals a transformation in normal sound use), in addition to other designations for sound patterns which are listed in the Sound Symbols Consonant Chart. These designations help students learn about some of the more overarching principles that affect how sounds operate in both speaking and reading. This format contrasts significantly with traditional approaches for reading instruction which rely heavily on recall of specific rules applied to individual letters. The sound patterns included in the invention and listed in these charts should not, however, be considered as all inclusive, but are representative of the types of sound patterns that can be observed in written forms for the English language.

Extending the Reading Process

The processes and strategies presented here are first used with single words (see also below). Next, these processes and strategies are used with combinations of words or short phrases, and then they are used in sentences. Finally, these processes are used as needed during ongoing reading activities. As students improve their reading skills, they are then able to naturally drop off use of and the need for these processes, strategies and related tools.

Students do not need to use these processes or strategies on words which they are able to quickly identify and fluently produce. On the other hand, the Sound Symbols Visual Prompts may be used at any time during these procedures, particularly when students are having difficulties. The Visual Prompts are also helpful for facilitating corrections when errors are made in sound productions, not only during early reading activities but during ongoing reading tasks as well.

Initially, these and the other processes, procedures and strategies in the Reading Processes component of the invention are used with several words that are familiar to the student. Once students have learned the processes and strategies for identifying written consonants and vowels in words and can decode some words, it is helpful to present two to three sets of familiar, related or categorized words (e.g. colors, foods, familiar people, familiar places, pets, zoo animals, etc.). This is done in order to facilitate students' reading of words from a limited set of familiar items. Moore and Lyon (2005), among others, indicate that the value of concept-based vocabulary instruction is supported by research. By extension, concept-based instruction embedded into reading instruction is likely to be more beneficial than random selection of frequently used words, as is the usual practice.

Next, the steps are used with new words, and then with words in phrases and sentences. This use of specifically selected and grouped words differs from traditional approaches which generally base word selection primarily on letter sounds (e.g. “a” words, “b” words, etc.) related to the selection of sight words or the most frequently used words.

Use of several sets of related words can suffice for helping students at this phase, which is focused on practicing and applying learned strategies to single words. When first introducing these sets of words, only familiar words or vocabulary should be used. After students practice reading a list of five to ten words, then a new or less familiar (e.g. unfamiliar vocabulary) words can be gradually added to the sets. Unfamiliar words are initially added to help students realize that they can learn new words by using the processes and strategies they have learned. In this manner, decoding skills and language skills (e.g. categorizing, language concepts, etc.) may be easily combined. Additional practice with various, new sets of categorized words can be implemented if needed. Use of this phase, however, may be intentionally brief in order to encourage rapid transition to phrases, sentences and then text on pages and in books.

At this stage, it is important to note the types of fonts being used, so that any errors students make are not due to student problems with accurate discernment of letters rather than errors in sound productions. Many different types of fonts are used in written materials and at early reading stages students do better when there is consistency in font usage. Even slight differences in fonts, yet alone clear differences in fonts, can undermine student performance at early reading stages. Students should not be expected to work on reading and increasing their ability to recognize different fonts at the same time. Rather, these skills and tasks should be separated until students have developed at least rudimentary skills levels in both areas.

After using the invention's processes and strategies with limited sets of words, the transition can be made to increasingly longer strings of words in phrases and sentences. In other words, the invention's methods may be applied to more ongoing reading activities. As students transition to longer tasks, additional supports may initially be needed in order for students to keep their place and to assist them in keeping track of the sounds they are working on (e.g. pointing to sounds using the bouncing and sliding techniques found in the Sound Circle component, pointing to words, having students point, placing card above words, etc.). Teacher assistance in using the processes and strategies in this component of the invention (e.g. use of Visual Prompts, written dots, cross out unused sounds, etc. as described above) is often still helpful at this phase yet. The same types of supports used for reading single words can also be used for reading connected words and text, although at this level teachers should be able to begin to gradually phase out supports.

The focus at multiple word and sentence levels is on increasing students' ability to independently apply the strategies and processes of this component of the invention. This focus is maintained even as students simultaneously work on ascertaining the meanings attached to combinations of words. As students become more skilled in using the invention or in applying these processes and strategies, increases are likely to be noted in the rate at which words are recognized. The use of self-monitoring, self-cueing, and self-corrections should also begin to emerge when errors are made.

As in other components in the invention, letters are presented as written examples of sounds where the names of the letters themselves are not taught. Throughout these activities, the emphasis is on the sounds and sounds are presented as the primary feature and focus. Students are taught that words are represented in written form for the purpose of allowing identification of words from the sounds that make up the selected words. The act of reading in this invention is construed as the verbal identification (whether spoken out loud or internalized as speech) of sounds, represented in written forms as sound patterns and words, that can be converted into meaningful and shared language. This includes, but is not limited to words, ideas, phrases, sentences and ongoing communication. The processes, procedures, strategies, and activities presented herein as part of the Reading component of the invention provide unique means of teaching and learning about sounds, as well as effective and efficient means of developing reading skills in students of a wide range of ability and age levels.

The Reading Processes component of the invention includes all of these unique and varied processes, procedures, strategies, and tools for learning about sounds and sound patterns in reading tasks, with application to speaking, writing and spelling. The processes, procedures, strategies and activities presented herein as part of the Reading component of the invention provide unique means of teaching and learning about sounds and sound patterns, as well as effective and efficient means of developing reading skills in students of a wide range of ability and age levels. It should be noted, however, that as students improve their reading skills, they can naturally drop off use of and the need for these processes, procedures, strategies, and tools.

Applying the Invention to Writing and Spelling

This component of the present invention is further characterized as providing unique processes, procedures, materials, tools, items and kit components to facilitate teaching and learning of reading skills, which can also apply to writing and spelling. Through use of the invention students can develop specific essential skills, as they learn about sounds, that can transfer to writing skills and some spelling skills. The approach in this invention contrasts significantly with traditional approaches which focus primarily on letters, instead of focusing primarily on sounds and the role that sounds play in learning to apply speaking and reading skills to written work.

The specific items in and the format of the Reading component of the invention presented herein should not be regarded as restricting the range or application of this component of the invention or the invention itself.

Pertaining to Claim 1 and FIG. 9: Sound Prosody

The system of Claim 1, wherein the present invention is characterized as providing a component for presenting, teaching and learning about how to recognize and use aspects of sounds identified and labeled as “Sound Prosody.” “Sound Prosody” is an original concept and original term developed as part of the invention to explain and demonstrate specific aspects of sound productions and their use not recognized or explained as such in other speech and reading programs.

“Sound Prosody” goes beyond the notions represented by the term “prosody” which has historically been attributed to syllables, but not sounds. Prosody is generally considered to include rhythm, stress, and intonation or syllable length, loudness and pitch (Webster's New Collegiate Dictionary, 1977). These features of prosody are most often considered individually and less often in combination. It should also be noted that the concept of prosody is not normally considered or addressed in discussions pertaining to relationships between sounds or to discussions on the acquisition of speaking and reading skills. Instead, it is more common to consider prosody during discussions about syllables, phrases, grammatical features (such as its use in rising intonation to signal questions) of language and expression during speaking or reading. While the term “Sound Prosody” builds on previous art by incorporating the word “prosody,” this component of the invention also looks at prosody in unique ways and applies it in new and different contexts.

In this component of the invention, the concept of prosody is applied to sounds (instead of syllables or words) and therefore the term “Sound Prosody” was formulated to depict this aspect of the invention and this component. The “Sound Prosody” component of the invention includes a variety of qualities that facilitate understanding and production of unique aspects of sounds, as well as differences among sounds, and includes the following: sound length or extension; timing of sound productions; space or pauses between sounds and words; individual sound rates and ratios (such as the rate differences among sounds); overlap and transitional aspects among, within and between sounds (e.g. sound changes during transitions); variations in emphasis during sound productions; completeness or clipping of sounds; variations in the boundaries of and between sounds; the distinctiveness of the features of sounds and how this impacts distinguishing the point at which features become or remain distinctive; vigor (or softness, gentleness, firmness, or harshness; pressure levels during forming and releasing of sounds) of sound productions; and airflow features during sound production.

“Sound Prosody” as a term describes all of these aspects of sounds in terms of individual features and as combined characteristics of particular sounds. Sound Prosody can perhaps be best described as portraying the multidimensional nature of sounds (e.g. length, height or depth as tonal variations or emphasis, strength or vigor, rate, and complexity or completeness of sound productions). These aspects of sounds, identified as Sound Prosody, are shown or demonstrated through the pairing of the Sound Symbols Visual Prompts with their corresponding verbal productions (e.g. sounds in isolation, in syllables, in words, and in ongoing speech or reading) and orofacial movements and positions. In other words, the invention provides hand, finger and arm positioning and movements that inform on the nature of the sounds produced, as described above.

Addressing Sound Prosody provides a number of benefits. This concept is helpful for understanding both normal sound productions and errors in sound productions. For example, perceptions of mumbled speech may be due to articulation errors or may be a result of discrepancies in prosodic sound features, such as shortened sound lengths (often perceived as fast rate of speech), indistinct production of sounds (often occurring due to indistinct aspects of sounds or incomplete production of sounds before transitioning to the next sound), and lack of adequate pauses (transitioning too quickly from one sound to another sound). With this approach we can even see that some sound deletions and distortions are the result of difficulties transitioning between sounds, thereby revealing that some errors may not represent typically identified articulation or reading errors but may instead be indicative of errors in Sound Prosody. Use of this component of the invention for addressing errors contrasts significantly with traditional instruction which does not address or include these aspects of sounds and sound productions.

Given that Sound Prosody is a newly coined term, it is not surprising that efforts to teach speaking and reading skills have not generally considered or addressed these types of dynamic or prosodic aspects of sounds, or the impact they can have on the teaching of speaking and reading skills. Several concerns emerge from brief consideration of the impact that failure to consider these aspects of sounds can have. For example, attempts to successfully remediate sound deletions and distortions by teaching correct sound productions may prove to be difficult if errors are caused by impaired understanding of these identified aspects of Sound Prosody. In such cases distortions or deletions are likely to continue to occur, particularly in ongoing speech and reading. These errors and sound deletions may persist, but not because correct sounds can't be produced or read. Instead such errors continue to be made when the speaker or reader does not understand the prosodic features of the sounds or letters being presented to them.

Through use of the invention, teachers and students are provided with information on the nature and quality of distinctive features that can be heard, seen, and even felt (e.g. through movement, touch, and positioning). Multiple aspects of Sound Prosody and distinctive features of sounds can be simultaneously addressed through use of the invention, particularly through use of the Sound Symbols Visual Prompts.

In addition to providing information pertaining to distinctive features of sounds, the invention (particularly the Sound Symbols Visual Prompts) provides important comparative information related to Sound Prosody. For example, simply using the terms “long” and “short” sounds does not provide specific information on the actual or comparative length or brevity of specific sounds. In contrast, using the concept of Sound Prosody and the Sound Symbols Visual Prompts, specific information on the rate and length of sound productions can be provided. Combining the concept of Sound Prosody with the use of Visual Prompts provides teachers with the means to share unique comparative and relational information pertaining to various aspects of sounds, such as the rate and length of sounds. These unique tools can be used to provide visual information on target sounds, as well as on sounds and features of sounds that contrast with the target sound, thus facilitating development of student understanding of the nature of sounds and sound productions. Use of this component of the invention, which provides comparative information on sounds, contrasts significantly with traditional approaches which do not address or include these aspects of sounds and sound productions for reading purposes and give limited attention to these aspects for instruction in speech sound productions.

Information on distinctive features alone does not provide this same level of understanding about sounds (e.g length, rate, etc.) Simple descriptive information cannot provide as much information as the invention and the Sound Prosody component can provide with regard to similarities and differences among sounds and information on how to recognize such aspects of sounds. Moreover, various aspects of sounds, in terms of descriptions and features, are most often presented as static in nature while in reality, variability or alterations in sound productions are routinely present.

For example, length of sound production is relative, particularly in terms of the length of sounds produced across individual speakers as well as in terms of the length of single sounds produced by any given individual in relation to other sounds produced by the same individual. Furthermore, the same sound produced by the same individual can vary across productions and contexts. Numerous other variations can be found in and across sounds (e.g. timing and transitions in voicing to voiceless features, sound changes during transitions, changes in pressure levels during forming and releasing of sounds, etc.).

The concept of Sound Prosody provides a means for understanding the variable nature of sound productions. In this invention, the nature of sound variations are made visible and understandable through the use of the concept of Sound Prosody and the Sound Symbols Visual Prompts. Distinctive feature approaches do not generally make such unique and variable aspects of sounds apparent to teachers or students. Use of this component of the invention for understanding variations in sound productions contrasts significantly from traditional approaches which do not explicitly address these aspects of sounds and sound productions. Furthermore, other approaches do not address the variety or combination of numerous aspects of sounds that are included in the invention as “Sound Prosody.”

In addition to the Sound Symbols Visual Prompts, the Sound Symbols Sound Circle (refer to appropriate sections) has also been found to be a useful part of the invention for helping students make improvements in the use of prosodic sound features. Use of the Sound Circle is beneficial for helping with learning and application of Sound Prosody skills. The Sound Circle is useful for helping students learn and apply aspects or principles of Sound Prosody as they learn to use typical sound patterns when modeling speech. These prosodic sound patterns can then be used with a variety of sounds (such as sound groups or sound types), precluding the need to learn each pattern and aspect of sound prosody individually for each and every sound. This method provides a means of developing consistent patterns in sound productions. It also ensures that the various aspects of Sound Prosody can be easily learned and easily transferred to new sounds, as they are introduced.

Moreover, use of the Sound Symbols Sound Circle facilitates student understanding of the concept of what aspects make up any given target sound and what aspects of sound productions do not fit with the target sound, in terms of both distinctive features and Sound Prosody.

Use of the invention also facilitates student understanding and recognition of errors in Sound Prosody, as well as errors in sound formulation. Increased recognition of errors can then promote increases in self-monitoring, self-cueing, and self-correcting, in both speaking and reading activities.

The information on Sound Prosody and related activities provided in the invention all promote development of skills needed for perceiving, discerning, and producing specific and distinct sounds in both speaking and reading tasks, with application to writing and spelling. Sound Prosody helps to explain and facilitates how we understand separate sounds and then words during ongoing or connected speech. In the invention, use of the concept of Sound Prosody in combination with use of the Sound Circle and Visual Prompts helps to clarify, demonstrate, and teach the skills needed to facilitate understanding and development of skills in these areas. This is accomplished by providing unique information on the nature and quality of sound features that can be seen, heard, and even felt, through movement, touch, and positioning using the Sound Symbols Visual Prompts. Combining the concept of Sound Prosody with use of the Sound Circle and Visual Prompts also helps to clarify, demonstrate, and teach the skills needed to facilitate understanding and development of skills in these areas. The use of this component of the invention contrasts significantly with the format that has been traditionally used for instruction which does not typically address the challenges of discerning specific sounds from one another in ongoing speech and reading.

Nor do other approaches address the variety or combination of aspects of sounds included in this component of the invention identified as “Sound Prosody.” The concept of Sound Prosody, as a unique component of the invention, is useful for teaching and learning about sounds and sound patterns, with application to speaking, reading, writing, and spelling. Through use of this component of the invention students develop specific essential skills, as they learn about sounds. The specific items in and format of this section on Sound Prosody, presented herein, should not be regarded as restricting the range or application of this component of the invention or the invention itself.

Pertaining to Claim 1 and FIG. 10: Feedback System: System and Supports for Feedback, Self-Monitoring, Self-Cueing and Self-Corrections

The system of Claim 1, wherein the present invention is further characterized as including a system for providing, using and benefiting from feedback. This Feedback System is further characterized as being useful for teaching and learning about how to self-monitor, self-cue, self-correct and to understand external and internal feedback. The invention provides processes, procedures, strategies, and multiple supports for accomplishing this. Moreover, the invention provides significant opportunities and means for providing innovative forms of feedback to students. This unique component of the invention is useful for teaching and learning about sounds and sound patterns, with application to speaking, reading, writing, and spelling.

While the Sound Symbols Visual Prompts are incorporated into and used as part of the Feedback System, this component of the invention focuses specifically on how the Prompts and other strategies are used in the feedback process. As such, the Feedback Component of the invention incorporates other components of the invention, as well as additional strategies, in particular ways that are designed to provide students with specific forms of feedback. Through use of the invention (including, but not limited to the Visual Prompts; Sound Circle; Sound Circle Methods, Processes, and Procedures; Consonant and Vowel Charts, etc.), students learn explicit skills and have access to materials that allow them to successfully self-monitor productions of sounds, including very specific aspects of sounds (e.g. placement, voicing, sound prosody, etc.). Where the Feedback System is referred to herein, this component of the invention is deemed to include other features or components of the invention, including the Visual Prompts, Sound Circle, Sound Circle Procedures, and Charts, etc., and their associated processes, procedures, strategies, materials and other items. This combination of processes and procedures, methods, strategies, and tools, is designed to provide a Feedback System or a means of teaching students to self-monitor, self-cue, and self-correct in order to improve students' speaking and reading skills.

When the Feedback System is combined with use of the Sound Symbols Visual Prompts, teachers can demonstrate mistakes that students make in sound productions and can help clarify how correct sound productions should be made (e.g. prompts and prompting can clarify place of production; prompts clarify differences in errors and target sounds, prompts clarify voiced versus voiceless sounds, etc.). The invention is also useful for clarifying differences in what students read out-loud during reading instruction versus what is actually written. Moreover, this component of the invention can help students make sense of errors and can help students gain an awareness of various unique aspects of spoken and written sounds (e.g. written letters that are not used when producing particular sounds, such as unspoken or silent “e”; unusual patterns of written letters and their corresponding spoken forms; spoken sounds that are affected by other sounds or letter patterns, etc.).

The various kinds of feedback provided through this component help increase student awareness of the types of errors they make while simultaneously increasing students' attention to sound patterns. Providing feedback using the invention, including the Visual Prompts, to demonstrate how student responses differ from target responses can reduce the typical back and forth routine use of repeated verbal corrections in response to errors. The typical back and forth responses to errors using verbal corrections with continued errors in reply can cause frustration for instructors and students alike. In contrast, the feedback system in the invention can quickly generate increases in accuracy and correct responses, due to students' abilities to correct their errors as they occur. This is accomplished by promptly providing visual feedback on errors and feedback on how to insert correct productions without having to verbally interrupt what students are saying. Such feedback can further increase student awareness of the types of errors they make and can increase their attention to sound patterns in speech and reading tasks.

Given the many visual supports in the invention, the Feedback System sensitizes students to the need for corrections so that they are subsequently able to benefit from small cues to self-correct (e.g. quietly tapping on a written word to encourage corrections; holding up a hand or a finger; use of the Five Time principle for repeating accurate productions, etc.). These small cues can be used to encourage corrections of spoken sounds or words. This allows any needs for modeling to be decreased or faded as quickly as possible, until modeling is no longer necessary. Self-corrections are also thereby encouraged.

Although the concept and use of feedback has gained attention in relation to education, most approaches in both speech and reading instruction continue to rely on repetitions of instructors' corrections and the use of repeated modeling of sounds, letters and words for feedback. The concept of giving very specific feedback on what the student have actually said, using multiple modalities, in combination with demonstrations of how student productions differ from target productions, has not been successfully incorporated into present educational approaches for either speech or reading instruction.

The need for teaching approaches that address different learning modes and learning styles has been addressed in educational literature, however specific application of this body of study has focused primarily on instruction, giving little attention to the need for providing feedback which incorporates these same principles. The present invention integrates very specific feedback, using multiple modalities, into instruction in ways that can increase the value of feedback and can lead to improvements in performance, as well as to development of self-monitoring, self-cueing and self-correction skills.

Through use of this component of the invention, teachers can cue students (e.g. also using other components of the inventions, particularly using the Sound Symbols Visual Prompts, as well as the Consonant Chart, Sound Circle, etc.) on an ongoing basis within the classroom environment, as well as during individual instruction. This can be accomplished in conjunction with instruction, instead of through interruptions to instruction as is usually required. For example, teachers can provide Visual Prompts of correct sounds to students when they make errors, which students can then immediately use to make self-corrections (without verbal interruptions by the teacher). The invention provides students with processes and visuals that facilitate their use of feedback and simultaneously promote development and use of self-corrections by students. This differs from traditional approaches where teacher interruptions and frequent, persistent repetitions of errors by students occur, particularly when students are having difficulties in making necessary adjustments during their attempts to more accurately model sounds and words.

Using the invention, students can easily learn to self-cue during both speaking and reading tasks. The invention provides a useful and effective process for facilitating transitions from modeling to independent productions (or to productions without models) of sounds, by providing tools and supports for making corrections while concurrently decreasing dependence on models. As a result, speakers and readers are able to simultaneously learn to self-monitor, self-cue, and self-correct while they learn how to produce and read sounds. Through use of the invention (including, but not limited to the Visual Prompts and Sound Circle), students learn explicit skills and have access to materials (e.g. Consonant Chart, Vowel Chart, etc.) that allow them to successfully learn to self-correct productions of sounds. This includes learning how to focus on very specific aspects of sounds (e.g. placement, manner of production, voicing, Sound Prosody, etc.). In other words, the Feedback System enables students to transition to independent speaking and reading while still providing a means of making corrections without resorting back to models. This allows development of sound improvement processes even as sound productions are learned, instead of waiting until later in the learning process to begin work on self-monitoring and self-correction skills.

The invention also facilitates accurate understanding of how sounds and subsets of sounds (or allophones of phonemes) are organized into sound categories or groups and facilitates understanding of the relationships between spoken sounds and written letters. The use of feedback increases understanding in these areas and further facilitates use of self-corrections, as awareness of sound boundaries and awareness of the characteristics or distinctive features of sounds increase. Additionally, improved understanding of sounds, when combined with opportunities for feedback and self-corrections, can lead to reductions in the overgeneralization of various features or aspects of sounds that cause multiple types of errors (e.g. voicing of unvoiced sounds, etc.). As a result of use of this component of the invention, students can be provided with the processes, procedures, strategies, and tools they need in order to develop a means of judging whether their sound productions are correct or not and of examining the types of mistakes they have made. These same processes, procedures, strategies, and tools help students learn how to self-assess and self-correct when they make mistakes in sound productions during speaking and reading tasks.

The Feedback System of the invention provides students with visuals and processes that increase their use of feedback and application of feedback in ways that promote sound development, improvement of modeling skills, and increases in self-monitoring. This component facilitates successful student changes and adjustments in sound productions. It is important to note that establishment of self-monitoring, self-cueing and self-correction skills can lead to increases in self-confidence, as well as to improvements in overall speaking and reading performance. Moreover, being able to self-monitor, self-cue, and self-correct can be particularly useful when learning to predict sounds in reading tasks. These skills are especially important for anticipating the ways in which sound combinations may potentially be produced and for understanding how even subtle changes in sound productions can change word forms and meaning.

The “Five-Times” principle and related activities are also useful aspects of the feedback system. The “Five-Times” principle facilitates self-cueing and self-correction skills. In this aspect of the invention, students are initially taught to selectively practice correct productions of sounds on which they have made errors. With high levels of support to start, students are encouraged to attempt to make correct productions of target sounds in words five times in a row. Extensive modeling and supports may be needed at first, followed by gradual fading of modeling and supports (e.g. graduated levels of support are reduced as quickly as possible) until modeling is no longer necessary. Hand cues, counting down from five to one using fingers on one hand, are given to encourage student use of the “Five-Times” principle, until students engage in these corrections without cues from others.

When instruction is provided through personal means (including actual presence and virtual presence), feedback is an additional avenue for instruction in accuracy of sound productions and use of the identified processes, procedures, strategies, materials, items, tools, and kit components being presented. Feedback may be provided through physical presence, virtual presence or through mechanized, electronic, digital or computerized means and by providing specific or individualized feedback, as well as more generalized information. Students can learn to use the feedback system in the invention and can learn to self-monitor, self-cue, and self-correct even when instruction is provided through virtual, electronic or other means.

Although one of the objectives of the invention is to provide teachers and students with an interactive experience, utilizing opportunities to provide and obtain feedback applying the tools, processes and procedures in the invention, this is not always possible. Therefore, the option of virtual use of the invention is offered, where feedback can be provided during instruction with modeling based on information noted in past performances of students or the performances of similarly situated students. Virtual feedback may be given during or following teacher instruction and during or following production of student responses. Live and virtual feedback may be provided using any of the modalities previously presented as being used in the program, including spoken, visual (such as cues from facial, written or drawn information), and gestural feedback (such as pointing, prompting, or demonstration of movements).

The Feedback System in the invention, with corresponding means of developing student skills in the areas of self-monitoring, self-cueing, and self-correcting, differentiates it from other programs for learning about spoken and written sounds. One of the differences centers on the amount of attention given to these areas and skills. The forms, views, approaches, and use of feedback provided in this invention differ significantly from how feedback is viewed in traditional approaches to speaking and reading. Moreover, the feedback system in this invention is useful for improving students' overall understanding and productions of sounds and sound patterns in a wide range of speaking and reading activities, with application to writing and spelling.

The specific items in and description of the system of feedback in the invention presented herein should not be regarded as restricting the range or application of this component of the invention or the invention itself.

Pertaining to Claim 1 and claim 2: FIG. 11 Materials

The system of Claim 1 wherein said materials related to the conveying, presentation and use of the Sound Symbols Speaking and Reading Approach may be offered in various forms, formats, and media, and through various substances or composition, features, and elements that maintain their relationship to the function, nature, and purposes of the invention. Said materials include items, tools, information and directions for processes, procedures, strategies, and methods, and kit components, related to the invention. The substances that make up the invention's materials may be of any variety; whether rigid or flexible; applying text or without text; may include pictures, diagram, manipulatives, figures, and drawings or depictions of actions, as well as printed, visual, auditory, and tactile materials or information, and may be conveyed through any audio-visual, digital, or electronically-based form or forms currently or subsequently available.

Regardless of their composition or substance (including any variety or combination of substances and materials) and means of manufacturing or presentation, the materials which relate to the present claimed invention are deemed to be elements of the invention. This includes materials and components made of or manufactured from the following substances or combinations of substances: paper and paper-based products, wood, ink and paint based products, plastics or plastic materials, resin, cork products, synthetically-based products, metal, magnets or magnetized materials, and computerized, digital or digitized, electronically-based, or electronically stored materials (e.g. materials related to web-based storage, mobile apps or software, computerized files, digitized files, electronic files, or stored files, emails, DVDs, internal or external hard drives, flash drives, and similar electronic storage devices), and any other materials which retain their relationship to the invention. Materials may also contain codes for access to additional information or materials through web-based, cloud-based, internet, email, digital, or other electronic means.

Materials germane to this invention may contain adhesive properties, such as in the case of stickers and tape-based products. Materials may also contain magnetic, adhering, fastening, tacking or other connective properties so that visual supports and pictured or written items representing sounds or having instructional value may be attached in various ways to objects that facilitate the process of giving instruction or providing/encouraging student practice. Materials may also contain other fasteners of any variety so that they may be attached or used to connect to other objects and materials included in the invention or being used in conjunction with the invention. These may include, but are not limited to, such fasteners as clips, hooks, pins, loops, tapes, and items of various types for attaching to other materials.

Materials may also contain properties that allow for writing and drawing on the surfaces of said materials. This includes properties such as or similar to those of a whiteboard or dry erase board for demonstration and instructional purposes related to use of the invention and its component parts. Alphabetic items or letters and other items for purposes of display, manipulation, and provision of models, may also be included.

Components in the invention may be made of one or more than one type of material. For example, paper-based items may also be produced in plastic, metal or wood-based forms, and other forms as deemed useful. Components in the invention may also be made of more than one type of material through the combining of materials. For example, part of an item could be produced of plastic while another portion of the same item might contain wood or paper based parts. Materials may include the following, such as printed, visual, auditory, and electronic tools; pictures, photographs, drawings, charts, diagrams, figures, video and audio recordings; dvds, compact discs, flash drives and other electronic or digital media, explanations and directions for using the invention's tools, items, strategies, and processes, direction booklets, lesson plans, teacher guides, test protocols, and demonstration forms, books, booklets, manuals, pamphlets, handouts, display items, instruction sheets, various types of manipulatives (for reinforcement tokens, markers, and place holders, etc.), and items related to hands-on activities, as well as articles for organizing, for identification purposes and for packaging or providing containers for said items. Materials may also be of various sizes, including large display sizes and smaller, reproductions of components of the invention for hands-on activities, display, or for handouts. Any or all of the materials in the invention may be contained or displayed in internal or external areas of the kits or containers for the kits.

The materials or substances may be conveyed as individual components of the invention or as combined components of the invention. Materials in the invention may be contained in kit form or various kit forms of the invention (where all or only some of the items are included), as well as being provided as separate items which are not contained in kits.

These materials related to the invention, regardless of the form they take, are to be referred to commercially as “Sound Symbols Speaking and Reading Approach” or “Sound Symbols.” Said materials and any variants thereof, regardless of their composition, means of manufacturing or electronic form, which relate to the present claimed invention, are deemed to be elements of the invention. Additionally, beyond the physical nature of items, materials, tools, procedures, processes, strategies and kit components or methods, all of the teaching and learning concepts presented in the invention are integral elements of the invention, which provide specific and unique benefits to users of the invention.

The specific materials in the invention and the format of the materials in the invention presented herein should not be regarded as restricting the range or application of this component of the invention or the invention itself. Moreover, figures, drawings, photos, and materials related to the invention with their corresponding attributes, descriptions and explanations herein are noted as material subject to Copyright.

The present invention may be embodied or presented through the use of various materials and in various formats, including any computerized or electronic means known or developed. The illustrative embodiments of the invention presented here can be applied and used as presented or may be modified to be presented with and/or without the use of other materials or means of transmission. It is therefore understood that the claims contained herein are intended to apply to any and all versions, application or use of the invention, or modifications thereof, that would reflect the unique benefits offered by the invention and are thereby intended to be included within the scope of the appended claims. Moreover, it is understood that further additional modifications and variations may be made that will nevertheless maintain or embody the novel concepts presented through and with the present invention. It is further understood that the description of the invention and the appended claims presented herein, with related terms and embodiments, are not intended to limit the scope, use, form, function, or application of the invention.

What is claimed is:

1. The Sound Symbols Speaking and Reading Approach provides a novel approach that simultaneously facilitates instruction in the combined areas of speaking and reading skills, with application to writing and spelling, through a uniquely identifiable format of distinct but integrated components that are used to represent the sounds of a language as they are spoken and written. These components incorporate the various aspects of the invention. Said components include: the Sound Symbols Sound Circle; the Sound Symbols Visual Prompts; the Sound Symbols Consonant Chart; the Sound Symbols Vowel Chart; the Sound Symbols Tracking Form; the Sound Symbols Feedback System; the concept of Sound Prosody; and the Sound Symbols processes, procedures, strategies, and activities that apply to instruction in reading and instruction in use of the Sound Circle. Included as well are related materials and tools that address specific processes, procedures and related instructional aspects of the invention pertaining to speaking, reading, writing, spelling, and use of feedback (including external, internal, self cueing, self-monitoring, and self-correcting).

2. The system of claim 1 wherein said materials related to the conveying, presentation and use of the Sound Symbols Speaking and Reading Approach may be offered in various forms, including various formats, media, through various substances or composition which contain features and elements that maintain their relationship to the function, nature, and purposes of the invention. Said materials include items, tools, information and directions for processes, procedures, strategies, and methods, or kit components, related to the invention. The substances that make up the invention's materials may be of any variety; whether rigid or flexible; applying text or without text; may include pictures, diagram, manipulatives, figures, and drawings or depictions of actions, as well as printed, visual, auditory, and tactile materials or information, and may be conveyed through any audio-visual, digital, or electronically-based form or forms of any type presently available or subsequently made available.

3. The system of claim 1 wherein said components of the invention uniquely address acquisition and development of skills and sub-skills of speaking and reading, thereby enabling said components to stand alone as unique, distinct elements, in addition to contributing to and comprising part of the invention in its entirety.
